(19) United States
(12) Patent Application Publication
(10) Pub. No.: US 2013/0096948 A1
(43) Pub. Date: Apr. 18, 2013

(54) METHODS FOR DIAGNOSIS, PROGNOSIS AND TREATMENT

(71) Applicants: David Parkinson, South San Francisco, CA (US); Wendy J. Fantl, San Francisco, CA (US); Alessandra Cesano, Redwood City, CA (US); David Spellmeyer, Oakland, CA (US)

(72) Inventors: David Parkinson, South San Francisco, CA (US); Wendy J. Fantl, San Francisco, CA (US); Alessandra Cesano, Redwood City, CA (US); David Spellmeyer, Oakland, CA (US)

(73) Assignee: Nodality, Inc., South San Francisco, CA (US)

(21) Appl. No.: 13/602,022

(22) Filed: Aug. 31, 2012

Related U.S. Application Data
(63) Continuation of application No. 12/688,851, filed on Jan. 15, 2010, now abandoned.
(60) Provisional application No. 61/144,955, filed on Jan. 15, 2009.
(60) Provisional application No. 61/146,276, filed on Jan. 21, 2009.

(51) Int. Cl. G06F 19/00

(52) U.S. Cl. CPC G06F 19/3487
USPC 705/3

(57) ABSTRACT

An embodiment of the present invention is a method of generating a report based on an association metric. The method involves identifying node state data associated with a sample, and generating an association metric based on the node state data.

### CROSS REFERENCE

This application claims priority as a continuation of U.S. Ser. No. 12/688,851 filed Jan. 15, 2010 which claims the benefit of U.S. Provisional Application Nos. 61/144,955, filed on Jan. 15, 2009 and 61/146,276, filed on Jan. 21, 2009, all of which applications are incorporated herein by reference.

### BACKGROUND OF THE INVENTION

Methods such as multi-parameter flow cytometry use flow-based proteomic characterization of single cells to capture rare cell populations and evoke signaling measures in response to extracellular challenges. Antibodies against state-specific epitopes are used to measure activatable elements characterizing phospho-protein signaling networks, cell cycle progression, apoptotic pathways, protein expression (e.g. transporters, growth factor receptors), other post-translational modifications (e.g. acetylation, methylation, ubiquitination, sumoylation), or conformational changes. Different antibodies may be used in combination with modulators that are known to stimulate activatable elements. Such combinations of modulators and antibodies/activatable elements are called “signaling nodes” or “nodes”. Signals of the bound antibodies are quantified to produce “node state data” characterizing the response of the activatable element to the modulator. Node state data can used to characterize the biological pathways associated with the activatable elements. Node state data can also be used to identify node states that are specific to, or characteristic of, a biological state such as a disease.

Accordingly, the ability to characterize activatable elements and biological pathways in single cells can facilitate great research advancements in the areas personalized medicine, drug-development and basic biological research. However, a high level of expertise is required to perform methods such as multi-parameter flow cytometry and other methods of single cell analysis such as laser cytometry and mass spectrometry. Additionally, cytometers and mass spectrometers are expensive to purchase and maintain. Consequently, node state data characterizing activatable elements and pathways in single cells is not widely produced by researchers and clinicians.

This lack of node state data serves as a barrier to the utility of this data in research. Node state data from cell populations in a specific biological state must be statistically modeled in order to identify node states that are specific to, or characteristic of the biological state. For instance, node state data from samples of patients with a sub-type of Acute Myeloid Leukemia (AML) must be statistically modeled in order to identify node state data that characterizes the sub-type of AML and can be used to diagnose the sub-type of AML. Also, node state data from samples of different cell lines may be used to characterize a biological pathway. The greater the amount of node state data that is produced from different patient samples, the more accurate the statistical model and its consequent characterization/diagnosis. Therefore, the lack of node state data serves as a barrier to the generation of accurate statistical models used to perform diagnosis or prognosis.

A related barrier to the utility of node state data in research is the lack of standardization in the production and analysis of node state data. Various commercial antibodies, modulators and experimental protocols can be used to generate node state data for the same node. These variations may cause node state data generated in different experiments to be incomparable. Because of these variations, node state data produced in different laboratories often cannot be combined and used to generate statistical models. Differences in data analysis protocols and instrument calibration also lead to incomparable or inconsistent node state data.

Also, iterative experiments are required to validate the different antibodies, modulators and protocols used. For instance, several experiments may be necessary to identify an antibody-modulator combination for use as a node and develop a protocol for obtaining consistent node state data using the node. This iteration leads to large labor costs incurred by parties attempting to generate consistent node state data.

Embodiments of the present invention address the above described limitations by providing methods and computer-implemented program code for the standardized production and analysis of node state data.

### DEFINITIONS

Activatable Element—Activatable elements are discussed in the section below entitled “Activatable Elements”.

Modulator—Modulators are discussed in the section below entitled “Modulators”.

Node—A node is a term used to describe a modulator and a molecule used to measure the response of an activatable element to the modulator. In some of the embodiments discussed herein, a node comprises a modulator and a labeled antibody that binds to a state-specific epitope associated with an activatable element.

Node State Data—Node state data, as used herein, refers to quantitative data corresponding to the signal of a molecule used to measure the response of an activatable element in one or more cells (i.e. a “node state”, “activation level”). Node state data may be raw signal data or metrics (“node state metrics”) quantifying any characteristic of the raw signal data. Node state metrics can express raw signal data as a relative value to a signal data generated from other cells (e.g. cells untreated with a modulator).

Biological State—A biological state is any discrete state that a cell may be in. Biological states can comprise the genotype of the cell, the phenotype of the cells, a stage of differentiation, a response to an modulator, activation of an activatable element, a disease/pre-disease state of the cell, grades of diseases states assigned by physicians, proteomic or expression based characterization of the cell, morphology of the cell and information associated with a patient the cell is derived from such as age, gender and geographical location. Biological states may be categorical variables or numerical variables corresponding to a biometric associated with a patient or cell state (e.g. age of patient, grade of cell). Biometrics associated with a patient or a cell state can comprise values of surrogate markers for disease. Biological states may further comprise future states of the cell, such as a clinical outcome.

Statistical Model—A statistical model is any aggregation or combination of data that characterizes node state data in one or more cells. A statistical model can comprise a classifier used to model data characteristic of cells in a known biological state. A statistical model can also comprise a Gaussian value that describes node state data derived from different cells. A statistical model may also describe other transformations of node state data into statistically meaningful data.

Sample—A sample is a population of one or more cells. Samples can be derived, for example, from cells in culture or from patients. The term “patient” or “individual” as used herein includes humans as well as other mammals. The methods generally involve determining the status of an activatable element. The methods also involve determining the status of a plurality of activatable elements.

### SUMMARY OF THE INVENTION

One embodiment of the present invention provides a method for customers to generate node state data and transmit the node state data to a central server for analysis and report generation. This embodiment includes a model with customers generating node state data from physical samples of cell populations and with the option of performing the data analysis or sending the data to server operated the central laboratory for processing and report generation. This method can standardize both the generation and analysis of node state data, allowing the third party to obtain the benefit of the latest analysis technology. For example, customers can proceed with the experiments identified in U.S. Ser. No. 61/120,320 in Example 1 and then provide the data for further processing to a central analysis service who can perform the types of analyses shown in the 61/120,320 application. Customers may order analytical reports or interface with the central laboratory via a web portal and/or network. See U.S. Patent Publication numbers 2003/0100995 and 2005/0009078. Pricing for report generation may be made on a per time or subscription basis. Different tiers of service pricing may be offered to different type of third party customers.

Additionally, kit software or modules may be provided for preliminary analysis of the raw signal data used to generate node state data using a computer operated by the third party. The kit software may be used to process raw signal data into node state data and transmit the signal/node state data to a server operated by the central laboratory for report generation. For example, the third party may evaluate the quality of raw signal data before incurring the cost of sending it to a central organization for more detailed analysis. Once the signal/node state data is submitted and analyzed, it can be stored in a database at the server operated by the central laboratory. Various third parties may pay a subscription fee to access and search the database.

Embodiments of the present invention further include kits for treating cells according to standardized methods with standardized modulators or antibodies. The subject invention also provides kits for use in determining the physiological status of cells in a sample, the kit comprising one or more modulators, inhibitors, specific binding elements for signaling molecules, and may additionally comprise one or more therapeutic agents. Embodiments further include calibration kits for performing standardized flow cytometry analysis on the treated cells. The standardized methods and reagents for evoking cell signaling and performing the flow cytometry analysis and data analysis will allow comparisons between samples/patients and across time.

In some embodiments, the present invention is a method for drug screening, diagnosis, prognosis and prediction of disease treatment. Reports generated by the present invention may be used to measure signaling pathway activity in single cells, identify signaling pathway disruptions in diseased cells, including rare cell populations, identify response and resistant biological profiles that guide the selection of therapeutic regimens, monitor the effects of therapeutic treatments on signaling in diseased cells, and monitor the effects of treatment over time. These reports can enable biology-driven patient management and drug development, improving patient outcome, reducing inefficient uses of resources, and improving the speed of drug development cycles.

A specific embodiment includes the use of a technology that is able to analyze events at a single cell level, such as the performance of multi-parametric flow cytometry, mass spectrometry, or laser spectrometry as examples, to analyze cell signaling pathways using standardized methods, equipment, and reagents. One embodiment of the invention uses evoked responses to probe signaling. By standardizing protocols, reagents, and analysis tools, the present invention can be used for patient monitoring. For example, clinicians may monitor patients over time as a tumor evolves by receiving reports for the patient comprises formed on responsive and resistant biological profiles as well as ensuring adequate accuracy and completeness to enable biology-driven patient management.

One embodiment of the present invention comprises generating reports that reflect the complete pathophysiology relevant for understanding therapeutic agent effects. Using these reports a third party will be able to characterize physiologically rare cell populations and to define components of heterogeneous cell populations. An embodiment of the present invention combines the aspects of the individual tumor or autoimmune biology revealed by various tests to provide more information surrounding a cell sample or patient relevant to understanding which types of treatment would be most effective, which would clearly be ineffective, determining the optimal dose of the agent and/or the optimal combination of treatments for the patient, monitoring the biological, pharmacological and clinically effects of the treatment and determining efficiently and early when such treatment is not longer effective, and aiding in the characterization of the most effective next treatment. For example, specialty hematopathology companies currently provide full diagnostic case reports which may be integrated with other tests described herein.

Another embodiment of the present invention may combine node state data and association values with biometric data provided by partner companies to generate reports for third parties. Biometric data may include any other laboratory and clinical tests such as: nucleic acid or protein array based experiments, hematopathology services, such as diagnostic immunophenotyping, cytogenetics, immunohistochemistry, karyotyping, FISH, molecular genetics, and analysis of cell morphology. More specifically, these tests could include one or more of the following: blood smear interpretation and report, bone marrow smear interpretation and report, cytospin, cytopathology selective, DNA ploidy by flow, flow markers, skin or other solid tissue, tissue culture, solid tumor culture, cytogenetic chromosome analysis, surgical pathology, decalcification, and morphometric analysis. These services are known in the art and are offered by commercial entities such Genoptix (Carlsbad, Calif.), US Labs (Irvine, Calif.), AmeriPath (Orlando, Fla.), CARIS DX (Tucson, Ariz.), Clarient (Aliso Viejo, Calif.), and GenPath (Elmwood Park, N.J.). The combination of all tests may be delivered in a single report to third party and provided with a single analysis. The use of cell samples will be minimized as they will not be distributed to multiple entities. Variability between different tests will be reduced because all samples will be handled by the same institution, and all tests will be performed under similar environmental conditions.

One embodiment of the present invention is a method for generating reports including association metrics that serve diagnoses, prognoses and values used to guide decision making such as values used to guide patient treatment. Samples comprising fresh or frozen cells may be used depending on the time between acquisition and analysis. The method of generating the associated metric can comprise correlating the node state data derived from a sample with a statistical model for a clinical outcome or surrogate marker thereof, such as the prognosis and/or diagnosis of a condition, or can correlate with the response to a therapy, such as complete response, partial response, remission, no response, progressive disease, stable disease, hematologic improvement, cytogenetic response and adverse reaction. The method can also involve generating association metrics based on statistical models of samples associated with “stages” wherein the “stages” associated with the samples are selected from the group consisting of: WHO classification, FAB classification, IPSS score, WPSS score, aggressive, indolent, benign, refractory, limited stage, extensive stage, including information that may inform on time to progression, progression free survival, overall survival, and event-free survival. Treatments or therapies may include chemotherapy, biological therapy, radiation therapy, small molecules, antibodies, bone marrow transplantation, peripheral stem cell transplantation, umbilical cord blood transplantation, autologous stem cell transplantation, allogeneic stem cell transplantation, syngeneic stem cell transplantation, surgery, induction therapy, maintenance therapy, watchful waiting, and other therapy. The association metric for a sample may also be based on statistical models generated based on samples with minimal residual disease or emerging resistance.

One embodiment of the present invention is a computer system for generating a report for third party, the system comprising: a memory; a processor; an association metric module executable to: identify node state data associated with a sample, wherein the node state data specifies a level of one or more activatable elements in one or more cells in the sample responsive to stimulation with a modulator, and generate an association metric based on the node state data and a statistical model, wherein the statistical model characterizes node state data associated with a biological state and the association metric specifies whether the sample is in the biological state characterized by the statistical model; a report generation module executable to generate a report based on the association metric; and a client communication module executable to transmit the report to a client operated by the third party.

### BRIEF DESCRIPTION OF THE DRAWINGS

FIG. 1 shows a system 101 according to one embodiment of the present invention.

FIG. 2 shows a third-party client 150 according to one embodiment of the present invention.

FIG. 3 shows a central laboratory server 110 according to one embodiment of the present invention.

FIG. 4 shows steps performed by the third-party client 150 to receive reports from a central laboratory according to an embodiment of the present invention.

FIG. 5 shows steps performed by the central laboratory server 110 to generate reports according to one embodiment of the present invention.

FIG. 6a shows steps performed by the central laboratory server 110 to store node data in the node state database according to one embodiment of the present invention.

FIG. 6b shows steps performed by the central laboratory server 110 to store biological state data models according to one embodiment of the present invention.

FIGS. 7a and 7b shows steps performed by the central laboratory server 110 to generate reports according to embodiments of the present invention.

FIGS. 8-19 illustrate examples of reports generated by the central laboratory server 110 according to various embodiments of the present invention.

FIG. 20 illustrates an example of a computer system environment.

FIG. 21 illustrates a networked system for the remote acquisition or analysis of data obtained through a method of the invention.

### DETAILED DESCRIPTION OF THE INVENTION

The present invention incorporates information disclosed in other applications and texts. The following patent and other publications are hereby incorporated by reference in their entireties: Haskell et al, Cancer Treatment, 5^{th} Ed., W.B. Saunders and Co., 2001; Alberts et al., The Molecular Biology of the Cell, 4^{th} Ed., Garland Science, 2002; Vogelstein and Kinzler, The Genetic Basis of Human Cancer, 2d Ed., McGraw Hill, 2002; Michael, Biochemical Pathways, John Wiley and Sons, 1999; Weinberg, The Biology of Cancer, 2007; Immunobiology, Janeway et al. 7^{th} Ed., Garland, and Leroith and Bondy, Growth Factors and Cytokines in Health and Disease, A Multi Volume Treatise, Volumes 1A and 1B, Growth Factors, 1996. Patents and applications that are also incorporated by reference include U.S. Pat. Nos. 7,381,535 and 7,393,656 and U.S. Ser. Nos. 10/193,462; 11/655,785; 11/655,789; 11/655,821; 11/338,957, 12/460,029, 12/229,476, 61/048,886; 61/048,920; 61/048,657; 61/079,766, 61/120,320 and 61/144,684. Many of these references disclose single cell network profiling (SCNP). Some commercial reagents, protocols, software and instruments that are useful in some embodiments of the present invention are available at the Becton Dickinson Website http:(slashslash)www(dot)bdbiosciences.com(slash)features/products(slash), and the Beckman Coulter website, http:(slashslash)www.beckmancoulter(dot)com(slash)Default.asp?bhfv=7. Relevant articles include High-content single-cell drug screening with phosphospecific flow cytometry, Krutzik et al., Nature Chemical Biology 23: 132-42, 2007; Irish et al., FLt3 ligand Y591 duplication and Bcl-2 over expression are detected in acute myeloid leukemia cells with high levels of phosphorylated wild-type p 53, Blood 109: 2589-96 2007; Irish et al. Mapping normal and cancer cell signaling networks: towards single-cell proteomics, Nature Rev. Cancer, 6: 146-55 2006; Irish et al., Single cell profiling of potentiated phospho-protein networks in cancer cells, Cell, Vol. 118, 1-20 Jul. 23, 2004; Schulz, K. R., et al., Single-cell phospho-protein analysis by flow cytometry, Curr Protoc Immunol, Chapter 8: Units 8.17.1-20, 2007; Krutzik, P. O., et al., Coordinate analysis of murine immune cell surface markers and intracellular phosphoproteins by flow cytometry, J Immunol. 2005 1754: 2357-65; Krutzik, P. O., et al., Characterization of the murine immunological signaling network with phosphospecific flow cytometry, J Immunol. 175: 2366-73, 2005; Stelzer et al. Use of Multiparameter Flow Cytometry and Immunophenotyping for the Diagnosis and Classification of Acute Myeloid Leukemia, Immunophenotyping, Wiley, 2000; and Krutzik, P. O. and Nolan, G. P., Intracellular phospho-protein staining techniques for flow cytometry: monitoring single cell signaling events, Cytometry A. 55:61-70, 2005; Hanahan D., Weinberg, The Hallmarks of Cancer, Cell 100:57-70, 2000; Krutzik et al, High content single cell drug screening with phophosphospecific flow cytometry, Nat Chem Biol. 4:132-42, 2008. Guiding principles of statistical analysis can be found in Begg C B. (1987). Biases in the assessment of diagnostic tests. Stat in Med. 6, 411-423; Bossuyt, P. M., et al. (2003) Towards complete and accurate reporting of studies of diagnostic accuracy: the STARD initiative. Clinical Chemistry 49, 1-6 (also in Ann. Intern. Med., BMJ and Radiology in 2003); CDRH, FDA. (2003). Statistical Guidance on Reporting Results from Studies Evaluating Diagnostic Tests: Draft Guidance (March, 2003); Pepe M S. (2003). The Statistical Evaluation of Medical Tests for Classification and Prediction. Oxford Press; Zhou X-H, Obuchowski N A, McClish D K. (2002). Statistical Methods in Diagnostic Medicine. Wiley.

Experimental and process protocols and other helpful information can be found at http(colon)(slash)proteomics.stanford.edu. The articles and other references cited below are also incorporated by reference in their entireties for all purposes.

The discussion below describes some of the preferred embodiments with respect to particular diseases, such as cancer and autoimmune diseases. However, it should be appreciated that the principles may be useful for the analysis of many other diseases as well.

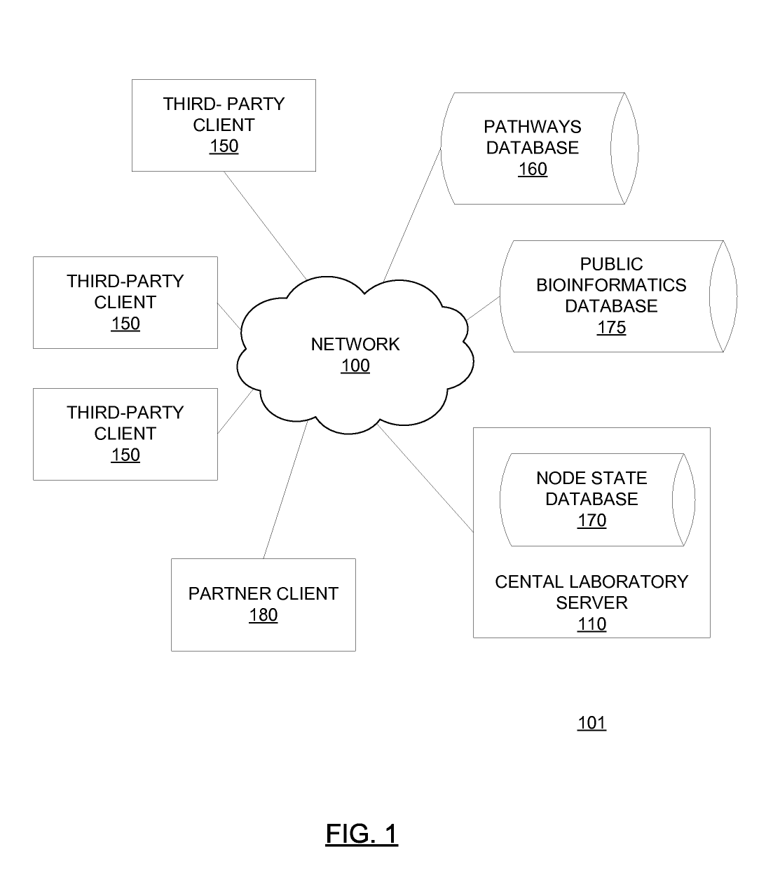

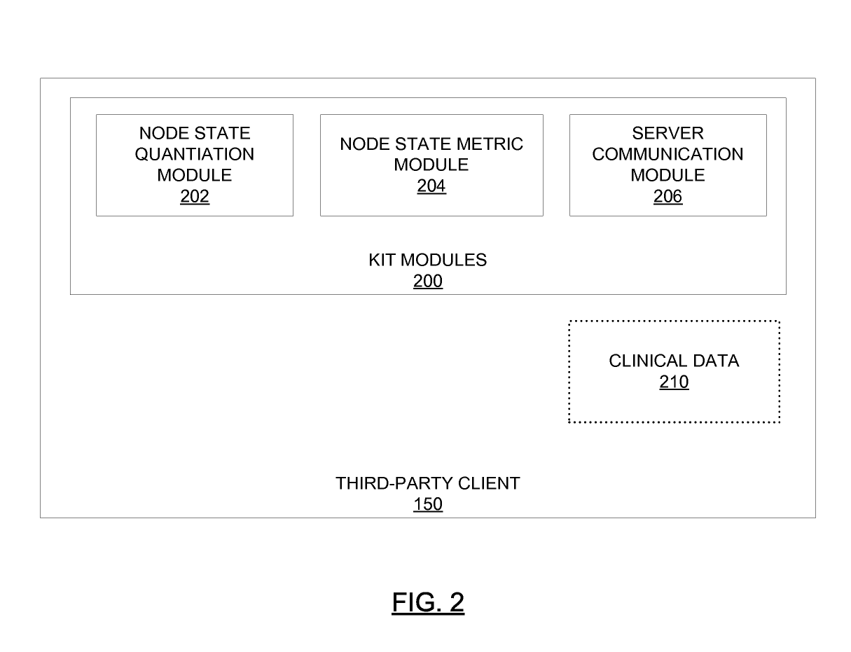

FIG. 1 shows a system 101 according to an embodiment of the present invention. The system 101 comprises one or more third-party clients 150, one or more pathways database(s) 160, one or more public bioinformatics databases 175, one or more partner clients 180, a central laboratory server 110 and a network 100. The third-party clients 150, partner clients 180 and the central laboratory server 110 communicate with each other through the network 100. The central laboratory server 110 accesses the pathways databases 160 and the public bioinformatics databases 175 through the network 100.

Although only three third-party clients 150 and one partner client 180 are depicted in the FIG. 1, it should be appreciated that in practice a large number (e.g. 10, 50, 10, 100, 500, 1000, 5000, 10000 or more) of third-party clients 150 will communicate with the central laboratory server 110 through the network 100. Similarly, in practice a large number of partner clients 180 will also communicate with the central laboratory server through the network 110. The central laboratory server 110 may also access a plurality of pathways databases 160 and public bioinformatics databases 170. It should also be appreciated that in practice, the functions performed by the central laboratory server 110 can be performed by more than one server. In some embodiments, there are 1, 2, 3, 4, 5, 6, 10 or more servers. Each of the third-party clients 150, the partner client 180 and the central laboratory server 110 can be a computer comprising a memory, a processor, computer-readable storage and input/output devices. Both the pathways database 160 and the public bioinformatics database 170 comprise computer-readable storage and may also comprise computers.

The central laboratory server 110 is a computer operated by a central laboratory that offers sample processing and report generation services. In one embodiment, the central laboratory will use flow cytometry-based techniques to quantitate levels of activatable elements in single cells. In other embodiments, the central laboratory may quantitate activatable elements using different techniques appropriate for single cells. Such techniques are discussed below in the section entitled “Generating Node State Data”. In some embodiments, the central laboratory server 110 is associated with more than one central laboratory and/or is not located in the same geographic location as the central laboratory. The central laboratory server 110 comprises a node state database 170. The node state database 170 is a centralized repository of standardized node state data. The node state database 170 incorporates standardized node state data generated at the central laboratory and standardized node state data generated by laboratories operated by third parties. Node state data generated at the central laboratory can include high-throughput data generated for development of tests as well as other node state data generated for collaborators and customers and for the central laboratory. High-throughput data generated for development of tests may include large volumes of node state data generated from samples with a specific biological state. In a specific application, a large amount of node state data is generated from samples derived from “normal” patients, that is, patients with no signs of one or more diseases or dysfunctions. Data can be generated for normal patients with different biological and environmental characteristics such as age, gender, race and geographic location. In one embodiment, the data on normal patients can be used as a comparison to other patients. Hosting a centralized repository of standardized node state data allows for various parties to share knowledge derived from experiments performed by other parties.

The third-party client 150 is a client computer operated by a third party who is a customer or collaborator of the central laboratory. Customers of the central laboratory include but are not limited to: academic or government institutions, biotechnology companies such as pharmaceutical companies or biological supply companies, commercial laboratories, physicians, medical centers and patients. Collaborators of the central laboratory may include academic or government institutions, biotechnology companies, physicians and medical centers. The third-party client 150 communicates with the central laboratory server 110 to transmit data and, in some instances, clinical information. The third-party client 150 further communicates with the central laboratory server 110 to receive software updates and reports.

The partner client 180 can be a client computer operated by a laboratory that the central laboratory partners with to provide diagnostics and other reports. The partner client 180 communicates with the central laboratory server 110 over the network 100 to receive biometric data associated with anonymized clinical samples.

The public bioinformatics databases 175 are databases of biological information that are available to the general public. Biological information included in the public bioinformatics databases 170 can comprise data from clinical trials, protein structure data, bio-activity data, chemical data, academic or government publications, gene expression data, genomic data, proteomic data, phenotype data and bio-ontology data. Other types of biological information will be apparent to those skilled in the art. The pathways databases 160 comprise manually curated pathway information such as the information available at NCI or ExPASy. The pathways databases 160 can also comprise pathway information that is, in some part, generated automatically from experimental data.

FIG. 2 illustrates one embodiment of the third-party client 150. The third-party client 150 can comprise a set of kit modules 200 that are received via the network 100 from the central laboratory server 110. In some instances, the third-party client 150 can further comprise clinical data 210. In alternate embodiments, any or all of the functions performed by the kit modules 200 may be performed by the central laboratory server 110 and accessed by the third-party client 150, for example, through a secure web portal.

The kit software 200 is software that is developed by the central laboratory and used by the third party to generate standardized node state data. In most embodiments, the kit software 200 will be used in conjunction with kits developed by the central laboratory.

Kits are described in detail in the section below entitled “Kits” and in U.S. Ser. No. 61/245,000, which is herein incorporated in its entirety, for all purposes. The kits can comprise antibodies, modulators and reagents that have been optimized by the central laboratory to produce consistent, standardized results, as described below with respect to the node validation module 306 and the protocol validation module 314. The kits further comprise protocols that have been optimized by the central laboratory, as described below with respect to the node validation module 306 and the protocol validation module 314. Third parties may use the kits to treat populations of cells, herein referred to as “samples”, and transmit the physical samples to the central laboratory for generation of node state data and reports. In some embodiments, the central laboratory or a representative thereof, may provide training to the third party including instruction on how to interpret analysis results included in the reports. The third party may be charged a fee for the kits, for training, for kit software, or for the reports generated by the central laboratory server 110. Alternatively, the customer may purchase kits and services on a subscription basis.

Third parties who possess flow cytometers or other machinery used to produce node state data can use the kit software 200 to generate standardized node state data. Appropriate methods of generating node state data are discussed below in the section entitled “Generating Node State Data”. Third parties may also use calibration kits developed by the central laboratory to calibrate their flow cytometers and further standardize node state data. Calibration kits are discussed below in the section entitled “Kits” and can include the reagents shown in U.S. Ser. No. 61/176,420 as well as materials specific to the instrumentation such as rainbow beads, lyophilized cells, and specific quantities of antibodies typically used for instrument calibration.

The server communication module 206 functions to communicate with the central laboratory server 110. The server communication module 206 receives software updates for the kit modules 200 from the central laboratory sever 110. The server communication module 206 transmits node state data produced by the node state metric module 204 to the central laboratory server 110. The server communication module 206 allows the third party to specify requisition data including the type of tests/analysis to be performed on the node state data and included in the report. The server communication module 206 transmits the requisition data in conjunction with the node state data. Other types of requisition data are discussed below. The server communication module 206 assigns tracking identifiers to the node state data prior to transmitting the node state data to the central laboratory server 110 for analysis.

In some instances, the server communication module 206 also transmits clinical data 210 to the central laboratory server 110. Clinical data 210 is information which associates patients with their medical history, including: biometric tests and medical diagnoses/prognosis. The server communication module 206 associates the clinical data with anonymized identifiers. In instances where the third party generates node state data derived from patient sample, the server communication module 206 associates the anonymized identifier with a tracking identifier prior to transmitting the clinical data 210 and the node state data derived from the patient sample to the central laboratory server 110. In other instances, clinical data 150 may be associated with a tracking number associated with a physical sample sent to the central laboratory for analysis and transmit to the central laboratory server 110 in association with the tracking number. According to the embodiment, the server communication module 206 may also de-identify or “scrub” the clinical data 210 prior to transmitting the clinical data 210 to the central laboratory server 110. Scrubbing is a term of art used to describe the process of removing all data that can be used, alone or in combination, to identify the patient.

The server communication module 206 further functions to receive reports from the central laboratory server 110. A report can comprise, for example, a hyperlinked document, a graphic user interface, executable code or a physical document. Reports may also be accessed via a secure web portal. The server communication module 206 displays the reports to the third party and allows the third party to interactively browse the reports. In some embodiments, the server communication module 206 allows the third party to specify a format they would like to receive a report in or specific types of data (e.g. pathways data, clinical trials data, partner biometric data) they would like to include in the reports. In instances where the received report is associated with a patient sample, the server communication module 206 on the third-party client 150 can re-integrate patient information that has been scrubbed from the clinical data 210 into the report.

The node state quantitation module 202 functions to generate raw node state data by communicating with one or more programs or machines used to generate quantitative biological data. In most embodiments, the node state quantitation module 202 will communicate with a flow cytometer to receive raw node state data. In some embodiments, the node state quantitation module 202 will further comprise experiment management software that may be used by the third party to design aspects of flow cytometry experiments such as well/plate design, software for experiment management is fully described in U.S. Ser. No. 12/501,274, the entirety of which is incorporated herein.

The node state quantitation module 202 processes and normalizes the raw signal data generated from quantitation of the activation level of an activatable element. Methods for processing signal data are described in US publication number 2006/0073474 entitled “Methods and compositions for detecting the activation state of multiple proteins in single cells” and below in the sections entitled “Generating Node State Data” and “Modeling Node State Data”. The node state quantitation module 202 transmits the raw signal data to the node state metric module 204 or to the central laboratory server 110 via the server communication module 206.

The node state metric module 204 functions to generate metrics representing different node states based on the raw signal data. The node state metric module 204 generates a “basal” metric characterizing the response of an activatable element by determining the log₂ fold difference in the Median Fluorescence Intensity (MFI) of a sample treated with a modulator divided by a sample that is not treated with a modulator. The node state metric module 204 generates a “total phospho” metric is calculated by measuring the autofluorescence of a cell that has been stimulated with a modulator and stained with a labeled antibody. The node state metric module 204 generates a “fold change” metric is the measurement of the total phospho metric divided by the basal metric. The node state metric module 204 generates a quadrant frequency metric is the frequency of cells in each quadrant of the contour plot.

According to the embodiment, the node state metric module 204 may generate any of the following metrics: 1) a metrics that measures the difference in the log of the median fluorescence value between an unstimulated fluorochrome-antibody stained sample and a sample that has not been treated with a stimulant or stained (log(MFI_{Unstimulated Stained})−log(MFI_{Gated Unstained})), 2) a metric that measures the difference in the log of the median fluorescence value between a stimulated fluorochrome-antibody stained sample and a sample that has not been treated with a stimulant or stained (log(MFI_{Stimulated Stained})−log(MFI_{Gated Unstained})), 3) a metric that measures the change between the stimulated fluorochrome-antibody stained sample and the unstimulated fluorochrome-antibody stained sample log(MFI_{Stimulated Stained})−log(MFI_{Unstimulated Stained}), also called “fold change in median fluorescence intensity”, 4) a metric that measures the percentage of cells in a Quadrant Gate of a contour plot which measures multiple populations in one or more dimension 5) a metric that measures MFI of phosphor positive population to obtain percentage positivity above the background and 6) use of multimodality and spread metrics for large sample population and for subpopulation analysis.

In some embodiments, the node state metric module 204 will generate an equivalent number of reference fluorophores value (ERF) which is a transformed value of the median fluorescent intensity values. The ERF value is computed using a calibration line determined by fitting observations of a standardized set of 8-peak rainbow beads for all fluorescent channels to standardized values assigned by the manufacturer. The ERF values for different samples can be combined in any way to generate different node state metric. Different metrics can include: 1) a fold value based on ERF values for samples that have been treated with a modulator (ERFₘ) and samples that have not been treated with a modulator (ERFᵤ), log₂ (ERFₘ/ERFᵤ); 2) a total phospho value based on ERF values for samples that have been treated with a modulator (ERFₘ) and samples from autofluorescent wells (ERFₐ), log₂ (ERFₘ/ERFₐ); 3) a basal value based on ERF values for samples that have not been treated with a modulator (ERFᵤ) and samples from autofluorescent wells (ERFₐ), log₂ (ERFᵤ/ERFₐ); 4) A Mann-Whitney statistic Uᵤ comparing the ERF_{m and} ERFᵤ values that has been scaled down to a unit interval (0,1) allowing inter-sample comparisons; 5) A Mann-Whitney statistic Uᵤ comparing the ERF_{m and} ERFᵤ values that has been scaled down to a unit interval (0,1) allowing inter-sample comparisons; 5) a Mann-Whitney statistic Uₐ comparing the ERFₐ and ERFₘ values that has been scaled down to a unit interval (0,1); and 6) A Mann-Whitney statistic U75. U75 is a linear rank statistic designed to identify a shift in the upper quartile of the distribution of ERFₘ and ERFᵤ values. ERF values at or below the 75^{th} percentile of the ERFₘ and ERFᵤ values are assigned a score of 0. The remaining ERFₘ and ERFᵤ values are assigned values between 0 and 1 as in the Uᵤ statistic. For activatable elements that are surface markers on cells, the node state metric module 204 may further generate: 1) a relative protein expression metric log 2(ERFₛₜₐᵢₙ)−log 2(ERF_{control}) based on the ERF value for a stained sample (ERFₛₜₐᵢₙ) and the ERF value for a control sample (ERF_{control}); and 2) A Mann-Whitney statistic Ui based the comparing the ERFₘ and ERFᵢ values that has been scaled down to a unit interval (0,1), where the ERFᵢ values are derived from an isotype control.

The node state metric module 204 may also function to generate graphical summaries of the node state data such as plots, third-color analysis plots (3D plots); percentage positive and relative expression of various markers.

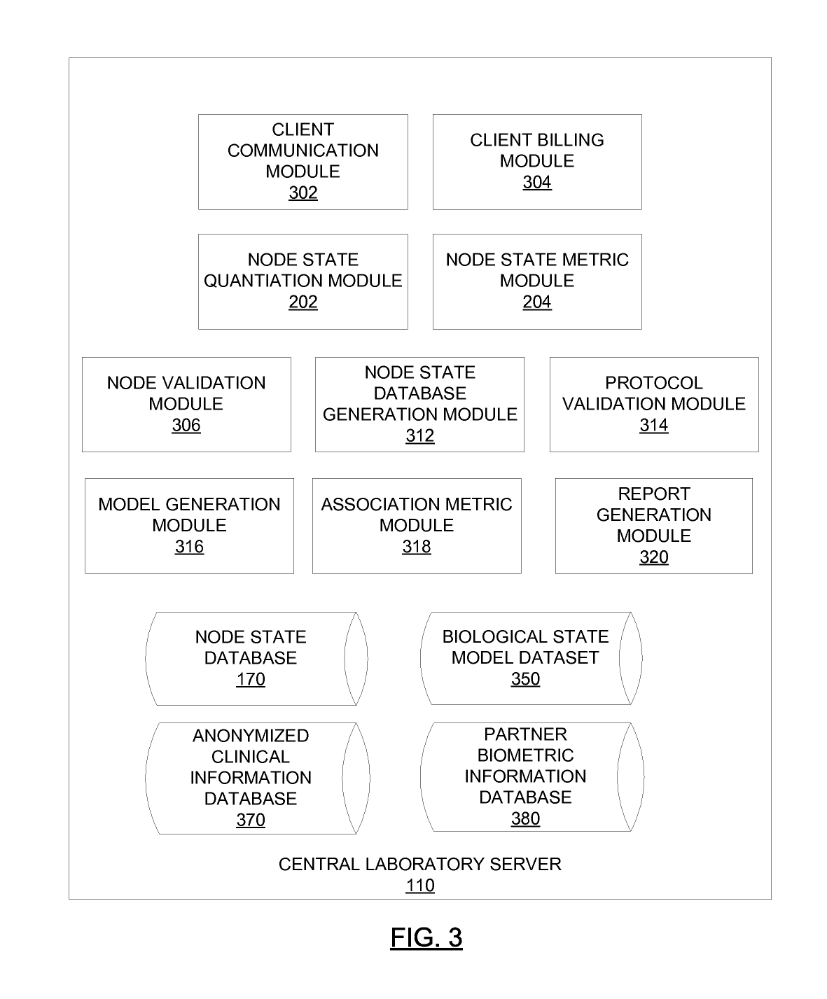

FIG. 3 illustrates one embodiment of the central laboratory server 110. The central laboratory server 110 is adapted to establish secure connections with the third-party client 150 and the partner client 180 to receive data. The central laboratory server 110 comprises a client communication module 302, a client billing module 304, a node state quantitation module 202, a node state database generation module 312, a node validation module 306, a protocol validation module 314, a model generation module 316, an association metric module 318 and a report generation module 320. The central laboratory server 110 further comprises a node state database 170, biological state model dataset 350, an anonymized clinical information database 370 and a partner biometric information database 380. The functions performed by the central laboratory server 110 are separated into modules for the purposes of discussion only. Different embodiments of the present inventions may distribute functions among modules in different ways. Likewise, different embodiments of the present invention may store the different types of data in different arrangements than discussed herein or in databases that are external to the central laboratory server 110.

The client communication module 302 is adapted to establish a secure network to communicate with the third-party clients 150 and the partner clients 180. The client communication module 302 receives node state data and anonymized clinical information from the third-party client 150. The client communication module 302 transmits the node state data to the association metric module for analysis. The client communication module 302 stores the anonymized clinical information in the anonymized clinical information database 370. The client communication 302 module communicates with the report generation module 320 to transmit reports to the third-party clients 150. The client communication module also transmits software updates for the kit modules 200 to the third-party clients 150.

The client communication module 302 further functions to receive clinical biometric information associated with anonymized identifiers from the partner clients 180. Clinical biometric information can include, but is not limited to, information derived from: histology, RT-PCR, expression analysis, karyotyping, single nucleotide polymorphism (SNP) analysis and other information derived from flow cytometry and mass spectrometry. The client communication module 302 stores the clinical biometric information in associated with the anonymized identifier in the partner biometric information database 380.

The client billing module 304 functions to determine the cost of the services provided to the third parties. The client billing module 304 communicates with the report generation module 320 and the client communication module 302 to determine the number of reports transmitted to each third-party client 150 and the amount of processing performed at the central laboratory to generate each report. In some embodiments, a separate billing system will exist to change third parties that transmit physical samples to the central laboratory for processing.

The client billing module 304 determines the amount of processing performed by the central laboratory by identifying internal tracking numbers associated with the node state data or physical samples received from the third parties. As described below, the central laboratory can receive and process physical samples at several points in the data generation process. The client billing module 304 determines the cost of the services provided based on both amount of processing performed by the central laboratory and the data analysis services provided such as the number of nodes/parameters analyzed by the central laboratory. In some embodiments, the client billing module 304 determines the cost of services provided based on the quality of data received. The third party may be charged less for good quality samples, treated samples or node state/signal data. In some embodiments, the client billing module 304 determines the cost of the services provided based on the number of samples processed or the type of third party client. For example, an academic or government customer may be charged a different rate for services provided than a pharmaceutical company or a collaborator. Additionally, third party customers may be charged different rates for services based on whether they purchased kits or calibration kits from the central laboratory. These third party customers may also be charged different rates for services provided based on the volume of kits they purchase from the central laboratory. Third parties that have the capacity to produce node state data may only require data analysis services and access to the node state database 170. These third parties may be charged on a subscription basis. Rates for data analysis services may also differ for third parties that purchase kits or calibration kits from the central laboratory. Third parties who do not allow the central laboratory to store their node state data in the node state database 170 can be charged a higher rate than third parties who allows the central laboratory and others to access their data via the node state database 170.

The node state quantitation module 202 and the node state metric module 204 function as described above with reference to FIG. 2. Both the node state metric module 204 and the node state quantitation module 202 are adapted to communicate with the node validation module 312, the node state database generation module 312 and the protocol validation module 314.

The node state database generation module 312 functions to generate node state data and store the node state data in the node state database 170. The node state database generation module 312 communicates with the node state metric module 314 and the association metric module 318 to store node state data in the node state database 170. The node state databases generation module 312 communicates with the protocol validation module 314, the node validation module 312 and the model generation module 312 to generate high-throughput node state data for developing diagnostic and predictive tests used for patient stratification, patient monitoring during clinical trials, diagnosis, or prognosis and perform pilot studies in conjunction with collaborators such as biological supply companies to develop standardized reagents and compounds. The development of high-throughput data for diagnostic development may be further segregated into three stages: a training stage in which a training statistical model is generated as a proof-of-concept, a validation stage in which the accuracy of the statistical model is verified/refined and a pivotal study stage in which the statistical model is applied to clinical samples. The node state database generation module 312 identifies node state data associated with a known biological state for which the test is being developed. The node state database generation module 312 communicates with the protocol validation module 314 to ensure that the protocols, reagents and analytical methods produce consistent node state data. The node state database generation module 312 communicates with the node validation module 306 to verify that the nodes quantified for the high-throughput experiment produce consistent data. The node state database generation module 312 iteratively communicates with the model generation module 316 to verify whether additional samples are needed to generate a statistically accurate model.

The node validation module 306 functions to validate and optimize node state data associated with a candidate “node” or modulator-antibody pair. The node validation module 306 communicates with the node state quantitation module 202 and the node state metric module 204 to evaluate performance of nodes. A candidate node is any known or hypothesized activatable element in a cell, but is of limited use until it has been validated and characterized so that researchers know how to measure different node states and what these different node states represent. In general, these node states represent the activation state of a pathway, either the baseline state observed at a particular time and under particular conditions in a patient or the activatable state of the pathway at the same times. This activatable state in a particular cell type represents the net effect of the different genetic, epigenetic, and other cellular perturbations which influence the underlying physiological state of the cell which cumulatively contribute to the disease state of the patient thus determining types of therapies most likely to be effective. For example, although there are many candidate nodes in the JAK/STAT pathway, multiple receptors, each of which respond to distinct ligands, converge on the JAK/STAT pathway). Validation of these nodes, including which nodes respond to pathway stimulation through certain ligands acting on certain receptors, enables biologically meaningful monitoring of cell signaling activity. Examples of validated nodes include p38 (MAPK pathway) for monitoring cell cycle arrest; ERK1/2 (Ras pathway) for monitoring cell cycle progression; AKT, ERK, and S6 (PI3K and Ras pathways; for review of the pathways, see J. Downward, Targeting RAS and PI3K in lung cancer. Nat. Med. 14: 1315-26, 2008) for monitoring cell growth, proliferation and survival; and AKT, GSK313, and NFκB (PI3K pathway; for a review of the pathway, see Vivanco I, Sawyers C L. The phosphatidylinositol 3-Kinase AKT pathway in human cancer. Nat Rev Cancer. 2:489-501, 2002.) for measuring cell cycle progression, glucose metabolism, and apoptosis.

In most embodiments, nodes will be evaluated over several sets of experimental conditions such as titration curves, activation curves, or kinetic analyses. The node validation module 306 determines performance metrics for the nodes using any of the following: confidence intervals, Gaussians, expectation maximization (EM), population density modeling, and histograms. Other metrics are discussed below in the section entitled “Modeling Node State Data”. For nodes with performance metrics indicating good reproducibility and standardization, kits are developed including composition comprising the standardized modulator-antibody pair. In instances where the third party is a biological supply company collaborator, node performance metrics may be incorporated into reports that are transmitted to the third party client 150.

In a specific embodiment, the node validation module 306 will be used for pathway analysis. The researcher may identify extracellular modulators that activate the node. For example, contacting a cell with oxidative agents may activate p38. Then, the researcher may identify receptors and upstream activators of node. For example, MKK3/6 may phosphorylate p38. Then, the research may determine which pathway or pathways the node participates in, also referred to as pathway data. For example, a researcher may determine that p38 functions in the MAPK pathway. Finally, the researcher may identify cell lines for node optimization (measure expression of receptor to be activated in assay). In another specific embodiment, the node validation module 306 may be used for reagent validation: Researchers may validate fluorochrome-conjugated phospho-Antibodies (p-Abs), if available, from different vendors to identify an optimal standardized set of reagents that may be used in future protocols. If only unconjugated antibodies are available, the researcher may use fluorochrome-conjugated secondary antibodies. In another specific embodiment, the node validation module 306 may be used for experimental implementation: Researchers will then determine optimal conditions and perform experiments under these conditions. Researchers may perform titrations of modulators and p-Abs in cell lines and primary cells (PBMCs, BMMCs). Researchers may also perform kinetics studies to determine optimal conditions for identifying node activation. Researchers may also perform control experiments to determine the specificity of a p-Ab. In the preferred embodiment, this control is performed by pre-incubating the p-Ab with phospho or non-phospho-peptide epitopes and comparing the different amount of bound antibody for each class of epitope. In another specific embodiment, the node validation module 306 may be used for clinical validation of the meaning of the nodes.

The protocol validation module 306 functions to validate and optimize experimental protocols used to generate node state data. The protocol validation module 306 may be used for standardization of reagents and protocols. This standardization will result in the same reportable results, regardless of the machine used to perform the assay, for example a flow cytometer or mass spectrometer, will make the methods of the invention robust to operator variability, and will allow intra- and inter-laboratory comparisons to be made between samples and across time.

In most embodiments, node state data will be generated and evaluated over several sets of experimental conditions corresponding to different reagents such as titration curves, titration curves over different cell types, titration curves over samples with different complexity (i.e. heterogeneity of cell types) and titration curves over samples with different states (e.g. cryopreserved or damaged cells). The protocol validation module 306 determines performance metrics for the reagents or protocols using any of the following: confidence intervals, Gaussians, expectation maximization (EM), population density modeling, and histograms. Other metrics are discussed below in the section entitled “Modeling Node State Data”. For reagents, protocols and analytical methods with performance metrics indicating good reproducibility and standardization, kits are developed including composition comprising the standardized modulator-antibody pair.

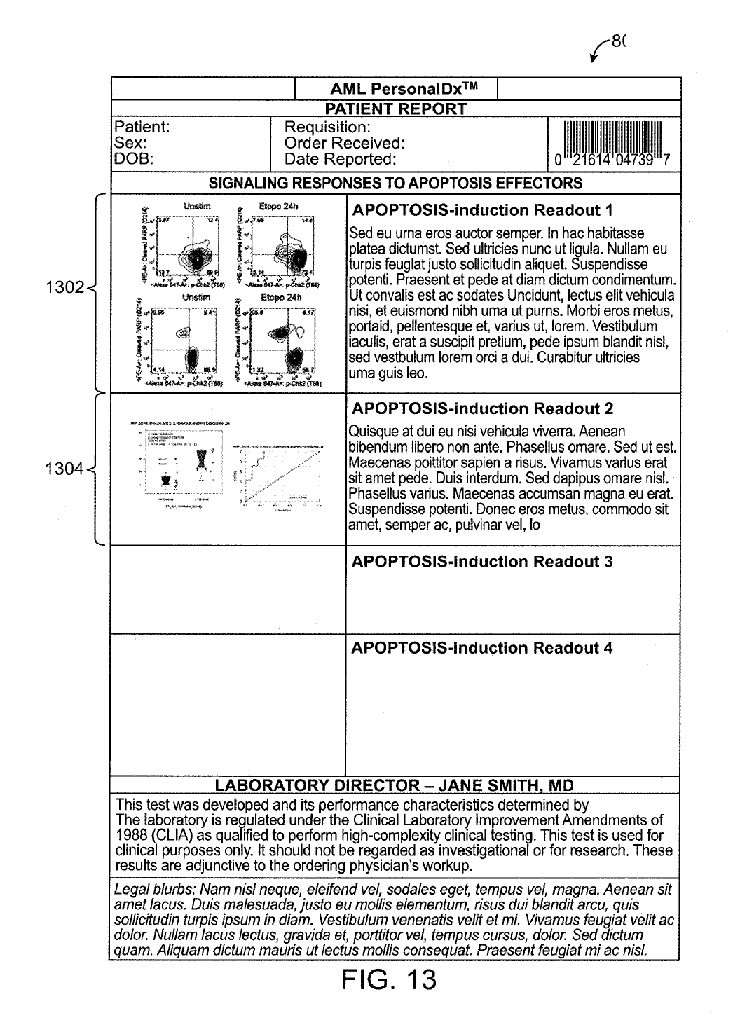

In some embodiments, the protocol validation module 306 may be used to standardize reagents by performing vendor qualification for a reagent and its targeted use on a one-to-one basis. For example, for a certain activatable element or CD group, available antibodies may be evaluated, and a certain antibody selected, so that the same antibody is always used to identify the activatable element or CD group. In some embodiments, the protocol validation module 306 may be used to standardize reagents by establishing ideal concentration for use for each separate order and lot. In some embodiments, the protocol validation module 306 may be used to standardize reagents by developing in-house “product” for assays. All sites will use antibodies per protocols and limitations set forth in the kit instructions. Additional parameters that may be standardized using the protocol validation module 306 include, but are not limited to experimental design, data acquisition, data storage, data tracking, data analytics and visualization, collection and representation of single cell data in the context of network pathways, methods for rare cell population discovery, methods for quantification of cell populations, representation of cell population data. The integration of these standardized forms of information may subsequently be used to facilitate one or more processes, including, but not limited to: quality assurance, quality control, data mining, research discovery, clinical development, laboratory automation, patient stratification, and GxP (Good Practice) environment compliance. In some embodiments of the invention, cell classification involves combining two or more metrics. Standardization permits cells to be classified using metrics obtained from two different experiments, for example, pSTAT5 levels after GM-CSF stimulation and pATK after FLT3L stimulation (For example, see FIG. 13 in U.S. Ser. No. 61/146,276). In some embodiments, metrics are specified prior to experimental execution. The use of prescribed metrics (see above for discussion and examples of calculating metrics) will standardize data on cell signaling, and facilitate the comparison of data from different patients, samples or experiments.

The model generation module 316 generates statistical models based on node state data generated from samples associated with a known biological state. Example biological states for which models are built are discussed below in the section titled “Specific Embodiments”. The statistical models specify properties of node states that can be used to characterize the biological state of the set of samples. The statistical models can specify characteristics of node state data associated with activatable element, modulator or experimental condition. For example, a correlation model may be built that specifies the correlations between node state data for pairs of activatable elements over one modulator or a set of modulators. Methods for generating correlation and other statistical models are discussed below in the section entitled “Modeling Node State Data”. In instances where the statistical model includes only one sample, a percentile or median node state metric may be specified as a characteristic of the sample. The model generation module 316 uses machine-learning methods to generate statistical models such as: logistic regression, random forest analysis, support vector machine (SVM) analysis, Bayesian analysis, neural network analysis, nearest-neighbor analysis, state transition models, boosting analysis and bagging analysis. Other machine-learning methods will be known to those skilled in the art. The model generation module 316 generates performance metrics that specify the accuracy of the statistical models such as confidence values and receiver operator curves (ROC). The model generation module 316 stores the statistical models in the biological state models dataset 350.

In some embodiments, the model generation module 316 generates statistical models that characterize the association between node states and continuous numeric data such as survival analysis, odds ratios and hazard ratios. In one embodiment, the model generation module 316 generates statistical models that characterize the association between node state data and surrogate markers of a clinical outcome. In some embodiments, node state data is generated from samples associated with different levels of a surrogate clinical marker. The model generation module 316 generates statistical models which specify node states that correspond to quantities of the surrogate marker.

The association metric module 318 generates association values that represent the association between a sample and a biological state. The association metric module 318 generates association values by applying the statistical models stored in the biological state model dataset 350 to node state data associated with samples. The association metric module 318 communicates with the node state metric module 204 to receive node state data generated from samples processed by the central laboratory. The association metric module 318 communicates with the client communication module 302 to receive node state data received from third-party clients 150. The association metric module 318 retrieves one or more statistical models from the biological state model dataset 350 and applies the statistical models to the node state data. According to the embodiment, applying the statistical model to the node state data may comprise classifying the node state data according to the statistical model or correlating the node state data to the statistical model. In some instances, a third party will specify that a specific test is to be performed on a sample and one or more data models will be retrieved and applied based on the specified test. For example, a physician may order hematological malignancy test for a sample and statistical models characterizing different types and/or sub-types of hematological malignancies will be retrieved from the biological state models dataset 350 and applied to the node state data associated with the sample. Likewise, a pharmaceutical company may order a test that characterizes a sample's response to a drug and a set of statistical models characterizing different pathways associated with drug response may be retrieved and applied to the model.

According to the embodiment and the type of statistical model used, the association metric module 318 can generate different types of association metrics. The association metric module 318 may generate a probability value that specifies the probability that a sample is in a biological state. The association metric module 318 may generate a binary value that specifies whether or not the sample is in the biological state. The association metric module 318 may generate a correlation value that specifies a correlation of the sample to a biological state. The association metric module 318 may further generate a confidence metric that specifies the statistical confidence associated with any of the above values.

The association metric module 318 further associates the node state data with a biological state and stores the node state data in association with the biological state in the node state database 170 if the association metric and confidence metric exceed a threshold value. For example, if the association metric for a sample specifies an 80% probability of the sample being in a state of non-response to drug and the statistical confidence of the probability value is 95% percent, then the node state data may stored in the database in association with the state of non-response to the drug. The stored data may then be used by the model generation module 316 to generate a new statistical model. Continuing the above example, the module generation module 316 may generate a new statistical model characterizing non-response to the drug.

In one embodiment, the report generation module 320 generates interactive reports which a third party can navigate to view report information. Reports can be displayed as a graphical user in a web browser or kit module 200 software on the third party client 150. Reports can also contain executable code or hyperlinks. The report generation module 320 further generates static reports such as hard copy documents.

The report generation module 320 functions to generate reports for the third parties based on the node state data and the association metrics. The report generation module 320 combines node state data and association metrics for a sample with additional information from public bioinformatics databases 175 and partner biometric information databases 380 to generate reports. The report generation module 320 retrieves data associated with biological states from external sources such as pathways databases 160 and public bioinformatics databases 175 and combines this data with the node state data and association metrics to generate a report. In some embodiments, the report generation module 320 periodically retrieves this data and stores the data in association with the statistical models in the biological state model dataset 350. The report generation module 320 retrieve clinical information associated with a sample from the partner biometric information databases 380. The report generation module 320 may also retrieve node state data associated with prior reports for the client from the node state database 170.

The report generation module 320 communicates with the node state metric module 204 and the model generation module 316 to generate graphical summaries of node state data. Graphical summaries of the data include, for example, bar plots of node state data, gated plots of node state data, line plots of node state data, pathway visualizations of node state data. The report generation module 320 further communicates with the association metric module 318 to produce textual summaries of association metric data. Textual summaries may include a diagnostic of a disease state in a patient, recommended treatment regimen for a patient, a grade disease-subtype of a patient or a prognosis for a patient. Other textual summaries will be apparent to those skilled in the art based on the biological states that the association metrics are used to characterize. The report generation module 320 incorporates graphical and textual summaries of the node state data into the report.

In most embodiments, the report generation module 320 then transmits the generated report to the third party client 150 via the client communication module 302 or displays the generated report to the third party client 150 via a secure web portal. In other embodiments, the report generation module 320 physically transmits a report to the third party as a hard copy paper document or as executable code encoded on a computer-readable storage medium.

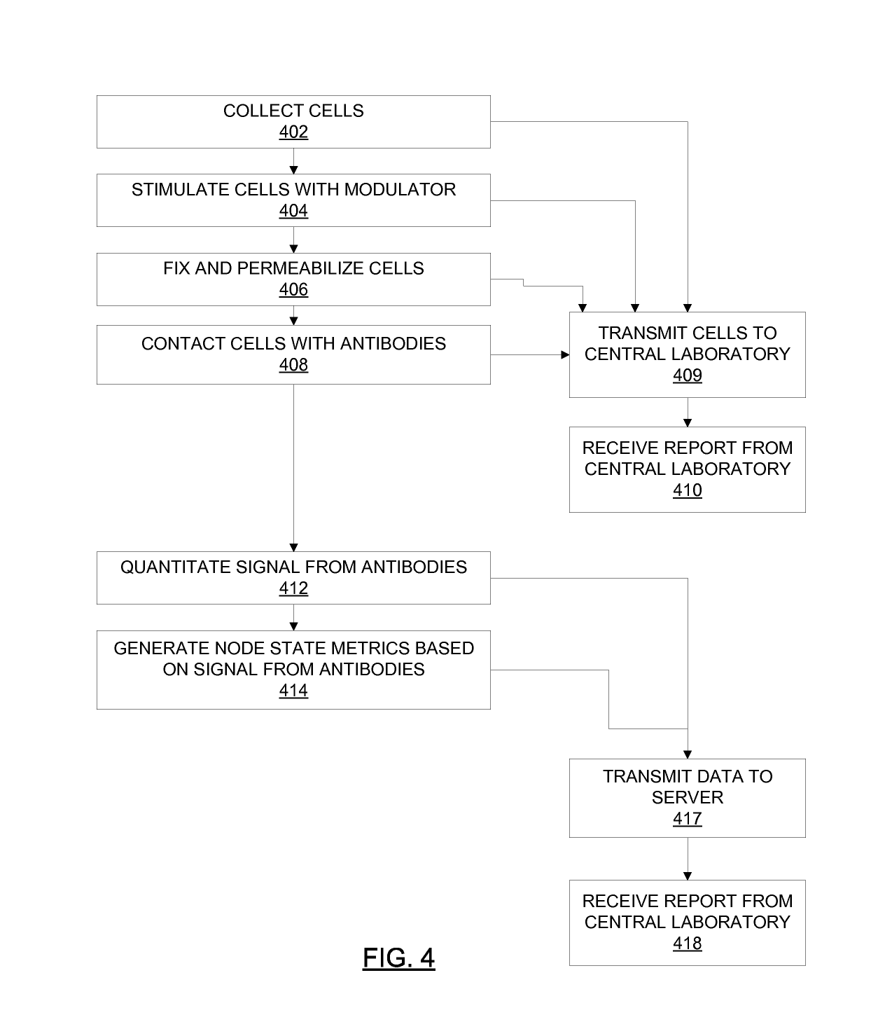

FIG. 4 illustrates alternate series of steps performed by a third party customer or collaborator to receive reports from the central laboratory server.

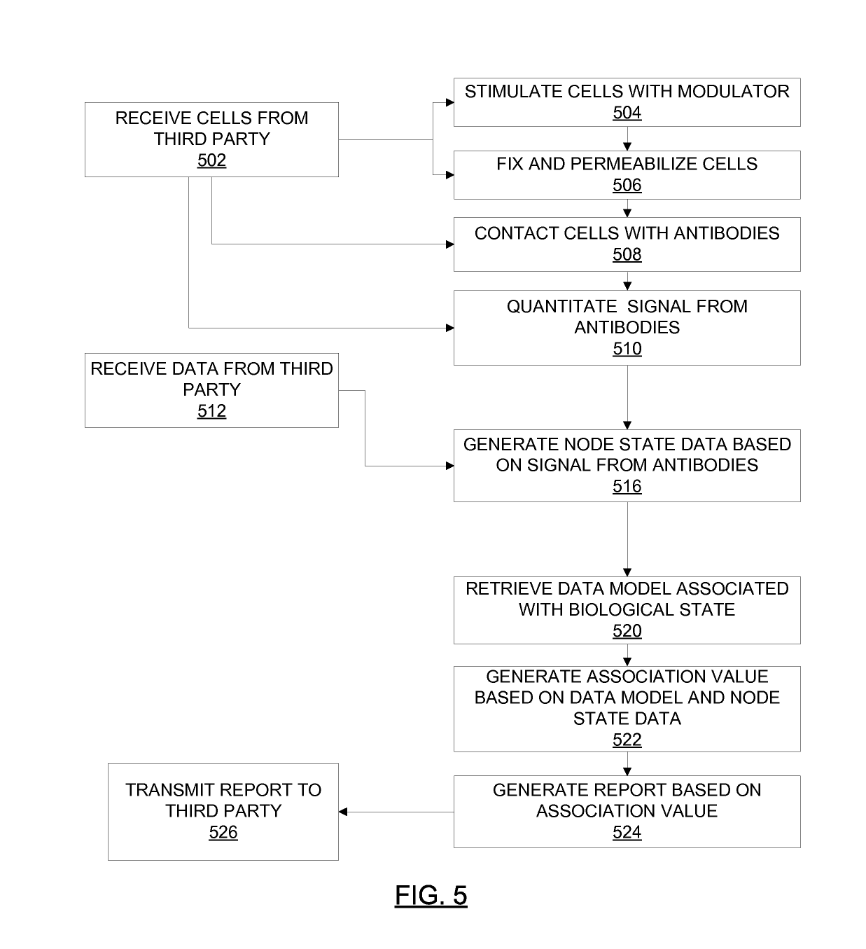

The third party collects 402 a sample comprising a population of one or more cells. The third party can then transmit 409 the cells to the central laboratory for testing and receive 410 a report from a central laboratory, e.g. the central laboratory server 110. Steps following the samples being transmitted to the central laboratory are as described below with respect to FIG. 5. The samples can be transmitted with requisition data. Also, before transmitting the cells to the central laboratory the third party may suspend the cells in a reagent or otherwise treat the cells to minimize damages. These reagents and treatments may be purchased from the central laboratory as a node kit comprising protocols for collecting samples. Kits are discussed below in the section entitled “Kits”.

Alternately, the third party can follow one or more steps outlined for the analysis of the activation state of the cells, the process is described below and in incorporated references. For example, the third party can stimulate 404 the collected cells with a modulator. Example modulators are discussed below in the section titled “Modulators”. The third party can purchase a modulator that has been validated by the central laboratory to produce standardized node state data as part of a node kit comprising protocols for stimulating cells. The third party can then transmit 409 the sample to the central laboratory and receive 410 a report from the central laboratory server 110.

Alternately, the third party fixes and permeabilizes 406 the stimulated cells. If the third party has collected and stimulated the cells using a kit, the third party can fix and permeabilize the collected cells according to protocols developed by the central laboratory to optimize and standardize these processes. The third party can then transmit 409 the cells to the central laboratory and receive 410 a report from the central laboratory server 110.

Alternately, the third party can contact 408 the permeabilized cells with one or more antibodies. The third party may purchase antibodies that have been validated by the central laboratory to produce standardized node state data as part of a node kit comprising protocols for contact cells with antibodies. The third party can then transmit 409 the cells to the central laboratory and receive 410 a report from the central laboratory server 110.

Alternately, the third party can quantitate 412 signal from the antibodies (i.e. activation level of one or more nodes) using any type of technique that is appropriate for single cell analysis including flow cytometry, laser cytometry and mass spectrometry. Prior to quantitating signal from the antibodies, the third party may calibrate their flow cytometer or other instrument using a calibration kit developed by the central laboratory comprising reagents and protocols for instrument calibration. The third party may also design their experiment using kit software modules 200 developed by the central laboratory and installed on the client 150 operated by the third party. The third party collects and transforms signal data generated from the instrument using kit module software 200. The third party server 150 can then transmit 417 the signal data to the central laboratory and receive 410 a report from the central laboratory server 110.

Alternately, the third party server 150 can generate 414 node state data based on the signal data using the kit software modules 200. The third party server 150 can then transmit 417 the signal data to the central laboratory and receive 410 a report from the central laboratory server 110.

In a first specific embodiment, the third party is a physician or medical center. In this embodiment, the physician or medical center collects 402 one or more samples, treats the samples with reagent purchased from the central laboratory and transmits 409 the samples directly to the central laboratory in association with requisition data. The physician or medical center receives 410 a report comprising node state data generated from the samples from the central laboratory server 110.

In a second specific embodiment, the third party is an academic or government institution. The academic or government institution collects 402 one or more samples, treats the samples, stimulates 404 the samples with one or more modulators comprised in a kit purchased from the central laboratory, fixes and permeabilizes 406 the samples according to protocols comprised in a kit, in one embodiment it is purchased from the central laboratory, contacts 408 the samples with antibodies comprised in a kit optionally purchased from the central laboratory. The academic or government institution then transmits 409 the samples directly to the central laboratory in association with requisition data. The academic or government institution receives 410 a report comprising node state data generated from the samples from the central laboratory server 110.

In a third specific embodiment the third party is a biotechnology company such as a pharmaceutical or diagnostics company. The biotechnology company collects 402 one or more samples, treats the samples, stimulates 404 the samples with one or more modulators comprised in a kit optionally purchased from the central laboratory, fixes and permeabilizes 406 the samples according to protocols comprised in a kit optionally purchased from the central laboratory, contacts 408 the samples with antibodies comprised in a kit optionally purchased from the central laboratory, quantitates 412 signal associated with the antibodies using kit software installed on the third party client 150, generates 414 node state metrics based on the signal using kit software installed on the third party client 150 and transmits 417 the node state metrics to the central laboratory server 110 in association with requisition data using kit software installed on the third party client 150.

FIG. 5 illustrates alternate series of steps performed by the central laboratory and the central laboratory server 110 operated by the central laboratory to generate reports for third parties.

The central laboratory receives 502 a population of cells comprising a sample from the third party. The received sample is accompanied by requisition data specifying a unique identifier for the cells, tests to be performed on the cells and the stage of processing the cells. Other data may be included in the requisition data including anonymized clinical data. The requisition form may also include the type of modulators to use, design parameters, specific antibodies to be measured and other types of experiment parameters.

The central laboratory assigns a tracking identifier such as a bar code to the received sample. The central laboratory determines the type of processes to be performed based on the requisition data. If the received cells are untreated with a modulator, in some instances the central laboratory stimulates 504 the cells with a modulator according to the requisition data, fixes/permeabilizes 506 the cells, contacts 508 them with antibodies and quantitates 510 signal from the antibodies. If the received cells treated with a modulator but not fixed and permeabilized, the central laboratory fixes and permeabilizes the cells, contacts 508 with antibodies and quantitates 510 signal from the antibodies. If the cells are fixed and permeabilized but not contacted with antibodies, the central laboratory contacts 508 the cells with antibodies according to the requisition data and quantitates 510 signal from the antibodies. If the cells are contacted with antibodies but the signal from the antibodies is not quantitated, the central laboratory operates the central laboratory server 110 to quantitate the signal from the antibodies using techniques appropriate for single cell analysis such as flow cytometry, laser cytometry and/or mass spectrometry. The central laboratory server 110 then uses the signal from the antibodies to generate and transmit reports as described below.

The central laboratory server 110 also receives 512 data associated with samples directly from the third party. Data received from the third party includes tracking identifiers and requisition data. If the central laboratory server 110 receives raw signal data, the central laboratory server 110 generates node state data based on the raw signal data and processes the node state data to generate and transmit reports as described below. If the central laboratory server 110 receives node state data, then the

For all samples received, the central laboratory server 110 retrieves one or more data models associated with biological states. The central laboratory server 110 may identify the data models to retrieve based on the tests specified in the requisition data. The central laboratory server 110 may also identify the data models to retrieve based, in part, on the node state data associated with the sample.

In one embodiment, the central laboratory server 110 generates 522 an association metric that specifies a statistical association between the sample and a biological state. The central laboratory server 110 generates 524 a report based on the association metric.

According to the embodiment, the report may be transmitted to the third party in different ways. In one embodiment, the central laboratory server 110 transmits 526 the report to the third party client 150 via a web server. In another embodiment, the central laboratory server 110 uses a secure connection to transmit 526 the report to the third party client 150 and store the report in a repository of reports on the third party client 150. Alternately, the central laboratory may transmit a hard copy report to the third party or encode the report on a computer-readable storage medium such as portable memory and transmit the computer-readable storage medium to the third party.

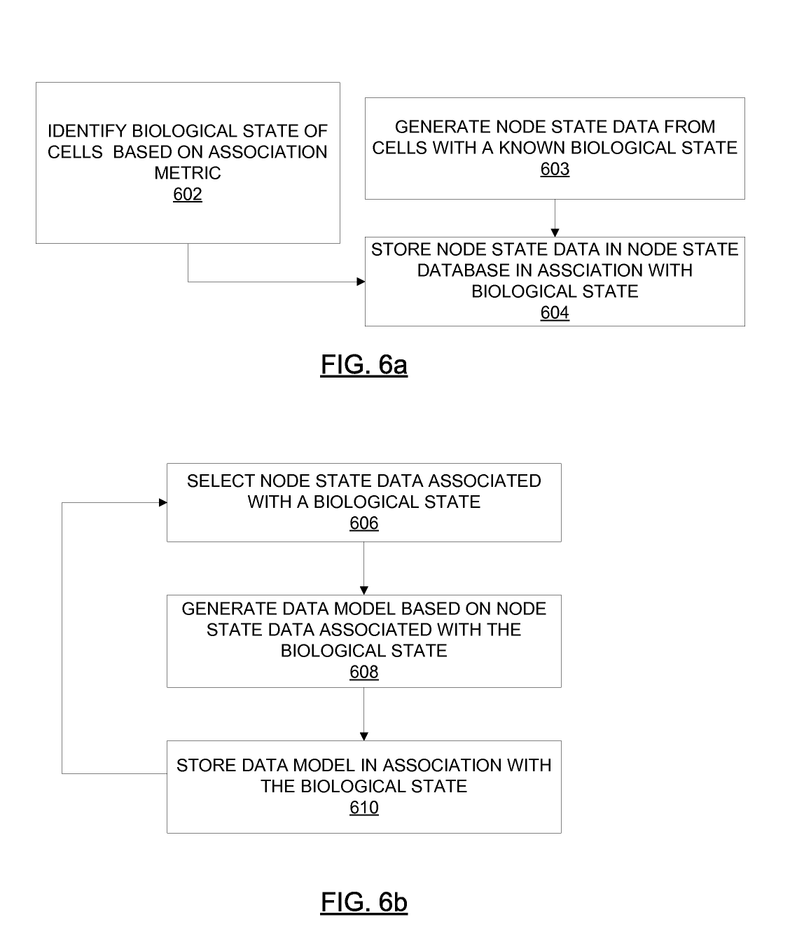

FIG. 6a illustrates steps performed by the central laboratory server 110 to generate node state data corresponding to a biological state and store the node state data in association with the known biological state in the node state database 170.

The central laboratory server 110 generates 603 node state data based on samples that have a known or characterized biological state. The central laboratory server 110 can generate 603 node state data in high-throughput mode, wherein hundreds or thousands of samples with known biological state are processed at the central laboratory and node state data is generated for each sample. Methods for generating 603 node state data are described below in the section titled “Generating Node State Data”. The central laboratory server 110 then stores 604 the node state data in association with the biological state in the node state database 170. The central laboratory server 110 may also use techniques like those described in U.S. Ser. No. 12/501,295 and in the section below titled “Modeling Node State Data” to select a sub-populations of the node state data.

The central laboratory server 110 can also identify 602 node state data that has a high likelihood of being in a biological state and store the node state data in association with the biological state in the node state database 170. The central laboratory server 110 can generate an association metric by applying a statistical model associated with a biological state to the node state data and identifies 602 that the sample has a high likelihood of being in a biological state based on the association metric exceeding a threshold value. The central laboratory server 110 can then store 604 the node state data for the sample in association with the biological state in the node state database 170.

FIG. 6b illustrates steps performed by the central laboratory server 110 to iteratively generate data models that characterize biological states.

In one embodiment, the central laboratory server 110 selects 606 node state data stored in association with the biological state in the node state database 170. The central laboratory server 110 generates 608 a statistical model that specifies node state data used to characterize the biological state. The central laboratory server 110 stores 610 the statistical model in association with the biological state in the biological state model dataset 350. The central laboratory server 110 iteratively re-performs these steps as new node state data associated with the biological state is added to the node state database 170.

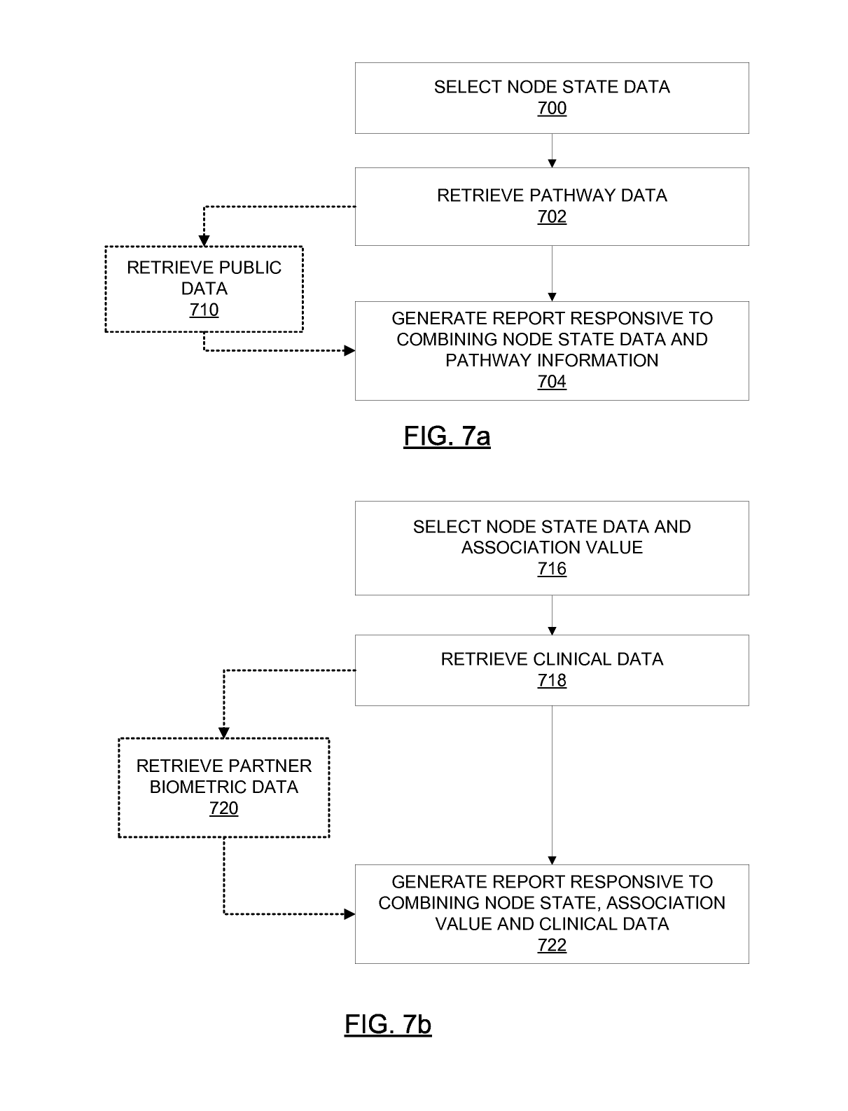

FIGS. 7a and 7b illustrate steps performed by the central laboratory server 110 to generate reports based on node state data and association value data according to embodiments of the present invention. It should be appreciated that different embodiments of the present invention may perform different combinations of steps, in different orders.

The central laboratory server 110 selects 700 node state data and association metrics associated with a sample or a set of samples. The central laboratory server 110 then retrieves 702 pathway data associated with a biological state corresponding to the association metrics from external pathway databases 160. The central laboratory server 110 combines the node state data and pathway data to generate 704 a report. In some embodiments, the central laboratory server 110 further retrieves 710 data from public bioinformatics databases 175 and combines the node state data, data from public bioinformatics databases and pathway data to generate 704 a report.

The central laboratory server 110 selects 716 node state data and association metrics associated with the sample or a patient. The central laboratory server 110 retrieves 718 clinical data 150 associated with the sample or patient and combines the clinical data, the association metrics and the node state data to generate 722 a report. In some embodiments, the central laboratory server 110 further retrieves 720 partner biometric data associated with the sample or patient from the partner biometric database 380 and combines the partner biometric data, the clinical data 150, the association metrics and the node state data to generate 722 a report.

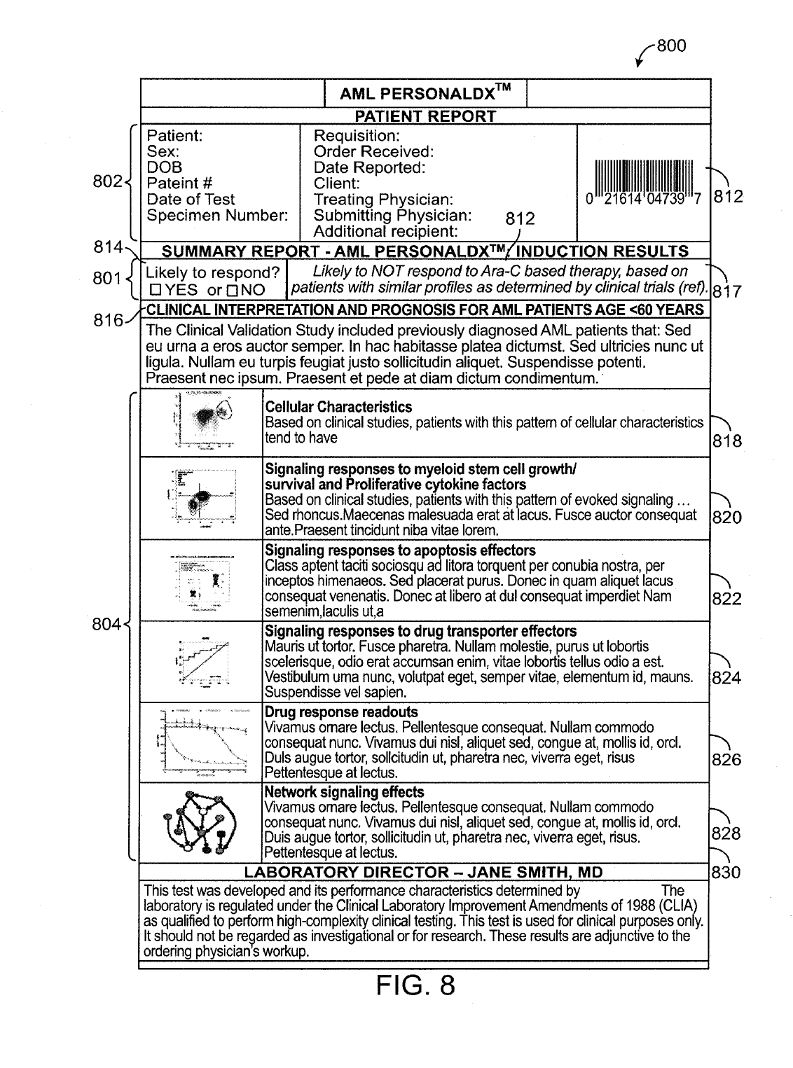

FIG. 8 illustrates a report 800 generated by the central laboratory server 110. In the embodiment illustrated, the report is a graphic user interface that is accessed by a third-party client 150 via the network 100. In other embodiments, the report may comprise a paper document, a hyperlinked document or executable code.

As shown in FIG. 8 the report 800 comprises several sections, each section comprising different types of information. The sample information section 802 comprises information associated with the sample, such as the name or identifier of the patient from whom the sample was taken, the gender of the patient, the date of birth of the patient, the date the test(s) summarized in the report 800 were performed, a requisition form identifier, a date the test order was received, a date the report 800 was generated and transmit to the third party, an identifier or name of the third party, a treating physician, a submitting physician and additional persons who are expected to receive the report 800. The sample information section further includes the tracking identifier 812 used by the central laboratory. In most embodiments, the sample information is re-associated with the node state data and tracking identifier by the report generation module 320 during report generation. In embodiments where personal information such as the patient's name or date of birth is included in the report, this data is integrated into the report by the server communication module after the report has been transmitted to third-party client 150.

The result summary section 801 comprises an actionable result the recipient of the information may use to guide decision making. In the embodiment illustrated, the result summary section 801 includes an association metric 814 and a textual summary 817 of how the association metric is used to guide decision making. Specifically, the illustrated association metric 814 is a binary value that indicates that the sample is in a state of non-response to Ara-C based therapy based on a statistical model of similar patients in a state of non-response to Ara-C based therapy. The textual summary 817 includes a statement that describes the clinical significance of the association metric 814.

The report navigation dashboard 804 displays interactive links to different types of node state data derived from the sample and the associated analyses of the node state data. In the embodiment illustrated the report navigation dashboard comprises links to data describing characteristics of the sample 818. The report navigation dashboard further comprises links to data describing signaling responses of the samples to modulators such as cell growth/survival and proliferative cytokine factors 820, apoptosis receptors 822 and drug transporter receptors 824. The report navigation dashboard 804 further comprises links to data describing drug response readouts 826 and data describing the network signaling effects 828. The types of data illustrated herein are directed to AML treatment and included as an illustrative example. Those skilled in the art will appreciate the benefit of including other types of data for other applications of the present invention.

The laboratory information section 830 includes information specific to the central laboratory such as the director of the central laboratory and certifications of the central laboratory.

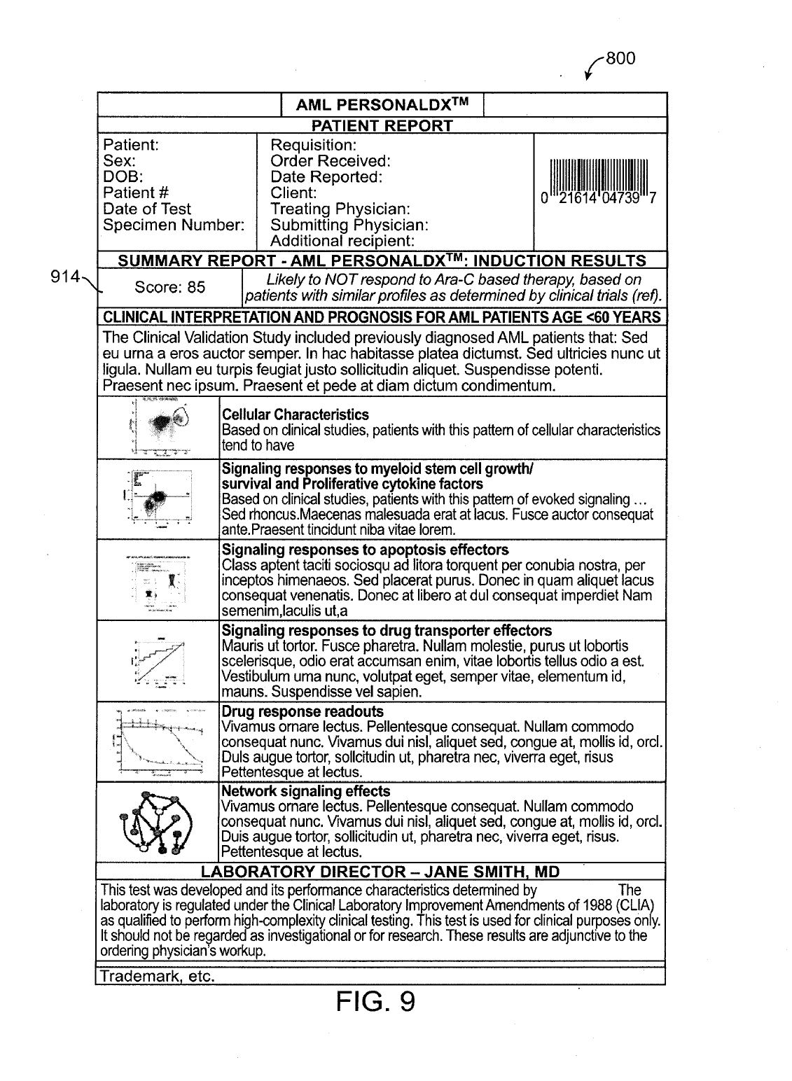

FIG. 9 illustrates an alternate embodiment in which the association metric 914 is a numerical value representing the probability that the sample is the biological state.

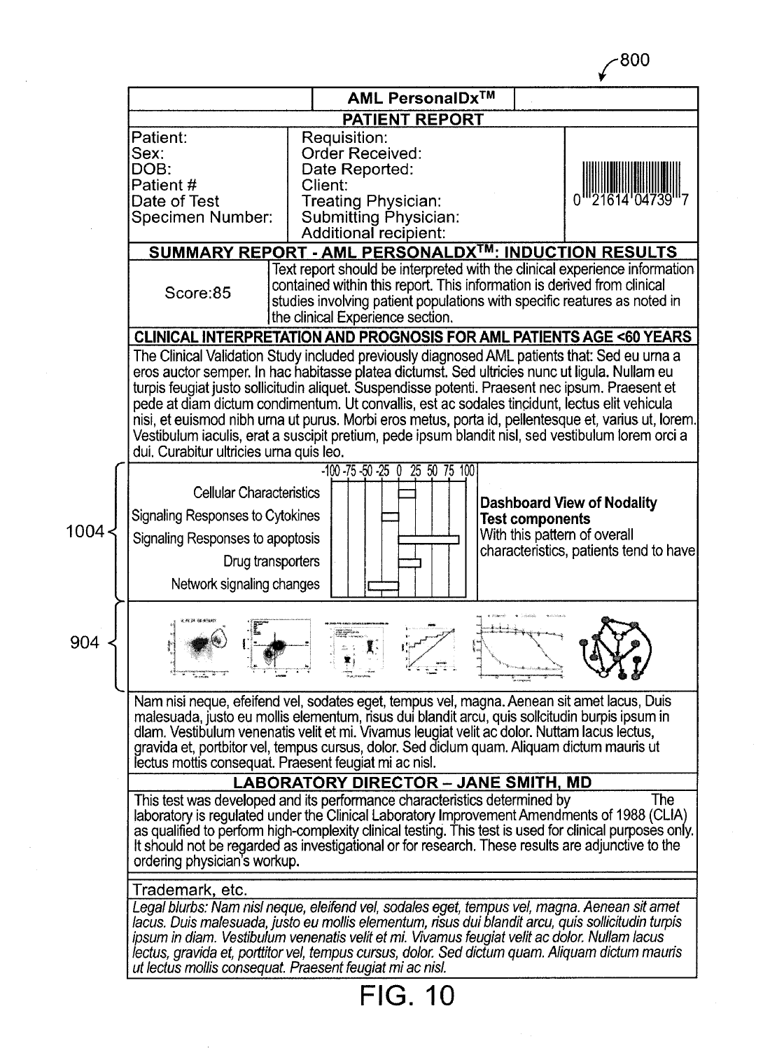

FIG. 10 illustrates an alternate view of the report 800 generated by the central laboratory server 110. The report 800 includes a graphical profile 1004 of the different types of data included in the report 800. In the embodiment illustrated, the graphical profile 1004 comprises a bar graph. In other embodiments, the graphical profile 1004 may include other types of data visualizations such as multi-dimensional plots. The graphical summary 1004 also comprises a textual summary describing biological states such as clinical outcomes associated with the graphical profile.

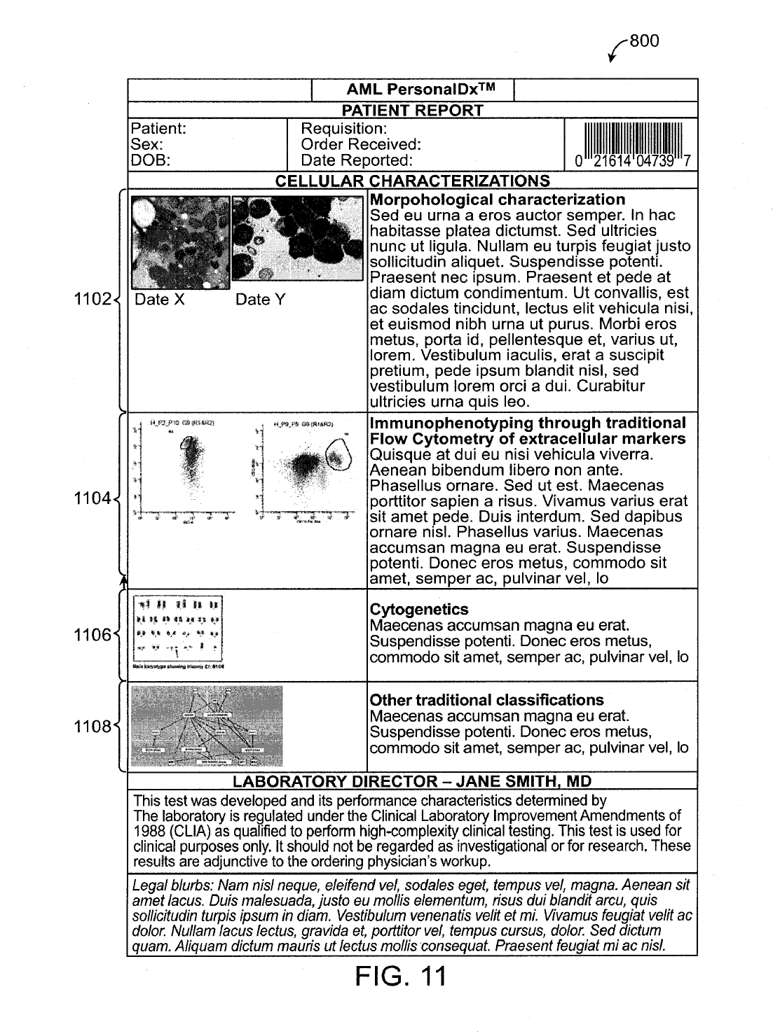

FIG. 11 illustrates an alternate view of the report 800 generated by the central laboratory server 110. The report 800 comprises additional biometric data associated with the sample or patient. The additional biometric data may be generated at the central laboratory or received from a partner client 180. The report 800 comprises histological data 1102 derived from the sample or patient. In the embodiment illustrated, the histological data comprises cell morphology data 1102. The report 800 further includes phenotypic data 1104 derived from the sample or patient. In the embodiment illustrated, the phenotypic data 1104 includes immunophenotypic data obtained through traditional flow cytometry techniques. The report 800 further comprises cytogenetic data 1106 derived from the patient or sample. In the embodiment illustrated, the report 800 comprises a karyotype. The report 800 further comprises other traditional biometric data 1108 used to characterize a sample or patient.

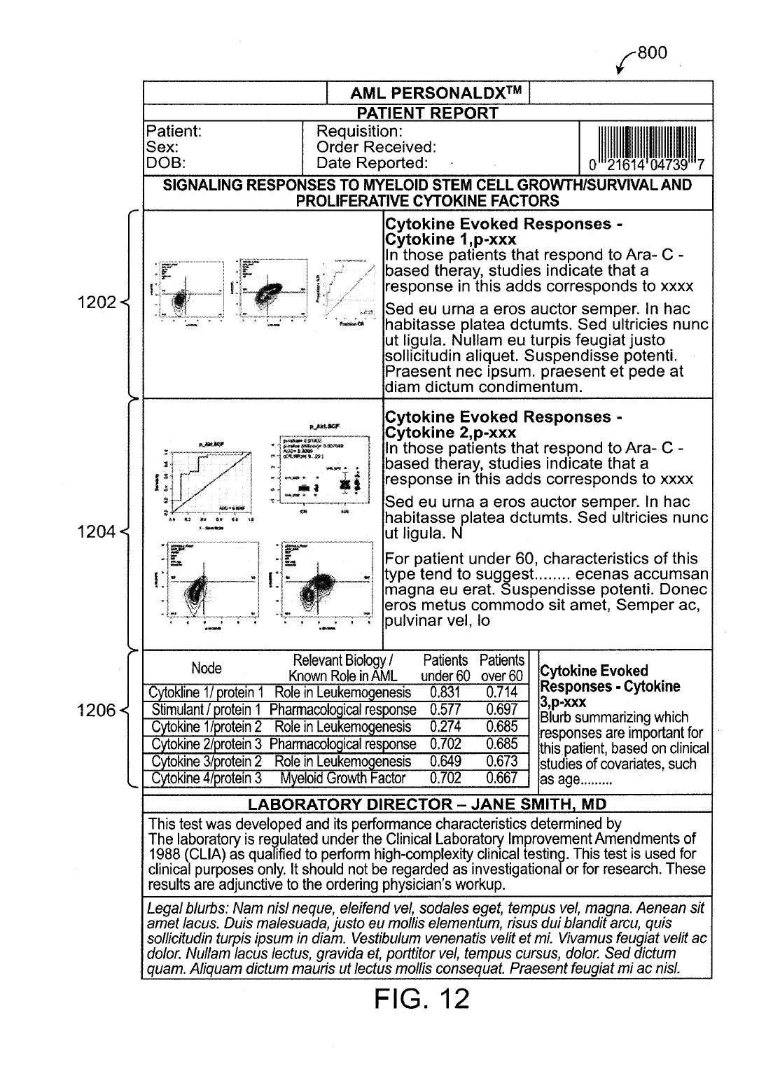

FIG. 12 illustrates an alternate view of the report 800 generated by the central laboratory server 110. The report comprises modulator response sections 1202, 1204, 1206. The modulator response sectors 1202, 1204, 1206 comprise data describing the response of different nodes associated with a modulator. The modulator response sections 1202, 1204 in the report 800 illustrated comprise graphical summaries that represent the quantities of one or more activatable elements (e.g. proteins, phospho-proteins) that are altered by the modulator. In the example illustrated the graphical summaries comprise: “bar and whisker” plots of node state values over populations of samples with the same biological state, scatter plots of raw signal data used to generate node state data and receiver operative curves (ROC) of the accuracy of a statistical model for a biological state.

The modulator response section 1206 further includes a table representing the associated between node state data from different modulators and biological states. In the embodiment illustrated, the modulator response section 1206 includes a table comprising nodes (modulators and activatable elements), the role of the activatable elements in a biological state (AML) and the statistical association between a state of the node and different biological states (AML in patients under 60 and AML in patients over 60).

FIG. 13 illustrates an alternate view of the report 800. The report 800 comprises two modulator response sections 1302, 1304. The modulator response sections 1302, 1304 in the example illustrated comprise graphical summaries that represent the quantities of one or more activatable elements in the sample responsive to stimulation of the sample with an apoptosis inducing modulator. In the example illustrated the graphical summaries comprise gated scatter plots of signal data 1302, “bar-and-whisker” plots 1304 and ROC curves 1304.

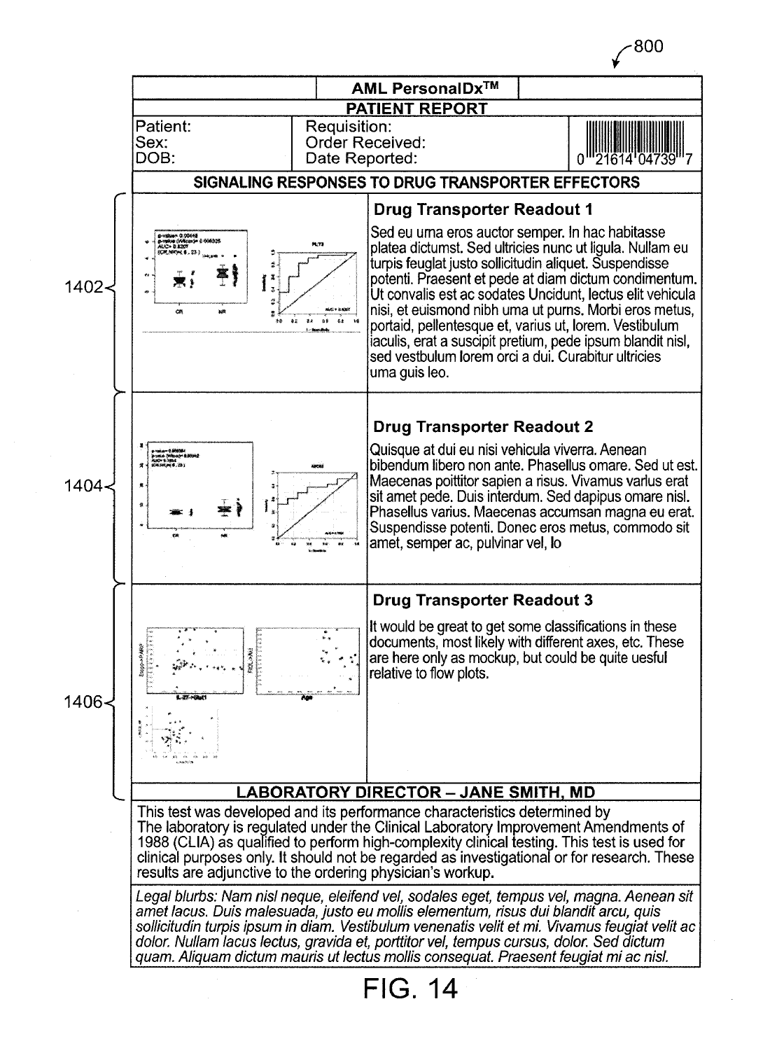

FIG. 14 illustrates an alternate view of the report 800. The report 800 illustrated in FIG. 14 comprises three modulator response sections 1402, 1404, 1406. The modulator response sections 1402, 1404, 1406 comprise graphical summaries that represent the quantities of one or more activatable elements in the sample responsive to stimulation of the sample with different modulators, specifically drug transporter effectors. In the example illustrated in FIG. 14, the graphical summaries comprise: “bar and whisker” plots 1402, 1404, ROC curves 1402, 1404 and scatter plots 1406. Scatter plots may be generated to visualize node state data over different biological states or patient characteristics. Scatter plots may also be generated to compare node state data from different nodes.

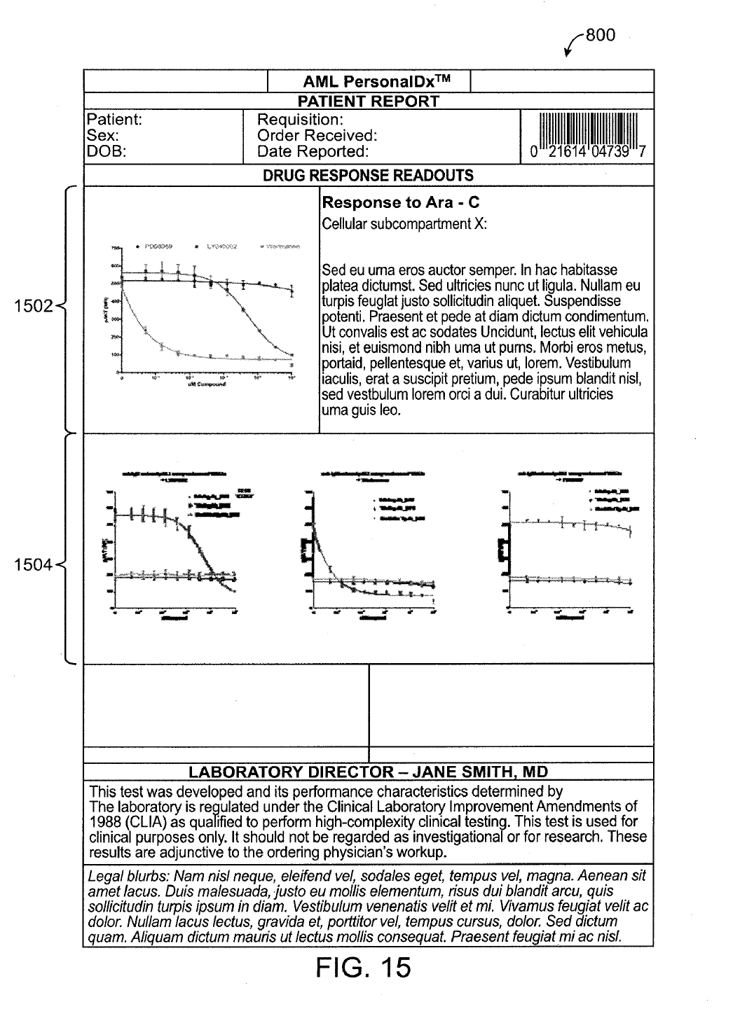

FIG. 15 illustrates an alternate view of the report 800. The report 800 illustrated in FIG. 15 comprises three modulator response sections 1502, 1504. The modulator response sections 1502, 1504 comprise graphical summaries that represent the quantities of one or more activatable elements in the sample responsive to stimulation of the sample with different modulators at different concentrations. In the example illustrated in FIG. 14 the graphical summaries comprise plots of node state data generated responsive to stimulating samples with different concentrations of modulators. Node state data for different nodes associated with the modulators is plotted in association with bars representing the confidence interval associated with the node state data at different modulator concentrations.

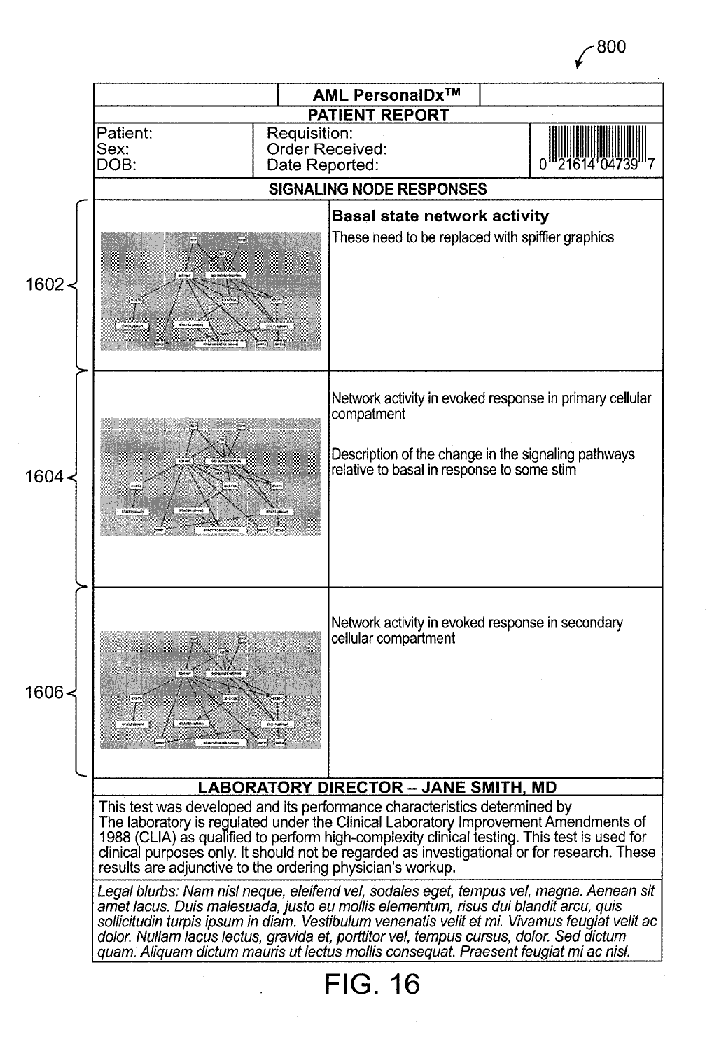

FIG. 16 illustrates an alternate view of the report 800. The report 800 illustrated in FIG. 16 comprises three modulator response sections 1602, 1604, 1606. The modulator response sections 1602, 1604, 1606 comprise graphical summaries that represent the quantities of one or more activatable elements in the sample responsive to stimulation with a modulator. In the example illustrated in FIG. 16 the graphical summaries comprise pathway visualizations of the node state data. The pathway visualizations are annotated to represent the node state data. According to the embodiment, the boxes in the pathway visualization may be colored to represent the node state data, displayed in different sizes according to the node state data and/or displayed in different fonts according to the node state data. In some embodiments, the pathway visualizations are interactive, allowing the user to reconfigure the pathway visualization by clicking on a box representing a activatable element.

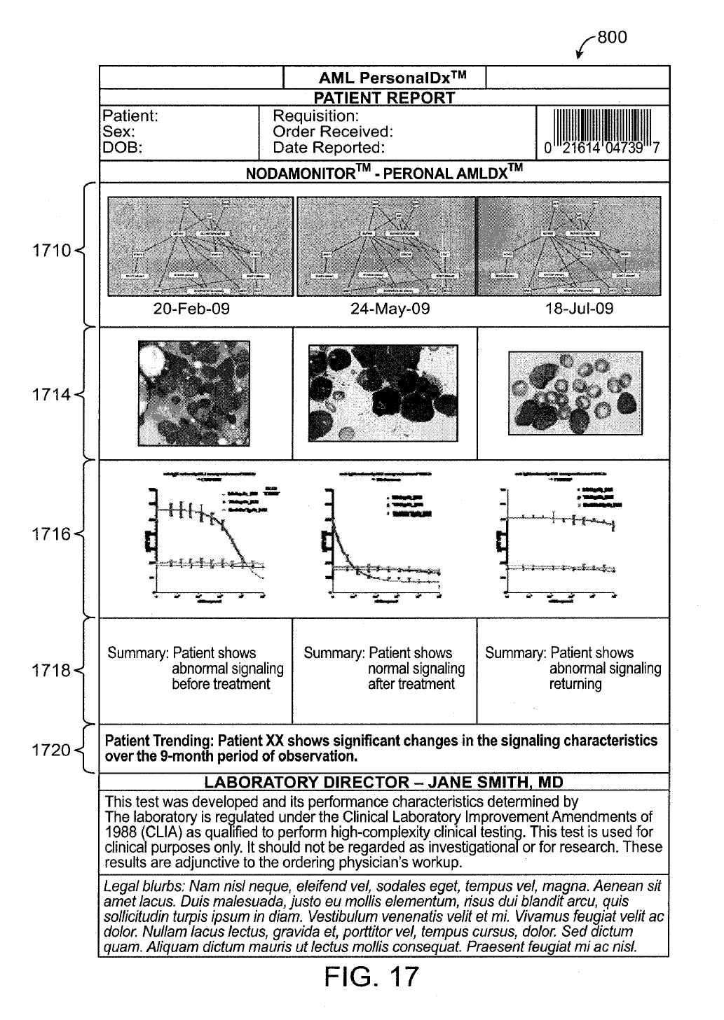

FIG. 17 illustrates an alternate view of the report 800. The report 800 illustrated in FIG. 17 comprises time series modulator response sections 1710, 1714, 1716, a time series patient summary section 1718 and a trending section 1720.

The time series modulator response sections 1710, 1714, 1716 comprise a series of graphical summaries of node state data derived from a patient or sample at different time points. The example illustrated in FIG. 17 comprises a series of pathway visualizations of node state data derived from a patient or sample at different time points 1710, a series of biometric data derived from a patient or sample at different time points 1714 and a series of plots of nodes state data over different modulator concentrations 1716.

The time series patient summary section 1718 includes summaries of one or more association metrics generated for node state data. According to the embodiment, these summaries may be textual summaries of the association or association metrics. In the embodiment illustrated in FIG. 17 the summaries are textual summaries describing the association between samples form a patient and biological states or normal/abnormal cell signaling after drug treatment.

The trending section 1720 summarizes the trends associated with node state data derived from a sample or patient over time, such as changes in individual nodes or changes in association metrics describing association to a biological state. In the embodiment, illustrated in FIG. 17 the trending section summarizes the statistical significance in the change of node state data describing signaling characteristics associated with a patient.

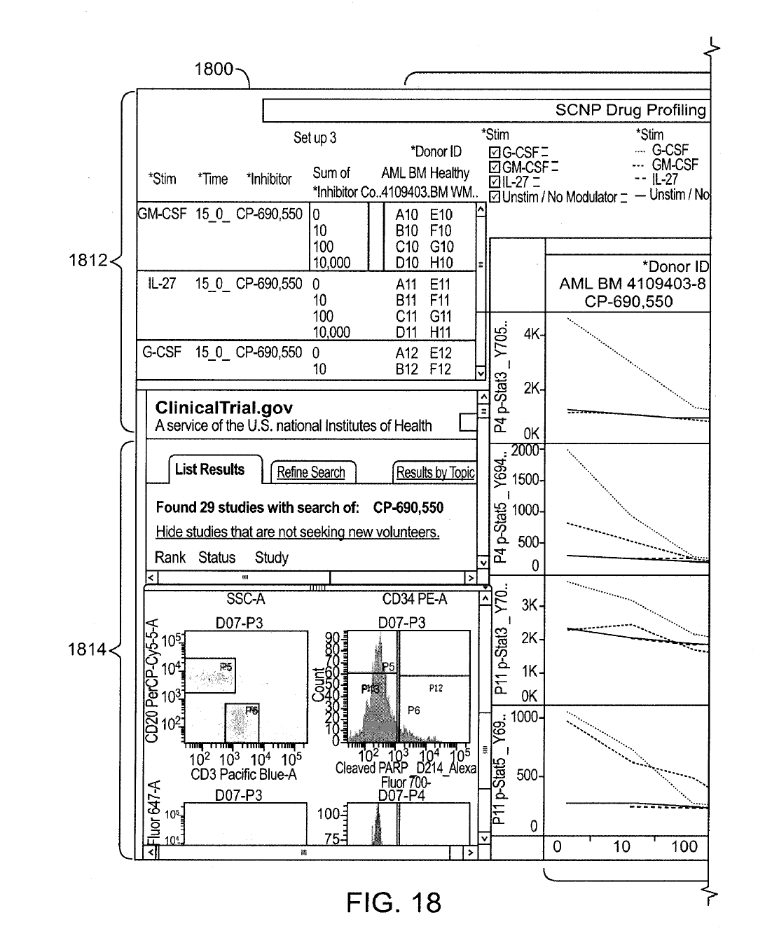

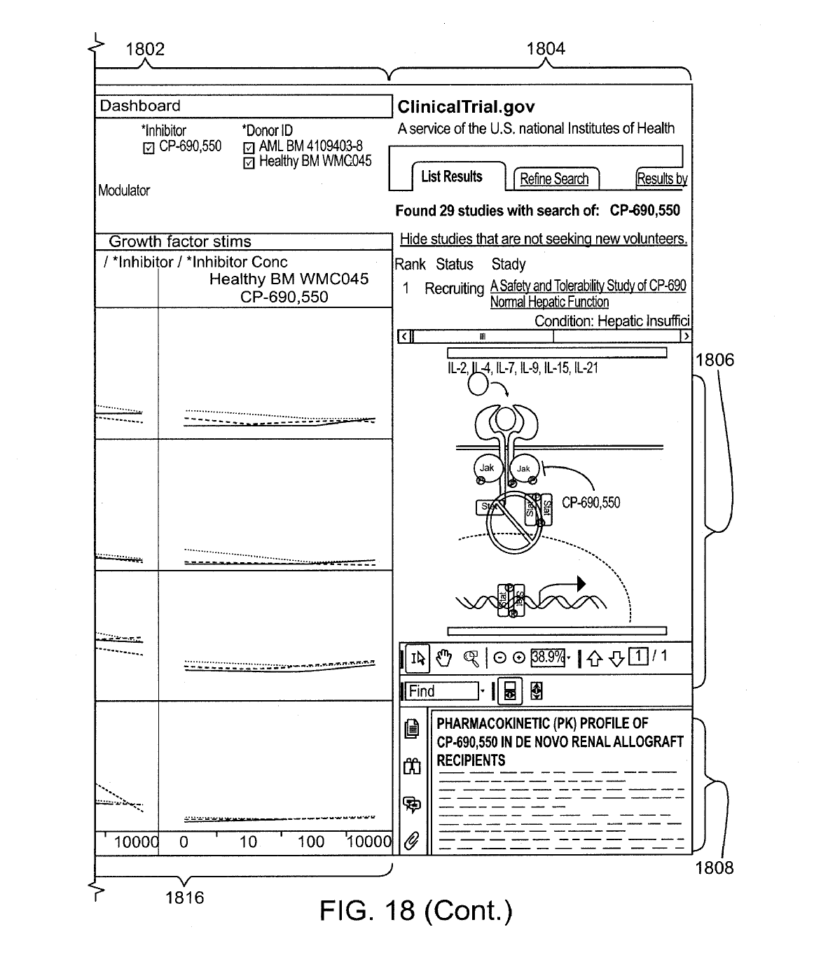

FIG. 18 illustrates a report 1800 according to another embodiment of the present invention. The report 1800 comprises a series of interactive sections 1812, 1814, 1802, 1804, 1806, 1808 used by the third party to navigate and interpret node state data.

The report 1800 comprises an experiment summary section 1812 used to provide a summary of the experimental design. Summaries of the experimental design can include: the modulator used, known biological states of the samples, concentration of the modulation, identity of the activatable element quantified, the amount of time the samples were stimulated, identity of the antibody used to quantify the activatable element. In some embodiments, the third party transmits data describing the experimental design generated by the kit modules 200 to the central laboratory server 110 and the report generation module 320 integrates the data describing the experimental design.

The report 1800 further comprises a profiling dashboard 1802 that allows the third party to interactively select and display different node state data in the other sections of the report 1800. In the embodiment illustrated in FIG. 18, the profiling dashboard allows the third party to select node state data to display based on the modulator used to generate the node state data and biological states associated with samples used to generate the node state data. In other embodiments, the third party may select node state data based on: the concentration of the modulator used to generate the node state data, the activatable element quantified in the node state data or the antibody/epitope used to generate in the node state data.

Based on the third parties selection in the profiling dashboard, graphical summaries 1816 of the selected node state data are generated. In the embodiment illustrated in FIG. 18, the graphical summaries 1816 comprise plots of node state data generating using different modulators at different concentrations. Separate plots are generated for node state data from samples with different biological states (for example, AML samples and Healthy samples).

The report 1800 further comprises sections 1804, 1806, 1808, 1814 comprising data retrieved by the report generation module 320 from public bioinformatics databases 175. The report 1800 comprises a section comprising plots of data from clinical trials 1814, a section comprising clinical trial studies 1804, a section comprising a pathway visualization 1806 and a section comprising academic or government publications 1808. In some embodiments, the third party may select the external information sources that are used to generate the report. Additionally, the third party may select to include data that is stored on the third party client 150 in the report.

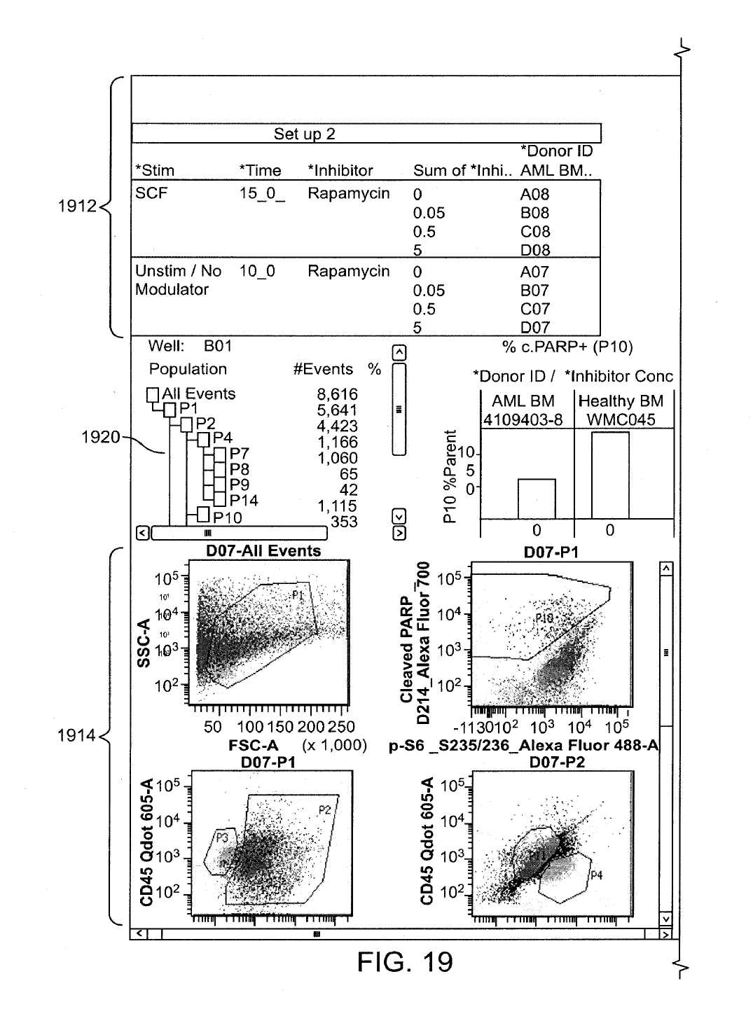

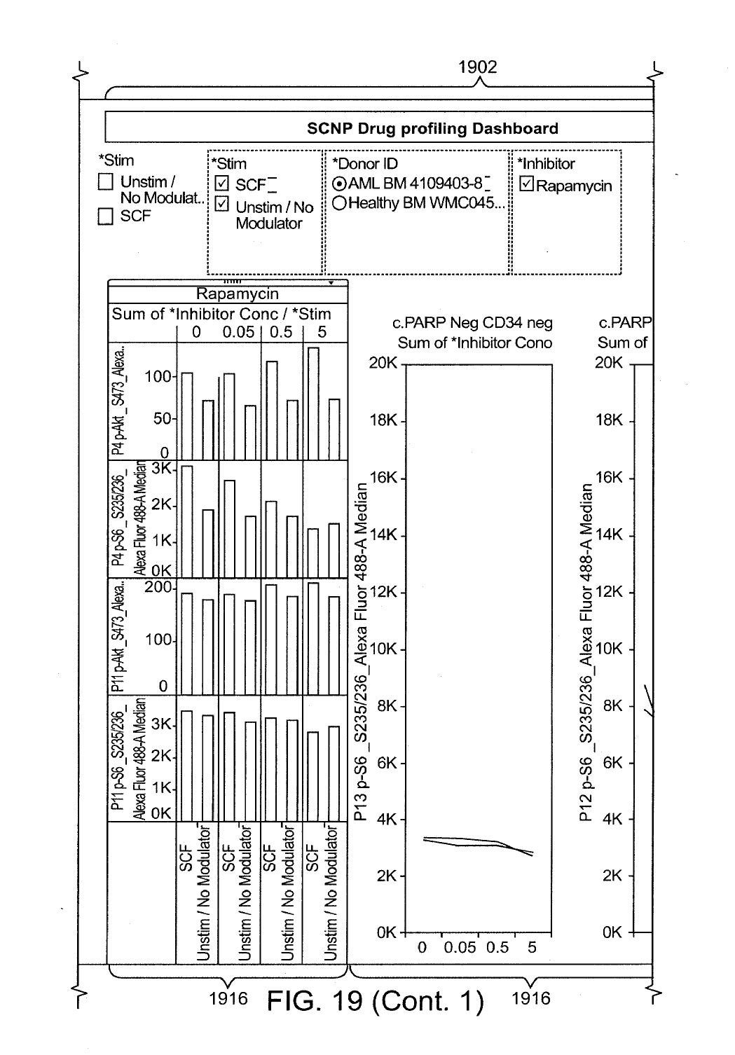

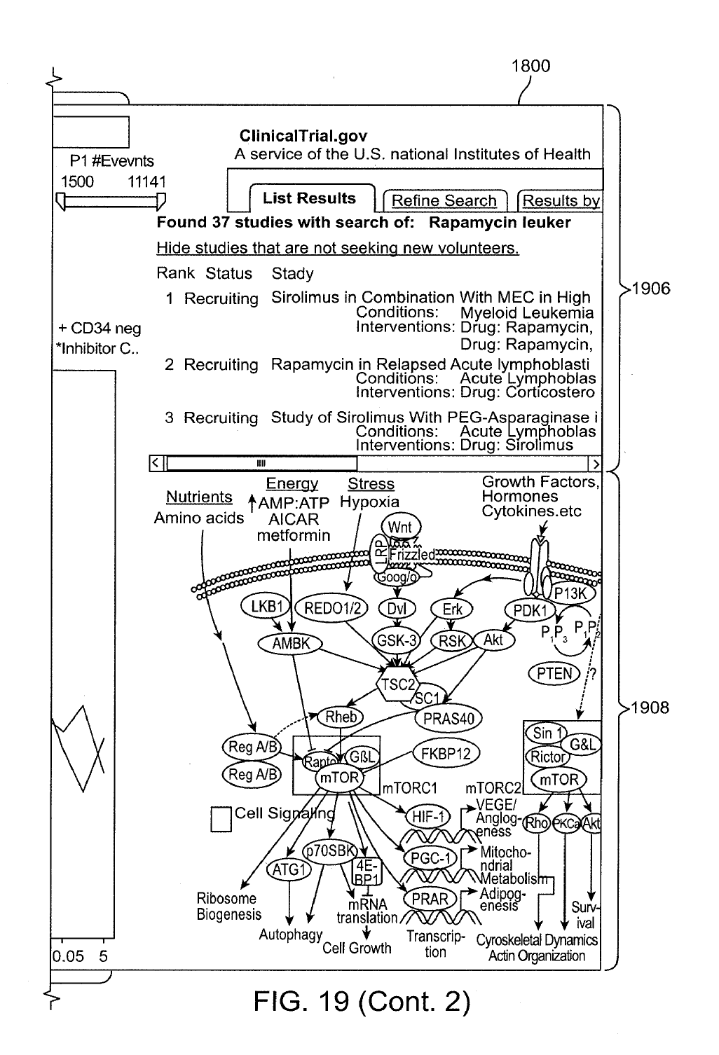

FIG. 19 illustrates an alternative view of the report 1800. The report 1800 comprises sections describing gating techniques used to segregate node state data into discrete populations of cells and sub-populations of cells. Methods and techniques for gating are described in U.S. Ser. No. 12/501,295 and in the section below title “Gating”. The report 1800 comprises a section 1914 used to visually display gated data. In the embodiment illustrated in FIG. 19, the section 1914 comprises one or more scatter plots that display different populations/sub-populations of gated data are displayed in different colors, wherein the populations/sub-populations are demarked by lines separating the cells. The report 1800 further comprises a section 1920 that displays a hierarchy of populations and sub-populations of cells, wherein each population/sub-population of cells is displayed in association with the number of cells in the population/sub-population.

The report 1800 comprises an experimental summary section 1912 and a profiling dashboard 1902. The profiling dashboard 1902 allows the third party to select node state data as discussed above. The profiling dashboard 1902 further allows the third party to specify threshold values used to select population/sub-population of cells to display node state data for. By adjusting the slider, the user can select maximum and minimum threshold values for populations/sub-populations of cells. If the number of cells in the population/sub-population exceeds the maximum value or is less than the minimum value, node state data associated with the cells is not displayed in the other sections of the report 1800.

The report 1800 comprises graphical summary sections 1916, 1918 that display graphic summaries of node state data corresponding to the selections made by the third party using the profiling dashboard 1902. The report 1800 comprises a section 1916 that displays bar plots of the selected node state data. In the embodiment illustrated, separate bar plots are generated for different populations of cells, where the bar plots represent different levels of activatable elements in samples treated with different modulator and untreated with modulators. Separate bar plots are generated for different concentrations of the modulator. The report further comprise a section 1918 that displays line plots of node state data associated with different concentrations of modulators.

The report 1800 further comprises sections 1906, 1908 comprising data retrieved by the report generation module 320 from public bioinformatics databases 175. The report 1800 comprises a section comprising clinical trial studies 1906 and a section comprising a pathway visualization 1908.

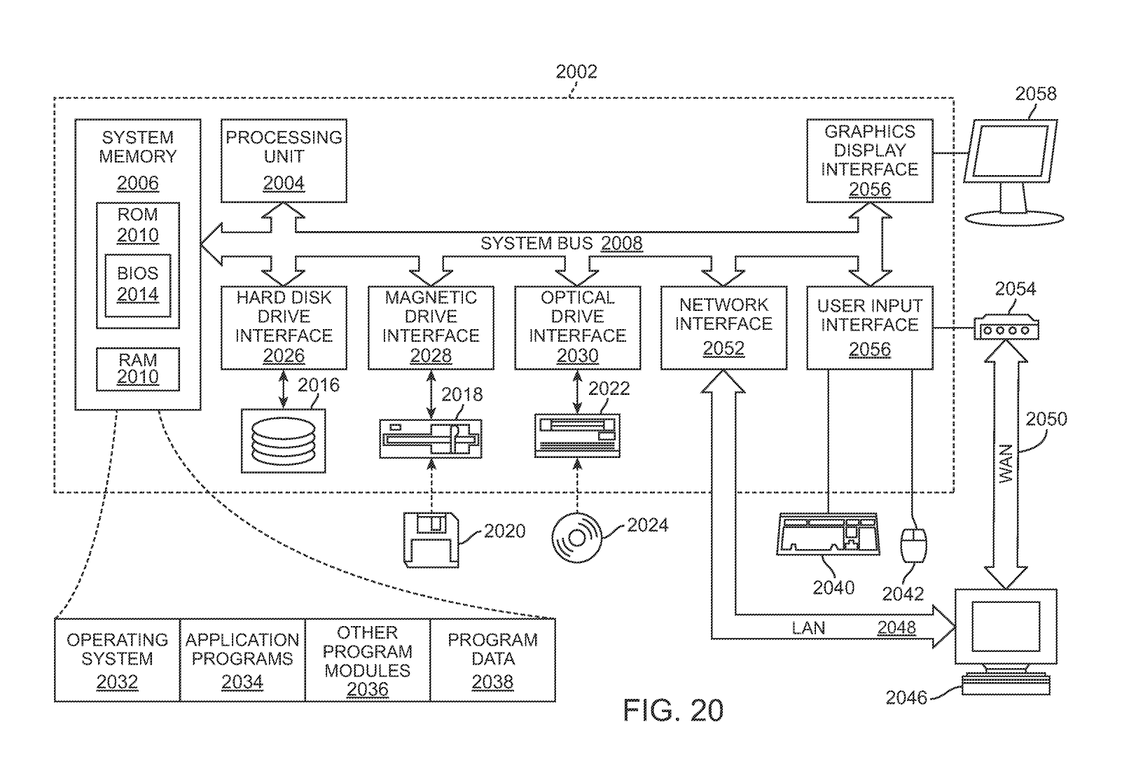

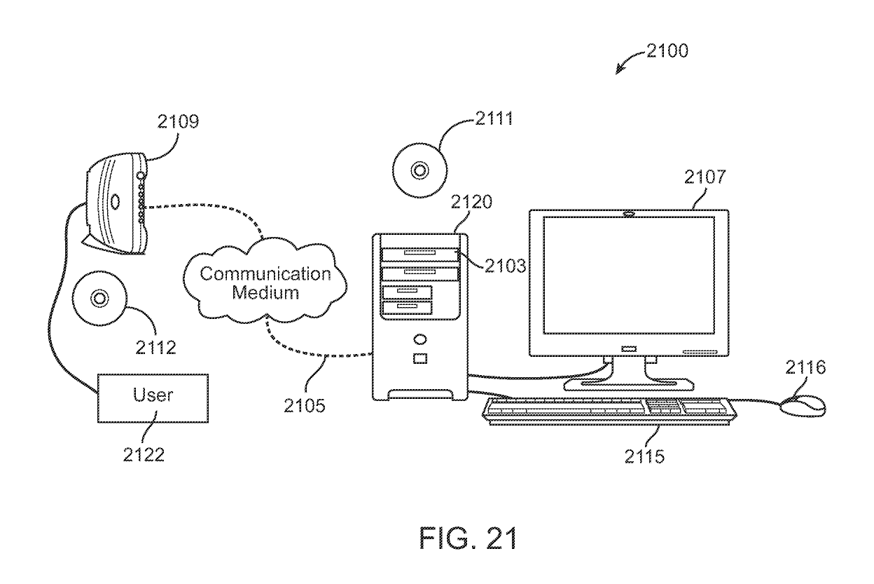

FIG. 20 illustrates an example of a suitable computing system environment or architecture in which computing subsystems may provide processing functionality to execute software embodiments of the present invention, including analyzing node data, generating an association metric, and remote networking. The computing system environment is only one example of a suitable computing environment and is not intended to suggest any limitation as to the scope of use or functionality of the invention.

The method or system disclosed herein is operational with numerous other general purpose or special purpose computing system environments or configurations including personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The method or system may be described in the general context of computer-executable instructions, such as program modules, being executed by a computer. Generally, program modules include routines, programs, objects, components, data structures, etc. that perform particular tasks or implement particular abstract data types. The method or system may also be practiced in distributed computing environments where tasks are performed by remote processing devices that are linked through a communications network.

With reference to FIG. 20, an exemplary system for implementing the method or system includes a general purpose computing device in the form of a computer 2002. Components of computer 2002 may include, but are not limited to, a processing unit 2004, a system memory 2006, and a system bus 2008 that couples various system components including the system memory to the processing unit 2004.

Computer 2002 typically includes a variety of computer readable media. Computer readable media includes both volatile and nonvolatile media, removable and non-removable media and a may comprise computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices.

The system memory 2006 includes computer storage media in the form of volatile and/or nonvolatile memory such as read only memory (ROM) 2010 and random access memory (RAM) 2012. A basic input/output system 2014 (BIOS), containing the basic routines that help to transfer information between elements within computer 2002, such as during start-up, is typically stored in ROM 2010. RAM 2012 typically contains data and/or program modules that are immediately accessible to and/or presently being operated on by processing unit 2004. FIG. 20 illustrates operating system 2032, application programs 2034 such as sequence analysis, probe selection, signal analysis and cross-hybridization analysis programs, other program modules 2036, and program data 2038.

The computer 2002 may also include other removable/non-removable, volatile/nonvolatile computer storage media. By way of example only, FIG. 20 illustrates a hard disk drive 2016 that reads from or writes to non-removable, nonvolatile magnetic media, a magnetic disk drive 2018 that reads from or writes to a removable, nonvolatile magnetic disk 2020, and an optical disk drive 2022 that reads from or writes to a removable, nonvolatile optical disk 2024 such as a CD ROM or other optical media. Other removable/non-removable, volatile/nonvolatile computer storage media that can be used in the exemplary operating environment include magnetic tape cassettes, flash memory cards, digital versatile disks, digital video tape, solid state RAM, solid state ROM, and the like. The hard disk drive 2016 is typically connected to the system bus 2008 through a non-removable memory interface such as interface 2026, and magnetic disk drive 2018 and optical disk drive 2022 are typically connected to the system bus 2008 by a removable memory interface, such as interface 2028 or 2030.

The drives and their associated computer storage media discussed above and illustrated in FIG. 20, provide storage of computer readable instructions, data structures, program modules and other data for the computer 2002. In FIG. 20, for example, hard disk drive 2016 is illustrated as storing operating system 2032, application programs 2034, other program modules 2036, and program data 2038. A user may enter commands and information into the computer 2002 through input devices such as a keyboard 2040 and a mouse, trackball or touch pad 2042. These and other input devices are often connected to the processing unit 2004 through a user input interface 2044 that is coupled to the system bus, but may be connected by other interface and bus structures, such as a parallel port or a universal serial bus (USB). A monitor 2058 or other type of display device is also connected to the system bus 2008 via an interface, such as a video interface or graphics display interface 2056. In addition to the monitor 2058, computers may also include other peripheral output devices such as speakers (not shown) and printer (not shown), which may be connected through an output peripheral interface (not shown).

The computer 2002 can be integrated into an analysis system, such as a analysis system reader or flow cytometry system or the data generated by an analysis system can be imported into the computer system using various means known in the art.

The computer 2002 may operate in a networked environment using logical connections to one or more remote computers or analysis systems. The remote computer may be a personal computer, a server, a router, a network PC, a peer device or other common network node, and typically includes many or all of the elements described above relative to the computer 2002. The logical connections depicted in FIG. 20 include a local area network (LAN) 2048 and a wide area network (WAN) 2050, but may also include other networks. Such networking environments are commonplace in offices, enterprise-wide computer networks, intranets and the Internet.

When used in a LAN networking environment, the computer 2002 is connected to the LAN 2048 through a network interface or adapter 2052. When used in a WAN networking environment, the computer 2002 typically includes a modem 2054 or other means for establishing communications over the WAN 2050, such as the Internet. The modem 2054, which may be internal or external, may be connected to the system bus 2008 via the user input interface 2044, or other appropriate mechanism. In a networked environment, program modules depicted relative to the computer 2002, or portions thereof, may be stored in the remote memory storage device.

In some embodiments, methods include use of one or more computers in a computer system. In some embodiments, the computer system is integrated into and is part of an analysis system, like a flow cytometer. In other embodiments, the computer system is connected to or ported to an analysis system. In some embodiments, the computer system is connected to an analysis system by a network connection. The computer may include a monitor 2107 or other graphical interface for displaying data, results, billing information, marketing information (e.g. demographics), customer information, or sample information. The computer may also include means for data or information input, such as a keyboard 2115 or mouse 2116. The computer may include a processing unit 2101 and fixed 2103 or removable 2111 media or a combination thereof. The computer may be accessed by a user in physical proximity to the computer, for example via a keyboard and/or mouse, or by a user 2122 that does not necessarily have access to the physical computer through a communication medium 2105 such as a modem, an internet connection, a telephone connection, or a wired or wireless communication signal carrier wave. In some cases, the computer may be connected to a server 2109 or other communication device for relaying information from a user to the computer or from the computer to a user. In some cases, the user may store data or information obtained from the computer through a communication medium 2105 on media, such as removable media 2112.

### Modulators

A modulator can be an activator, an inhibitor or a compound capable of impacting cellular signaling networks. Modulators can take the form of a wide variety of environmental cues and inputs. In some embodiments, the modulator is selected from the group comprising: growth factors, cytokines, adhesion molecules, drugs, hormones, small molecules, polynucleotides, antibodies, natural compounds, lactones, chemotherapeutic agents, immune modulators, carbohydrates, proteases, ions, reactive oxygen species, radiation, physical parameters such as heat, cold, UV radiation, peptides, and protein fragments, either alone or in the context of cells, cells themselves, viruses, and biological and non-biological complexes (e.g. beads, plates, viral envelopes, antigen presentation molecules such as major histocompatibility complex). One exemplary set of modulators, includes but is not limited to SDF-1α, IFN-α, IFN-γ, IL-10, IL-6, IL-27, G-CSF, FLT-3L, IGF-1, M-CSF, SCF, PMA, Thapsigargin, H₂O₂, etoposide, AraC, daunorubicin, staurosporine, benzyloxycarbonyl-Val-Ala-Asp (OMe) fluoromethylketone (ZVAD), lenalidomide, EPO, azacitadine, decitabine, IL-3, IL-4, GM-CSF, EPO, LPS, TNF-α, and CD40L. In some embodiments, the modulator is an activator. In some embodiments the modulator is an inhibitor. In some embodiments, the modulators include growth factors, cytokines, chemokines, phosphatase inhibitors, and pharmacological reagents. The response panel is composed of at least one of: SDF-1α, IFN-α, IFN-γ, IL-10, IL-6, IL-27, G-CSF, FLT-3L, IGF-1, M-CSF, SCF, PMA, Thapsigargin, H₂O₂, etoposide, AraC, daunorubicin, staurosporine, benzyloxycarbonyl-Val-Ala-Asp (OMe) fluoromethylketone (ZVAD), lenalidomide, EPO, azacitadine, decitabine, IL-3, IL-4, GM-CSF, EPO, LPS, TNF-α, and CD40L.

In some embodiments, the methods and composition utilize a modulator. A modulator can be an activator, an inhibitor or a compound capable of impacting a cellular pathway. Modulators can take the form of environmental cues and inputs.

Modulation can be performed in a variety of environments. In some embodiments, cells are exposed to a modulator immediately after collection. In some embodiments where there is a mixed population of cells, purification of cells is performed after modulation. In some embodiments, whole blood is collected to which a modulator is added. In some embodiments, cells are modulated after processing for single cells or purified fractions of single cells. As an illustrative example, whole blood can be collected and processed for an enriched fraction of lymphocytes that is then exposed to a modulator. Modulation can include exposing cells to more than one modulator. For instance, in some embodiments, cells are exposed to at least 2, 3, 4, 5, 6, 7, 8, 9, or 10 modulators. See U.S. Patent Application 61/048,657 which is incorporated by reference.

In some embodiments, cells are cultured post collection in a suitable media before exposure to a modulator. In some embodiments, the media is a growth media. In some embodiments, the growth media is a complex media that may include serum. In some embodiments, the growth media comprises serum. In some embodiments, the serum is selected from the group consisting of fetal bovine serum, bovine serum, human serum, porcine serum, horse serum, and goat serum. In some embodiments, the serum level ranges from 0.0001% to 30%. In some embodiments, the growth media is a chemically defined minimal media and is without serum. In some embodiments, cells are cultured in a differentiating media.

Modulators include chemical and biological entities, and physical or environmental stimuli. Modulators can act extracellularly or intracellularly. Chemical and biological modulators include growth factors, cytokines, neurotransmitters, adhesion molecules, hormones, small molecules, inorganic compounds, polynucleotides, antibodies, natural compounds, lectins, lactones, chemotherapeutic agents, biological response modifiers, carbohydrate, proteases and free radicals. Modulators include complex and undefined biologic compositions that may comprise cellular or botanical extracts, cellular or glandular secretions, physiologic fluids such as serum, amniotic fluid, or venom. Physical and environmental stimuli include electromagnetic, ultraviolet, infrared or particulate radiation, redox potential and pH, the presence or absences of nutrients, changes in temperature, changes in oxygen partial pressure, changes in ion concentrations and the application of oxidative stress. Modulators can be endogenous or exogenous and may produce different effects depending on the concentration and duration of exposure to the single cells or whether they are used in combination or sequentially with other modulators. Modulators can act directly on the activatable elements or indirectly through the interaction with one or more intermediary biomolecule. Indirect modulation includes alterations of gene expression wherein the expressed gene product is the activatable element or is a modulator of the activatable element.

In some embodiments the modulator is selected from the group consisting of growth factors, cytokines, adhesion molecules, drugs, hormones, small molecules, polynucleotides, antibodies, natural compounds, lactones, chemotherapeutic agents, immune modulators, carbohydrates, proteases, ions, reactive oxygen species, peptides, and protein fragments, either alone or in the context of cells, cells themselves, viruses, and biological and non-biological complexes (e.g. beads, plates, viral envelopes, antigen presentation molecules such as major histocompatibility complex). In some embodiments, the modulator is a physical stimuli such as heat, cold, UV radiation, and radiation. Examples of modulators, include but are not limited to SDF-1α, IFN-α, IFN-γ, IL-10, IL-6, IL-27, G-CSF, FLT-3L, IGF-1, M-CSF, SCF, PMA, Thapsigargin, H₂O₂, etoposide, AraC, daunorubicin, staurosporine, benzyloxycarbonyl-Val-Ala-Asp (OMe) fluoromethylketone (ZVAD), lenalidomide, EPO, azacitadine, decitabine, IL-3, IL-4, GM-CSF, EPO, LPS, TNF-α, and CD40L.

In some embodiments, the modulator is an activator. In some embodiments the modulator is an inhibitor. In some embodiments, cells are exposed to one or more modulator. In some embodiments, cells are exposed to at least 2, 3, 4, 5, 6, 7, 8, 9, or 10 modulators. In some embodiments, cells are exposed to at least two modulators, wherein one modulator is an activator and one modulator is an inhibitor. In some embodiments, cells are exposed to at least 2, 3, 4, 5, 6, 7, 8, 9, or 10 modulators, where at least one of the modulators is an inhibitor.

In some embodiments, the cross-linker is a molecular binding entity. In some embodiments, the molecular is a monovalent, bivalent, or multivalent is made more multivalent by attachment to a solid surface or tethered on a nanoparticle surface to increase the local valency of the epitope binding domain.

In some embodiments, the inhibitor is an inhibitor of a cellular factor or a plurality of factors that participates in a cellular pathway (e.g. signaling cascade) in the cell. In some embodiments, the inhibitor is a phosphatase inhibitor. Examples of phosphatase inhibitors include, but are not limited to H₂O₂, siRNA, miRNA, Cantharidin, (−)-p-Bromotetramisole, Microcystin LR, Sodium Orthovanadate, Sodium Pervanadate, Vanadyl sulfate, Sodium oxodiperoxo(1,10-phenanthroline)vanadate, bis(maltolato)oxovanadium(IV), Sodium Molybdate, Sodium Perm olybdate, Sodium Tartrate, Imidazole, Sodium Fluoride, β-Glycerophosphate, Sodium Pyrophosphate Decahydrate, Calyculin A, Discodermia calyx, bpV(phen), mpV(pic), DMHV, Cypermethrin, Dephostatin, Okadaic Acid, NIPP-1, N-(9,10-Dioxo-9,10-dihydro-phenanthren-2-yl)-2,2-dimethyl-propionamide, α-Bromo-4-hydroxyacetophenone, 4-Hydroxyphenacyl Br, α-Bromo-4-methoxyacetophenone, 4-Methoxyphenacyl Br, α-Bromo-4-(carboxymethoxy)acetophenone, 4-(Carboxymethoxy)phenacyl Br, and bis(4-Trifluoromethylsulfonamidophenyl)-1,4-diisopropylbenzene, phenylarsine oxide, Pyrrolidine Dithiocarbamate, and Aluminium fluoride. In some embodiments, the phosphatase inhibitor is H₂O₂.

In some embodiments, the inhibitor is an inhibitor of a cellular factor or a plurality of factors that participates in a signaling cascade in the cell. In some embodiments, the inhibitor is a phosphatase inhibitor. Examples of phosphatase inhibitors include, but are not limited to H₂O₂, siRNA, miRNA, Cantharidin, (−)-p-Bromotetramisole, Microcystin LR, Sodium Orthovanadate, Sodium Pervanadate, Vanadyl sulfate, Sodium oxodiperoxo(1,10-phenanthroline)vanadate, bis(maltolato)oxovanadium(IV), Sodium Molybdate, Sodium Perm olybdate, Sodium Tartrate, Imidazole, Sodium Fluoride, β-Glycerophosphate, Sodium Pyrophosphate Decahydrate, Calyculin A, Discodermia calyx, bpV(phen), mpV(pic), DMHV, Cypermethrin, Dephostatin, Okadaic Acid, NIPP-1, N-(9,10-Dioxo-9,10-dihydro-phenanthren-2-yl)-2,2-dimethyl-propionamide, α-Bromo-4-hydroxyacetophenone, 4-Hydroxyphenacyl Br, α-Bromo-4-methoxyacetophenone, 4-Methoxyphenacyl Br, α-Bromo-4-(carboxymethoxy)acetophenone, 4-(Carboxymethoxy)phenacyl Br, and bis(4-Trifluoromethylsulfonamidophenyl)-1,4-diisopropylbenzene, phenylarsine oxide, Pyrrolidine Dithiocarbamate, and Aluminium fluoride. In some embodiments, the phosphatase inhibitor is H₂O₂.

### Activatable Elements

In some embodiments, the invention is directed to methods for determining the activation level (i.e. the quantity) one or more activatable elements in a cell upon treatment with one or more modulators. The activation of an activatable element in the cell upon treatment with one or more modulators can reveal operative pathways in a condition that can then be used, e.g., as an indicator to predict the course of the condition, to identify risk group, to predict an increased risk of developing secondary complications or suffering harmful side effects, to choose a therapy for an individual, to predict response to a therapy for an individual, to determine the efficacy of a therapy in an individual, and to determine the prognosis for an individual.

In some embodiments, the activation level of an activatable element in a cell is determined by contacting the cell with at least 2, 3, 4, 5, 6, 7, 8, 9, or 10 modulators. In some embodiments, the activation level of an activatable element in a cell is determined by contacting the cell with at least 2, 3, 4, 5, 6, 7, 8, 9, or 10 modulators where at least one of the modulators is an inhibitor. In some embodiments, the activation level of an activatable element in a cell is determined by contacting the cell with an inhibitor and a modulator, where the modulator can be an inhibitor or an activator. In some embodiments, the activation level of an activatable element in a cell is determined by contacting the cell with an inhibitor and an activator. In some embodiments, the activation level of an activatable element in a cell is determined by contacting the cell with two or more modulators.

In some embodiments, a phenotypic profile of a population of cells is determined by measuring the activation level of an activatable element when the population of cells is exposed to a plurality of modulators in separate cultures. In some embodiments, the modulators include H₂O₂, PMA, SDF1α, CD40L, IGF-1, IL-7, IL-6, IL-10, IL-27, IL-4, IL-2, IL-3, thapsigardin and/or a combination thereof. For instance a population of cells can be exposed to one or more, all or a combination of the following combination of modulators: H₂O₂; PMA; SDF1α; CD40L; IGF-1; IL-7; IL-6; IL-10; IL-27; IL-4; IL-2; IL-3; thapsigardin. In some embodiments, the phenotypic profile of the population of cells is used to classify the population as described herein.

The methods and compositions of the invention may be employed to examine and profile the status of any activatable element in a cellular pathway, or collections of such activatable elements. Single or multiple distinct pathways may be profiled (sequentially or simultaneously), or subsets of activatable elements within a single pathway or across multiple pathways may be examined (again, sequentially or simultaneously).

As will be appreciated by those in the art, a wide variety of activation events can find use in the present invention. In general, the basic requirement is that the activation results in a change in the activatable element that is quantitatable by some indication (termed an “activation state indicator”), preferably by altered binding of a labeled binding element or by changes in detectable biological activities (e.g., the activated state has an enzymatic activity which can be measured and compared to a lack of activity in the non-activated state, or the cell cycle arrests at a certain point, resulting in a specific level of DNA accumulation).

The activation level of an individual activatable element represents a relative quantity of the activation element. The activation levels can be represented into numeric values or partitioned into categorical groups associated with activation states such as high activation/low activation/no activation or an “on or off” state. As an illustrative example, and without intending to be limited to any mechanism or process, an individual phosphorylatable site on a protein can activate or deactivate the protein. Additionally, phosphorylation of an adapter protein may promote its interaction with other components/proteins of distinct cellular signaling pathways. The terms “on” and “off,” when applied to an activatable element that is a part of a cellular constituent, are used here to describe the state of the activatable element, and not the overall state of the cellular constituent of which it is a part. Typically, a cell possesses a plurality of a particular protein or other constituent with a particular activatable element and this plurality of proteins or constituents usually has some proteins or constituents whose individual activatable element is in the on state and other proteins or constituents whose individual activatable element is in the off state. Since the activation state of each activatable element is measured through the use of a binding element that recognizes a specific activation state, only those activatable elements in the specific activation state recognized by the binding element, representing some fraction of the total number of activatable elements, will be bound by the binding element to generate a measurable signal. The measurable signal corresponding to the summation of individual activatable elements of a particular type that are activated in a single cell is the “activation level” for that activatable element in that cell.

Activation levels (i.e. quantity determined based on antibody signal) for a particular activatable element may vary among individual cells so that when a plurality of cells is analyzed, the activation levels follow a distribution. The distribution may be a normal distribution, also known as a Gaussian distribution, or it may be of another type. Different populations of cells may have different distributions of activation levels that can then serve to distinguish between the populations.

In some embodiments, the basis for classifying cells is that the distribution of activation levels for one or more specific activatable elements will differ among different phenotypes. A certain activation level, or more typically a range of activation levels for one or more activatable elements seen in a cell or a population of cells, is indicative that that cell or population of cells belongs to a distinctive phenotype. Other measurements, such as cellular levels (e.g., expression levels) of biomolecules that may not contain activatable elements, may also be used to classify cells in addition to activation levels of activatable elements; it will be appreciated that these levels also will follow a distribution, similar to activatable elements. Thus, the activation level or levels of one or more activatable elements, optionally in conjunction with levels of one or more levels of biomolecules that may or may not contain activatable elements, of cell or a population of cells may be used to classify a cell or a population of cells into a class. Once the activation level of intracellular activatable elements of individual single cells is known they can be placed into one or more classes, e.g., a class that corresponds to a phenotype. A class encompasses a class of cells wherein every cell has the same or substantially the same known activation level, or range of activation levels, of one or more intracellular activatable elements. For example, if the activation levels of five intracellular activatable elements are analyzed, predefined classes of cells that encompass one or more of the intracellular activatable elements can be constructed based on the activation level, or ranges of the activation levels, of each of these five elements. It is understood that activation levels can exist as a distribution and that an activation level of a particular element used to classify a cell may be a particular point on the distribution but more typically may be a portion of the distribution.

In addition to activation levels of intracellular activatable elements, levels of intracellular or extracellular biomolecules, e.g., proteins, may be used alone or in combination with activation states of activatable elements to classify cells. Further, additional cellular elements, e.g., biomolecules or molecular complexes such as RNA, DNA, carbohydrates, metabolites, and the like, may be used in conjunction with activatable states or expression levels in the classification of cells encompassed here.

In some embodiments, other characteristics that affect the status of a cellular constituent may also be used to classify a cell. Examples include the translocation of biomolecules or changes in their turnover rates and the formation and disassociation of complexes of biomolecule. Such complexes can include multi-protein complexes, multi-lipid complexes, homo- or hetero-dimers or oligomers, and combinations thereof. Other characteristics include proteolytic cleavage, e.g. from exposure of a cell to an extracellular protease or from the intracellular proteolytic cleavage of a biomolecule.

Additional elements may also be used to classify a cell, such as the expression level of extracellular or intracellular markers, nuclear antigens, enzymatic activity, protein expression and localization, cell cycle analysis, chromosomal analysis, cell volume, and morphological characteristics like granularity and size of nucleus or other distinguishing characteristics. For example, B cells can be further subdivided based on the expression of cell surface markers such as CD19, CD20, CD22 or CD23.

Alternatively, predefined classes of cells can be aggregated or grouped based upon shared characteristics that may include inclusion in one or more additional predefined class or the presence of extracellular or intracellular markers, similar gene expression profile, nuclear antigens, enzymatic activity, protein expression and localization, cell cycle analysis, chromosomal analysis, cell volume, and morphological characteristics like granularity and size of nucleus or other distinguishing cellular characteristics.

In some embodiments, the physiological status of one or more cells is determined by examining and profiling the activation level of one or more activatable elements in a cellular pathway. In some embodiments, a cell is classified according to the activation level of a plurality of activatable elements. In some embodiments, a hematopoietic cell is classified according to the activation levels of a plurality of activatable elements. In some embodiments, 1, 2, 3, 4, 5, 6, 7, 8, 9, 10 or more activatable elements may be analysed in a cell signaling pathway. In some embodiments, the activation levels of one or more activatable elements of a hematopoietic cell are correlated with a condition.

In some embodiments, the activation level of one or more activatable elements in single cells in the sample is determined. Cellular constituents that may include activatable elements include without limitation proteins, carbohydrates, lipids, nucleic acids and metabolites. The activatable element may be a portion of the cellular constituent, for example, an amino acid residue in a protein that may undergo phosphorylation, or it may be the cellular constituent itself, for example, a protein that is activated by translocation, change in conformation (due to, e.g., change in pH or ion concentration), by proteolytic cleavage, degradation through ubiquitination and the like. Upon activation, a change occurs to the activatable element, such as covalent modification of the activatable element (e.g., binding of a molecule or group to the activatable element, such as phosphorylation) or a conformational change. Such changes generally contribute to changes in particular biological, biochemical, or physical properties of the cellular constituent that contains the activatable element. The state of the cellular constituent that contains the activatable element is determined to some degree, though not necessarily completely, by the state of a particular activatable element of the cellular constituent. For example, a protein may have multiple activatable elements, and the particular activation states of these elements may overall determine the activation state of the protein; the state of a single activatable element is not necessarily determinative. Additional factors, such as the binding of other proteins, pH, ion concentration, interaction with other cellular constituents, and the like, can also affect the state of the cellular constituent.

In some embodiments, the activation levels of a plurality of intracellular activatable elements in single cells are determined. In some embodiments, at least about 2, 3, 4, 5, 6, 7, 8, 9, 10 or more than 10 intracellular activatable elements are determined.

Activation states of activatable elements may result from chemical additions or modifications of biomolecules and include biochemical processes such as glycosylation, phosphorylation, acetylation, methylation, biotinylation, glutamylation, glycylation, hydroxylation, isomerization, prenylation, myristoylation, lipoylation, phosphopantetheinylation, sulfation, ISGylation, nitrosylation, palmitoylation, SUMOylation, ubiquitination, neddylation, citrullination, amidation, and disulfide bond formation, disulfide bond reduction. Other possible chemical additions or modifications of biomolecules include the formation of protein carbonyls, direct modifications of protein side chains, such as o-tyrosine, chloro-, nitrotyrosine, and dityrosine, and protein adducts derived from reactions with carbohydrate and lipid derivatives. Other modifications may be non-covalent, such as binding of a ligand or binding of an allosteric modulator.

One example of a covalent modification is the substitution of a phosphate group for a hydroxyl group in the side chain of an amino acid (phosphorylation). A wide variety of proteins are known that recognize specific protein substrates and catalyze the phosphorylation of serine, threonine, or tyrosine residues on their protein substrates. Such proteins are generally termed “kinases.” Substrate proteins that are capable of being phosphorylated are often referred to as phosphoproteins (after phosphorylation). Once phosphorylated, a substrate phosphoprotein may have its phosphorylated residue converted back to a hydroxyl one by the action of a protein phosphatase that specifically recognizes the substrate protein. Protein phosphatases catalyze the replacement of phosphate groups by hydroxyl groups on serine, threonine, or tyrosine residues. Through the action of kinases and phosphatases a protein may be reversibly phosphorylated on a multiplicity of residues and its activity may be regulated thereby. Thus, the presence or absence of one or more phosphate groups in an activatable protein is a preferred readout in the present invention.

Another example of a covalent modification of an activatable protein is the acetylation of histones. Through the activity of various acetylases and deacetylylases the DNA binding function of histone proteins is tightly regulated. Furthermore, histone acetylation and histone deactelyation have been linked with malignant progression. See Nature, 429: 457-63, 2004.

Another form of activation involves cleavage of the activatable element. For example, one form of protein regulation involves proteolytic cleavage of a peptide bond. While random or misdirected proteolytic cleavage may be detrimental to the activity of a protein, many proteins are activated by the action of proteases that recognize and cleave specific peptide bonds. Many proteins derive from precursor proteins, or pro-proteins, which give rise to a mature isoform of the protein following proteolytic cleavage of specific peptide bonds. Many growth factors are synthesized and processed in this manner, with a mature isoform of the protein typically possessing a biological activity not exhibited by the precursor form. Many enzymes are also synthesized and processed in this manner, with a mature isoform of the protein typically being enzymatically active, and the precursor form of the protein being enzymatically inactive. This type of regulation is generally not reversible. Accordingly, to inhibit the activity of a proteolytically activated protein, mechanisms other than “reattachment” must be used. For example, many proteolytically activated proteins are relatively short-lived proteins, and their turnover effectively results in deactivation of the signal. Inhibitors may also be used. Among the enzymes that are proteolytically activated are serine and cysteine proteases, including cathepsins and caspases respectively.

In one embodiment, the activatable enzyme is a caspase. The caspases are an important class of proteases that mediate programmed cell death (referred to in the art as “apoptosis”). Caspases are constitutively present in most cells, residing in the cytosol as a single chain proenzyme. These are activated to fully functional proteases by a first proteolytic cleavage to divide the chain into large and small caspase subunits and a second cleavage to remove the N-terminal domain. The subunits assemble into a tetramer with two active sites (Green, Cell 94:695-698, 1998). Many other proteolytically activated enzymes, known in the art as “zymogens,” also find use in the instant invention as activatable elements.

In an alternative embodiment the activation of the activatable element involves prenylation of the element. By “prenylation”, and grammatical equivalents used herein, is meant the addition of any lipid group to the element. Common examples of prenylation include the addition of farnesyl groups, geranylgeranyl groups, myristoylation and palmitoylation. In general these groups are attached via thioether linkages to the activatable element, although other attachments may be used.

In alternative embodiment, activation of the activatable element is detected as intermolecular clustering of the activatable element. By “clustering” or “multimerization”, and grammatical equivalents used herein, is meant any reversible or irreversible association of one or more signal transduction elements. Clusters can be made up of 2, 3, 4, etc., elements. Clusters of two elements are termed dimers. Clusters of 3 or more elements are generally termed oligomers, with individual numbers of clusters having their own designation; for example, a cluster of 3 elements is a trimer, a cluster of 4 elements is a tetramer, etc.

Clusters can be made up of identical elements or different elements. Clusters of identical elements are termed “homo” dimers, while clusters of different elements are termed “hetero” clusters. Accordingly, a cluster can be a homodimer, as is the case for the β₂-adrenergic receptor.

Alternatively, a cluster can be a heterodimer, as is the case for GABA_{B-R}. In other embodiments, the cluster is a homotrimer, as in the case of TNFα, or a heterotrimer such the one formed by membrane-bound and soluble CD95 to modulate apoptosis. In further embodiments the cluster is a homo-oligomer, as in the case of Thyrotropin releasing hormone receptor, or a hetero-oligomer, as in the case of TGFβ1.

In a preferred embodiment, the activation or signaling potential of elements is mediated by clustering, irrespective of the actual mechanism by which the element's clustering is induced. For example, elements can be activated to cluster a) as membrane bound receptors by binding to ligands (ligands including both naturally occurring or synthetic ligands), b) as membrane bound receptors by binding to other surface molecules, or c) as intracellular (non-membrane bound) receptors binding to ligands.

In a preferred embodiment the activatable elements are membrane bound receptor elements that cluster upon ligand binding such as cell surface receptors. As used herein, “cell surface receptor” refers to molecules that occur on the surface of cells, interact with the extracellular environment, and transmit or transduce (through signals) the information regarding the environment intracellularly in a manner that may modulate cellular activity directly or indirectly, e.g., via intracellular second messenger activities or transcription of specific promoters, resulting in transcription of specific genes. One class of receptor elements includes membrane bound proteins, or complexes of proteins, which are activated to cluster upon ligand binding. As is known in the art, these receptor elements can have a variety of forms, but in general they comprise at least three domains. First, these receptors have a ligand-binding domain, which can be oriented either extracellularly or intracellularly, usually the former. Second, these receptors have a membrane-binding domain (usually a transmembrane domain), which can take the form of a seven pass transmembrane domain (discussed below in connection with G-protein-coupled receptors) or a lipid modification, such as myristylation, to one of the receptor's amino acids which allows for membrane association when the lipid inserts itself into the lipid bilayer. Finally, the receptor has an signaling domain, which is responsible for propagating the downstream effects of the receptor.

Examples of such receptor elements include hormone receptors, steroid receptors, cytokine receptors, such as IL1-α, IL-β, IL-2, IL-3, IL-4, IL-5, IL-6, IL-7, IL-8, IL-9, IL-10. IL-12, IL-15, IL-18, IL-21, CCR5, CCR7, CCR-1-10, CCL20, chemokine receptors, such as CXCR4, adhesion receptors and growth factor receptors, including, but not limited to, PDGF-R (platelet derived growth factor receptor), EGF-R (epidermal growth factor receptor), VEGF-R (vascular endothelial growth factor), uPAR (urokinase plasminogen activator receptor), ACHR (acetylcholine receptor), IgE-R (immunoglobulin E receptor), estrogen receptor, thyroid hormone receptor, integrin receptors (β1, β2, β3, β4, β5, β6, α1, α2, α3, α4, α5, α6), MAC-1 (β2 and cd11b), αVβ33, opioid receptors (mu and kappa), FC receptors, serotonin receptors (5-HT, 5-HT6, 5-HT7), β-adrenergic receptors, insulin receptor, leptin receptor, TNF receptor (tissue-necrosis factor), statin receptors, FAS receptor, BAFF receptor, FLT3 LIGAND receptor, GMCSF receptor, and fibronectin receptor.

In a preferred embodiment the activatable element is a cytokine receptor. Cytokines are a family of soluble mediators of cell-to-cell communication that includes interleukins, interferons, and colony-stimulating factors. The characteristic features of cytokines lie in their pleiotropy and functional redundancy. Most of the cytokine receptors that constitute distinct superfamilies do not possess intrinsic protein tyrosine kinase domains, yet receptor stimulation usually invokes rapid tyrosine phosphorylation of intracellular proteins, including the receptors themselves. Many members of the cytokine receptor superfamily activate the Jak protein tyrosine kinase family, with resultant phosphorylation of the STAT family of transcription factors. IL-2, IL-4, IL-7 and Interferon γ have all been shown to activate Jak kinases (Frank et al. Proc. Natl. Acad. Sci. USA 92: 7779-7783, 1995); Scharfe et al. Blood 86:2077-2085, 1995); (Bacon et al. Proc. Natl. Acad. Sci. USA 92: 7307-7311, 1995); and (Sakatsume et al. J. Biol. Chem. 270: 17528-17534, 1995). Events downstream of Jak phosphorylation have also been elucidated. For example, exposure of T lymphocytes to IL-2 has been shown to lead to the phosphorylation of signal transducers and activators of transcription (STAT) proteins STAT1α, STAT1β, and STAT3, as well as of two STAT-related proteins, p94 and p95. The STAT proteins translocate to the nucleus and bind to a specific DNA sequence, thus suggesting a mechanism by which IL-2 may activate specific genes involved in immune cell function (Frank et al. supra). Jak3 is associated with the gamma chain of the IL-2, IL-4, and IL-7 cytokine receptors (Fujii et al. Proc. Natl. Acad. Sci. 92: 5482-5486, 1995) and (Musso et al. J. Exp. Med. 181: 1425-1431, 1995). The Jak kinases have been shown to be activated by numerous ligands that signal via cytokine receptors such as, growth hormone, erythropoietin and IL-6 (Kishimoto Stem cells Suppl. 12: 37-44, 1994). Preferred activatable elements are selected from the group p-STAT1, p-STAT3, p-STAT5, p-STAT6, p-PLCy2, p-S6, pAkt, p-Erk, p-CREB, p-38, and NF-KBp-65.

In a preferred embodiment the activatable element is a member of the nerve growth factor receptor superfamily, such as the tumor necrosis factor alpha receptor. Tumor necrosis factor α (TNF-α or TNF-alpha) is a pleiotropic cytokine that is primarily produced by activated macrophages and lymphocytes but is also expressed in endothelial cells and other cell types. TNF-alpha is a major mediator of inflammatory, immunological, and pathophysiological reactions. (Grell, M., et al., Cell, 83:793-802, 1995). Two distinct forms of TNF exist, a 26 kDa membrane expressed form and the soluble 17 kDa cytokine which is derived from proteolytic cleavage of the 26 kDa form. The soluble TNF polypeptide is 157 amino acids long and is the primary biologically active molecule.

TNF-alpha exerts its biological effects through interaction with high-affinity cell surface receptors. Two distinct membrane TNF-alpha receptors have been cloned and characterized. These are a 55 kDa species, designated p55 TNF-R and a 75 kDa species designated p75 TNF-R (Corcoran. A. E., et al., Eur. J. Biochem., 223: 831-840, 1994). The two TNF receptors exhibit 28% similarity at the amino acid level. This is confined to the extracellular domain and consists of four repeating cysteine-rich motifs, each of approximately 40 amino acids. Each motif contains four to six cysteines in conserved positions. Dayhoff analysis shows the greatest intersubunit similarity among the first three repeats in each receptor. This characteristic structure is shared with a number of other receptors and cell surface molecules, which comprise the TNF-R/nerve growth factor receptor superfamily (Corcoran. A. E., et al., Eur. J. Biochem., 223: 831-840, 1994).

TNF signaling is initiated by receptor clustering, either by the trivalent ligand TNF or by cross-linking monoclonal antibodies (Vandevoorde, V., et al., J. Cell Biol., 137: 1627-1638, 1997). Crystallographic studies of TNF and the structurally related cytokine, lymphotoxin (LT), have shown that both cytokines exist as homotrimers, with subunits packed edge to edge in threefold symmetry. Structurally, neither TNF nor LT reflect the repeating pattern of the their receptors. Each monomer is cone shaped and contains two hydrophilic loops on opposite sides of the base of the cone. Recent crystal structure determination of a p55 soluble TNF-R/LT complex has confirmed the hypothesis that loops from adjacent monomers join together to form a groove between monomers and that TNF-R binds in these grooves (Corcoran. A. E., et al., Eur. J. Biochem., 223: 831-840, 1994).

In one embodiment, the activatable element is a receptor tyrosine kinase. The receptor tyrosine kinases can be divided into subgroups on the basis of structural similarities in their extracellular domains and the organization of the tyrosine kinase catalytic region in their cytoplasmic domains. Sub-groups I (epidermal growth factor (EGF) receptor-like), II (insulin receptor-like) and the EPH/ECK family contain cysteine-rich sequences (Hirai et al., (1987) Science 238:1717-1720 and Lindberg and Hunter, (1990) Mol. Cell. Biol. 10:6316-6324). The functional domains of the kinase region of these three classes of receptor tyrosine kinases are encoded as a contiguous sequence (Hanks et al. (1988) Science 241:42-52). Subgroups III (platelet-derived growth factor (PDGF) receptor-like) and IV (the fibro-blast growth factor (FGF) receptors) are characterized as having immunoglobulin (Ig)-like folds in their extracellular domains, as well as having their kinase domains divided in two parts by a variable stretch of unrelated amino acids (Yanden and Ullrich (1988) supra and Hanks et al. (1988) supra).

The family with the largest number of known members is the Eph family (with the first member of the family originally isolated from an erythropoietin producing hepatocellular carcinoma cell line). Since the description of the prototype, the Eph receptor (Hirai et al. (1987) Science 238:1717-1720), sequences have been reported for at least ten members of this family, not counting apparently orthologous receptors found in more than one species. Additional partial sequences, and the rate at which new members are still being reported, suggest the family is even larger (Maisonpierre et al. (1993) Oncogene 8:3277-3288; Andres et al. (1994) Oncogene 9:1461-1467; Henkemeyer et al. (1994) Oncogene 9:1001-1014; Ruiz et al. (1994) Mech. Dev. 46:87-100; Xu et al. (1994) Development 120:287-299; Zhou et al. (1994) J. Neurosci. Res. 37:129-143; and references in Tuzi and Gullick (1994) Br. J. Cancer 69:417-421). Remarkably, despite the large number of members in the Eph family, all of these molecules were identified as orphan receptors without known ligands.

As used herein, the terms “Eph receptor” or “Eph-type receptor” refer to a class of receptor tyrosine kinases, comprising at least eleven paralogous genes, though many more orthologs exist within this class, e.g. homologs from different species. Eph receptors, in general, are a discrete group of receptors related by homology and easily recognizable, e.g., they are typically characterized by an extracellular domain containing a characteristic spacing of cysteine residues near the N-terminus and two fibronectin type III repeats (Hirai et al. (1987) Science 238:1717-1720; Lindberg et al. (1990) Mol. Cell Biol. 10:6316-6324; Chan et al. (1991) Oncogene 6:1057-1061; Maisonpierre et al. (1993) Oncogene 8:3277-3288; Andres et al. (1994) Oncogene 9:1461-1467; Henkemeyer et al. (1994) Oncogene 9:1001-1014; Ruiz et al. (1994) Mech. Dev. 46:87-100; Xu et al. (1994) Development 120:287-299; Zhou et al. (1994) J. Neurosci. Res. 37:129-143; and references in Tuzi and Gullick (1994) Br. J. Cancer 69:417-421). Exemplary Eph receptors include the eph, elk, eck, sek, mek4, hek, hek2, eek, erk, tyro1, tyro4, tyro5, tyro6, tyrol11, cek4, cek5, cek6, cek7, cek8, cek9, cek10, bsk, rtk1, rtk2, rtk3, myk1, myk2, ehk1, ehk2, pagliaccio, htk, erk and nuk receptors.

In another embodiment the receptor element is a member of the hematopoietin receptor superfamily. Hematopoietin receptor superfamily is used herein to define single-pass transmembrane receptors, with a three-domain architecture: an extracellular domain that binds the activating ligand, a short transmembrane segment, and a domain residing in the cytoplasm. The extracellular domains of these receptors have low but significant homology within their extracellular ligand-binding domain comprising about 200-210 amino acids. The homologous region is characterized by four cysteine residues located in the N-terminal half of the region, and a Trp-Ser-X-Trp-Ser (WSXWS) motif located just outside the membrane-spanning domain. Further structural and functional details of these receptors are provided by Cosman, D. et al., (1990). The receptors of IL-1, IL-2, IL-3, IL-4, IL-5, IL-6, IL-7, prolactin, placental lactogen, growth hormone GM-CSF, G-CSF, M-CSF and erythropoietin have, for example, been identified as members of this receptor family.

In a further embodiment, the receptor element is an integrin other than Leukocyte Function Antigen-1 (LFA-1). Members of the integrin family of receptors function as heterodimers, composed of various α and β subunits, and mediate interactions between a cell's cytoskeleton and the extracellular matrix. (Reviewed in, Giancotti and Ruoslahti, Science 285, 13 Aug. 1999). Different combinations of the α and β subunits give rise to a wide range of ligand specificities, which may be increased further by the presence of cell-type-specific factors. Integrin clustering is know to activate a number of intracellular signals, such as RAS, MAP kinase, and phosphotidylinosital-3-kinase. In a preferred embodiment the receptor element is a heterodimer (other than LFA-1) composed of a β integrin and an α integrin chosen from the following integrins; β1, β2, β3, β4, β5, β6, α1, α2, α3, α4, α5, and α6, or is MAC-1 (β2 and cd11b), or αVβ3.

In a preferred embodiment the element is an intracellular adhesion molecule (ICAM). ICAMs-1, -2, and -3 are cellular adhesion molecules belonging to the immunogloblin superfamily. Each of these receptors has a single membrane-spanning domain and all bind to β2 integrins via extracellular binding domains similar in structure to Ig-loops. (Signal Transduction, Gomperts, et al., eds, Academic or government Press Publishers, 2002, Chapter 14, pp 318-319).

In another embodiment the activatable elements cluster for signaling by contact with other surface molecules. In contrast to the receptors discussed above, these elements cluster for signaling by contact with other surface molecules, and generally use molecules presented on the surface of a second cell as ligands. Receptors of this class are important in cell-cell interactions, such mediating cell-to-cell adhesion and immunorecognition.

Examples of such receptor elements are CD3 (T cell receptor complex), BCR (B cell receptor complex), CD4, CD28, CD80, CD86, CD54, CD102, CD50 and ICAMs 1, 2 and 3.

In a preferred embodiment the receptor element is a T cell receptor complex (TCR). TCRs occur as either of two distinct heterodimers, αβ, or γξ both of which are expressed with the non-polymorphic CD3 polypeptides γ, Σ, ε, ξ. The CD3 polypeptides, especially ξ and its variants, are critical for intracellular signaling. The αβ TCR heterodimer expressing cells predominate in most lymphoid compartments and are responsible for the classical helper or cytotoxic T cell responses. Im most cases, the αβ TCR ligand is a peptide antigen bound to a class I or a class II MHC molecule (Fundamental Immunology, fourth edition, W. E. Paul, ed., Lippincott-Raven Publishers, 1999, Chapter 10, pp 341-367).

In another embodiment, the activatable element is a member of the large family of G-protein-coupled receptors. It has recently been reported that a G-protein-coupled receptors are capable of clustering. (Kroeger, et al., J Biol Chem 276:16, 12736-12743, Apr. 20, 2001; Bai, et al., J Biol Chem 273:36, 23605-23610, Sep. 4, 1998; Rocheville, et al., J Biol Chem 275 (11), 7862-7869, Mar. 17, 2000). As used herein G-protein-coupled receptor, and grammatical equivalents thereof, refers to the family of receptors that bind to heterotrimeric “G proteins.” Many different G proteins are known to interact with receptors. G protein signaling systems include three components: the receptor itself, a GTP-binding protein (G protein), and an intracellular target protein. The cell membrane acts as a switchboard. Messages arriving through different receptors can produce a single effect if the receptors act on the same type of G protein. On the other hand, signals activating a single receptor can produce more than one effect if the receptor acts on different kinds of G proteins, or if the G proteins can act on different effectors.

In their resting state, the G proteins, which consist of alpha (α), beta (β) and gamma (γ) subunits, are complexed with the nucleotide guanosine diphosphate (GDP) and are in contact with receptors. When a hormone or other first messenger binds to a receptor, the receptor changes conformation and this alters its interaction with the G protein. This spurs a subunit to release GDP, and the more abundant nucleotide guanosine triphosphate (GTP), replaces it, activating the G protein. The G protein then dissociates to separate the α subunit from the still complexed beta and gamma subunits. Either the Gα subunit, or the Gβγ complex, depending on the pathway, interacts with an effector. The effector (which is often an enzyme) in turn converts an inactive precursor molecule into an active “second messenger,” which may diffuse through the cytoplasm, triggering a metabolic cascade. After a few seconds, the Gα converts the GTP to GDP, thereby inactivating itself. The inactivated Gα may then reassociate with the Gβγ complex.

Hundreds, if not thousands, of receptors convey messages through heterotrimeric G proteins, of which at least 17 distinct forms have been isolated. Although the greatest variability has been seen in a subunit, several different β and γ structures have been reported. There are, additionally, many different G protein-dependent effectors.

Most G protein-coupled receptors are comprised of a single protein chain that passes through the plasma membrane seven times. Such receptors are often referred to as seven-transmembrane receptors (STRs). More than a hundred different STRs have been found, including many distinct receptors that bind the same ligand, and there are likely many more STRs awaiting discovery.

In addition, STRs have been identified for which the natural ligands are unknown; these receptors are termed “orphan” G protein-coupled receptors, as described above. Examples include receptors cloned by Neote et al. (1993) Cell 72, 415; Kouba et al. FEBS Lett. (1993) 321, 173; and Birkenbach et al. (1993) J. Virol. 67, 2209.

Known ligands for G protein coupled receptors include: purines and nucleotides, such as adenosine, cAMP, ATP, UTP, ADP, melatonin and the like; biogenic amines (and related natural ligands), such as 5-hydroxytryptamine, acetylcholine, dopamine, adrenaline, histamine, noradrenaline, tyramine/octopamine and other related compounds; peptides such as adrenocorticotrophic hormone (acth), melanocyte stimulating hormone (msh), melanocortins, neurotensin (nt), bombesin and related peptides, endothelins, cholecystokinin, gastrin, neurokinin b (nk3), invertebrate tachykinin-like peptides, substance k (nk2), substance p (nk1), neuropeptide y (npy), thyrotropin releasing-factor (trf), bradykinin, angiotensin ii, beta-endorphin, c5a anaphalatoxin, calcitonin, chemokines (also called intercrines), corticotrophic releasing factor (crf), dynorphin, endorphin, fmlp and other formylated peptides, follitropin (fsh), fungal mating pheromones, galanin, gastric inhibitory polypeptide receptor (gip), glucagon-like peptides (glps), glucagon, gonadotropin releasing hormone (gnrh), growth hormone releasing hormone (ghrh), insect diuretic hormone, interleukin-8, leutropin (1 h/hcg), met-enkephalin, opioid peptides, oxytocin, parathyroid hormone (pth) and pthrp, pituitary adenylyl cyclase activating peptide (pacap), secretin, somatostatin, thrombin, thyrotropin (tsh), vasoactive intestinal peptide (vip), vasopressin, vasotocin; eicosanoids such as ip-prostacyclin, pg-prostaglandins, tx-thromboxanes; retinal based compounds such as vertebrate 11-cis retinal, invertebrate 11-cis retinal and other related compounds; lipids and lipid-based compounds such as cannabinoids, anandamide, lysophosphatidic acid, platelet activating factor, leukotrienes and the like; excitatory amino acids and ions such as calcium ions and glutamate.

Preferred G protein coupled receptors include, but are not limited to: α1-adrenergic receptor, α1B-adrenergic receptor, α2-adrenergic receptor, α2B-adrenergic receptor, β1-adrenergic receptor, β2-adrenergic receptor, β3-adrenergic receptor, m1 acetylcholine receptor (AChR), m2 AChR, m3 AChR, m4 AChR, m5 AChR, D1 dopamine receptor, D2 dopamine receptor, D3 dopamine receptor, D4 dopamine receptor, D5 dopamine receptor, A1 adenosine receptor, A2a adenosine receptor, A2b adenosine receptor, A3 adenosine receptor, 5-HT1a receptor, 5-HT1b receptor, 5HT1-like receptor, 5-HT1d receptor, 5HT1d-like receptor, 5HT1d beta receptor, substance K (neurokinin A) receptor, fMLP receptor (FPR), fMLP-like receptor (FPRL-1), angiotensin II type 1 receptor, endothelin ETA receptor, endothelin ETB receptor, thrombin receptor, growth hormone-releasing hormone (GHRH) receptor, vasoactive intestinal peptide receptor, oxytocin receptor, somatostatin SSTR1 and SSTR2, SSTR3, cannabinoid receptor, follicle stimulating hormone (FSH) receptor, leutropin (LH/HCG) receptor, thyroid stimulating hormone (TSH) receptor, thromboxane A2 receptor, platelet-activating factor (PAF) receptor, C5a anaphylatoxin receptor, CXCR1 (IL-8 receptor A), CXCR2 (IL-8 receptor B), Delta Opioid receptor, Kappa Opioid receptor, mip-1alpha/RANTES receptor (CRR1), Rhodopsin, Red opsin, Green opsin, Blue opsin, metabotropic glutamate mGluR1-6, histamine H2 receptor, ATP receptor, neuropeptide Y receptor, amyloid protein precursor receptor, insulin-like growth factor II receptor, bradykinin receptor, gonadotropin-releasing hormone receptor, cholecystokinin receptor, melanocyte stimulating hormone receptor, antidiuretic hormone receptor, glucagon receptor, and adrenocorticotropic hormone II receptor. In addition, there are at least five receptors (CC and CXC receptors) involved in HIV viral attachment to cells. The two major co-receptors for HIV are CXCR4, (fusin receptor, LESTR, SDF-1α receptor) and CCR5 (m-trophic). More preferred receptors include the following human receptors: melatonin receptor 1a, galanin receptor 1, neurotensin receptor, adenosine receptor 2a, somatostatin receptor 2 and corticotropin releasing factor receptor 1. Melatonin receptor 1a is particularly preferred. Other G protein coupled receptors (GPCRs) are known in the art.

In one embodiment, Lnk is a protein to be measured. Hematopoietic stem cells (HSCs) give rise to variety of hematopoietic cells via pluripotential progenitors. Lineage-committed progenitors are responsible for blood production throughout adult life. Amplification of HSCs or progenitors represents a potentially powerful approach to the treatment of various blood disorders. Animal model studies demonstrated that Lnk acts as a broad inhibitor of signaling pathways in hematopoietic lineages. Lnk is an adaptor protein which belongs to a family of proteins sharing several structural motifs, including a Src homology 2 (SH2) domain which binds phospho-tyrosines in various signal-transducing proteins. The SH2 domain is essential for Lnk-mediated negative regulation of several cytokine receptors (i.e. Mpl, EpoR, c-Kit, Il-3R and IL7R). Therefore, inhibition of the binding of Lnk to cytokine receptors might lead to enhanced downstream signaling of the receptor and thereby to improved hematopoiesis in response to exposure to cytokines (i.e. erythropoietin in anemic patients). (Gueller et al, Adaptor protein Lnk associates with Y568 in c-Kit. 1: Biochem J. 2008 Jun. 30.) It has been shown that overexpression of Lnk in Ba/F3-MPLW515L cells inhibits cytokine-independent growth, while suppression of Lnk in UT7-MPLW515L cells enhances proliferation. Lnk blocks the activation of Jak2, Stat3, Erk, and Akt in these cells. (Gery et al., Adaptor protein Lnk negatively regulates the mutant MPL, MPLW515L associated with myeloproliferative neoplasms, Blood, 1 Nov. 2007, Vol. 110, No. 9, pp. 3360-3364.)

In one embodiment, the activatable elements are intracellular receptors capable of clustering. Elements of this class are not membrane-bound. Instead, they are free to diffuse through the intracellular matrix where they bind soluble ligands prior to clustering and signal transduction. In contrast to the previously described elements, many members of this class are capable of binding DNA after clustering to directly effect changes in RNA transcription.

In another embodiment the intracellular receptors capable of clustering are perioxisome proliferator-activated receptors (PPAR). PPARs are soluble receptors responsive to lipophillic compounds, and induce various genes involved in fatty acid metabolism. The three PPAR subtypes, PPAR α, β, and γ have been shown to bind to DNA after ligand binding and heterodimerization with retinoid X receptor. (Summanasekera, et al., J Biol Chem, M211261200, Dec. 13, 2002.)

In another embodiment the activatable element is a nucleic acid. Activation and deactivation of nucleic acids can occur in numerous ways including, but not limited to, cleavage of an inactivating leader sequence as well as covalent or non-covalent modifications that induce structural or functional changes. For example, many catalytic RNAs, e.g. hammerhead ribozymes, can be designed to have an inactivating leader sequence that deactivates the catalitic activity of the ribozyme until cleavage occurs. An example of a covalent modification is methylation of DNA. Deactivation by methylation has been shown to be a factor in the silencing of certain genes, e.g. STAT regulating SOCS genes in lymphomas. See Leukemia. See February 2004; 18(2): 356-8. SOCS1 and SHP1 hypermethylation in mantle cell lymphoma and follicular lymphoma: implications for epigenetic activation of the Jak/STAT pathway. Chim C S, Wong K Y, Loong F, Srivastava G.

In another embodiment the activatable element is a small molecule, carbohydrate, lipid or other naturally occurring or synthetic compound capable of having an activated isoform. In addition, as pointed out above, activation of these elements need not include switching from one form to another, but can be detected as the presence or absence of the compound. For example, activation of cAMP (cyclic adenosine mono-phosphate) can be detected as the presence of cAMP rather than the conversion from non-cyclic AMP to cyclic AMP.

Examples of proteins that may include activatable elements include, but are not limited to kinases, phosphatases, lipid signaling molecules, adaptor/scaffold proteins, cytokines, cytokine regulators, ubiquitination enzymes, adhesion molecules, cytoskeletal/contractile proteins, heterotrimeric G proteins, small molecular weight GTPases, guanine nucleotide exchange factors, GTPase activating proteins, caspases, proteins involved in apoptosis, cell cycle regulators, molecular chaperones, metabolic enzymes, vesicular transport proteins, hydroxylases, isomerases, deacetylases, methylases, demethylases, tumor suppressor genes, proteases, ion channels, molecular transporters, transcription factors/DNA binding factors, regulators of transcription, and regulators of translation. Examples of activatable elements, activation states and methods of determining the activation level of activatable elements are described in US Publication Number 20060073474 entitled “Methods and compositions for detecting the activation state of multiple proteins in single cells” and US Publication Number 20050112700 entitled “Methods and compositions for risk stratification” the content of which are incorporate here by reference. See also U.S. Ser. Nos. 61/048,886; 61/048,920; and Shulz et al., Current Protocols in Immunology 2007, 78:8.17.1-20.

In some embodiments, the protein is selected from the group consisting of HER receptors, PDGF receptors, Kit receptor, FGF receptors, Eph receptors, Trk receptors, IGF receptors, Insulin receptor, Met receptor, Ret, VEGF receptors, TIE1, TIE2, FAK, Jak1, Jak2, Jak3, Tyk2, Src, Lyn, Fyn, Lck, Fgr, Yes, Csk, Abl, Btk, ZAP70, Syk, IRAKs, cRaf, ARaf, BRAF, Mos, Lim kinase, ILK, Tpl, ALK, TGFβ receptors, BMP receptors, MEKKs, ASK, MLKs, DLK, PAKs, Mek 1, Mek 2, MKK3/6, MKK4/7, ASK1, Cot, NIK, Bub, Myt 1, Wee1, Casein kinases, PDK1, SGK1, SGK2, SGK3, Akt1, Akt2, Akt3, p90Rsks, p70S6 Kinase, Prks, PKCs, PKAs, ROCK 1, ROCK 2, Auroras, CaMKs, MNKs, AMPKs, MELK, MARKs, Chk1, Chk2, LKB-1, MAPKAPKs, Pim1, Pim2, Pim3, IKKs, Cdks, Jnks, Erks, IKKs, GSK3α, GSK3β, Cdks, CLKs, PKR, PI3-Kinase class 1, class 2, class 3, mTor, SAPK/JNK1,2,3, p38s, PKR, DNA-PK, ATM, ATR, Receptor protein tyrosine phosphatases (RPTPs), LAR phosphatase, CD45, Non receptor tyrosine phosphatases (NPRTPs), SHPs, MAP kinase phosphatases (MKPs), Dual Specificity phosphatases (DUSPs), CDC25 phosphatases, Low molecular weight tyrosine phosphatase, Eyes absent (EYA) tyrosine phosphatases, Slingshot phosphatases (SSH), serine phosphatases, PP2A, PP2B, PP2C, PP1, PP5, inositol phosphatases, PTEN, SHIPs, myotubularins, phosphoinositide kinases, phopsholipases, prostaglandin synthases, 5-lipoxygenase, sphingosine kinases, sphingomyelinases, adaptor/scaffold proteins, Shc, Grb2, BLNK, LAT, B cell adaptor for PI3-kinase (BCAP), SLAP, Dok, KSR, MyD88, Crk, CrkL, GAD, Nck, Grb2 associated binder (GAB), Fas associated death domain (FADD), TRADD, TRAF2, RIP, T-Cell leukemia family, IL-2, IL-4, IL-8, IL-6, interferon γ, interferon α, suppressors of cytokine signaling (SOCs), Cbl, SCF ubiquitination ligase complex, APC/C, adhesion molecules, integrins, Immunoglobulin-like adhesion molecules, selectins, cadherins, catenins, focal adhesion kinase, p130CAS, fodrin, actin, paxillin, myosin, myosin binding proteins, tubulin, eg5/KSP, CENPs, β-adrenergic receptors, muscarinic receptors, adenylyl cyclase receptors, small molecular weight GTPases, H-Ras, K-Ras, N-Ras, Ran, Rac, Rho, Cdc42, Arfs, RABs, RHEB, Vav, Tiam, Sos, Dbl, PRK, TSC1,2, Ras-GAP, Arf-GAPs, Rho-GAPs, caspases, Caspase 2, Caspase 3, Caspase 6, Caspase 7, Caspase 8, Caspase 9, Bcl-2, Mcl-1, Bcl-XL, Bcl-w, Bcl-B, A1, Bax, Bak, Bok, Bik, Bad, Bid, Bim, Bmf, Hrk, Noxa, Puma, IAPB, XIAP, Smac, Cdk4, Cdk 6, Cdk 2, Cdk1, Cdk 7, Cyclin D, Cyclin E, Cyclin A, Cyclin B, Rb, p16, p14Arf, p27KIP, p21CIP, molecular chaperones, Hsp90s, Hsp70, Hsp27, metabolic enzymes, Acetyl-CoA Carboxylase, ATP citrate lyase, nitric oxide synthase, caveolins, endosomal sorting complex required for transport (ESCRT) proteins, vesicular protein sorting (Vsps), hydroxylases, prolyl-hydroxylases PHD-1, 2 and 3, asparagine hydroxylase FIH transferases, Pin1 prolyl isomerase, topoisomerases, deacetylases, Histone deacetylases, sirtuins, histone acetylases, CBP/P300 family, MYST family, ATF2, DNA methyl transferases, Histone H3K4 demethylases, H3K27, JHDM2A, UTX, VHL, WT-1, p53, Hdm, PTEN, ubiquitin proteases, urokinase-type plasminogen activator (uPA) and uPA receptor (uPAR) system, cathepsins, metalloproteinases, esterases, hydrolases, separase, potassium channels, sodium channels, resistance proteins, P-Gycoprotein, nucleoside transporters, Ets, Elk, SMADs, Rel-A (p65-NFKB), CREB, NFAT, ATF-2, AFT, Myc, Fos, Spl, Egr-1, T-bet, β-catenin, HIFs, FOXOs, E2Fs, SRFs, TCFs, Egr-1, β-catenin, FOXO, STAT1, STAT 3, STAT 4, STAT 5, STAT 6, p53, WT-1, HMGA, pS6, 4EPB-1, eIF4E-binding protein, RNA polymerase, initiation factors, elongation factors.

In some embodiments of the invention, the methods described herein are employed to determine the activation level of an activatable element, e.g., in a cellular pathway. Methods and compositions are provided for the classification of a cell according to the activation level of an activatable element in a cellular pathway. The cell can be a hematopoietic cell. Examples of hematopoietic cells include but are not limited to pluripotent hematopoietic stem cells, granulocyte lineage progenitor or derived cells, monocyte lineage progenitor or derived cells, macrophage lineage progenitor or derived cells, megakaryocyte lineage progenitor or derived cells and erythroid lineage progenitor or derived cells.

### Kits

In some embodiments the invention provides kits. Kits provided by the invention may comprise one or more of the state-specific binding elements described herein, such as phospho-specific antibodies. A kit may also include other reagents that are useful in the invention, such as modulators, fixatives, containers, plates, buffers, therapeutic agents, instructions, and the like.

In some embodiments, the kit comprises one or more of the phospho-specific antibodies specific for the proteins selected from the group consisting of PI3-Kinase (p85, p110a, p110b, p110d), Jak1, Jak2, SOCs, Rac, Rho, Cdc42, Ras-GAP, Vav, Tiam, Sos, Dbl, Nck, Gab, PRK, SHP1, and SHP2, SHIP1, SHIP2, sSHIP, PTEN, Shc, Grb2, PDK1, SGK, Akt1, Akt2, Akt3, TSC1,2, Rheb, mTor, 4EBP-1, p70S6Kinase, S6, LKB-1, AMPK, PFK, Acetyl-CoA Carboxylase, DokS, Rafs, Mos, Tpl2, MEK1/2, MLK3, TAK, DLK, MKK3/6, MEKK1,4, MLK3, ASK1, MKK4/7, SAPK/JNK1,2,3, p38s, Erk1/2, Syk, Btk, BLNK, LAT, ZAP70, Lck, Cbl, SLP-76, PLCγ□, PLCγ 2, STAT1, STAT 3, STAT 4, STAT 5, STAT 6, FAK, p130CAS, PAKs, LIMK1/2, Hsp90, Hsp70, Hsp27, SMADs, Rel-A (p65-NFKB), CREB, Histone H2B, HATs, HDACs, PKR, Rb, Cyclin D, Cyclin E, Cyclin A, Cyclin B, P16, p14Arf, p27KIP, p21CIP, Cdk4, Cdk6, Cdk7, Cdk1, Cdk2, Cdk9, Cdc25, A/B/C, Abl, E2F, FADD, TRADD, TRAF2, RIP, Myd88, BAD, Bcl-2, Mcl-1, Bcl-XL, Caspase 2, Caspase 3, Caspase 6, Caspase 7, Caspase 8, Caspase 9, IAPB, Smac, Fodrin, Actin, Src, Lyn, Fyn, Lck, NIK, IκB, p65(RelA), IKKα, PKA, PKCα□□, PKCβ□□, PKCθ□□, PKCδ, CAMK, Elk, AFT, Myc, Egr-1, NFAT, ATF-2, Mdm2, p53, DNA-PK, Chk1, Chk2, ATM, ATR, ε□ catenin, CrkL, GSK3α, GSK3β, and FOXO. In some embodiments, the kit comprises one or more of the phospho-specific antibodies specific for the proteins selected from the group consisting of Erk, Syk, Zap70, Lck, Btk, BLNK, Cbl, PLCγ2, Akt, ReilA, p38, S6. In some embodiments, the kit comprises one or more of the phospho-specific antibodies specific for the proteins selected from the group consisting of Akt1, Akt2, Akt3, SAPK/JNK1,2,3, p38s, Erk1/2, Syk, ZAP70, Btk, BLNK, Lck, PLCγ, PLCγ 2, STAT1, STAT 3, STAT 4, STAT 5, STAT 6, CREB, Lyn, p-S6, Cbl, NF-κB, GSK3β, CARMA/Bcl10 and Tcl-1.

Kits provided by the invention may comprise one or more of the modulators described herein. In some embodiments, the kit comprises one or more modulators selected from the group consisting of H₂O₂, PMA, BAFF, April, SDF1 α, CD40L, IGF-1, Imiquimod, polyCpG, IL-7, IL-6, IL-10, IL-27, IL-4, IL-2, IL-3, thapsigardin and a combination thereof.

The state-specific binding element of the invention can be conjugated to a solid support and to detectable groups directly or indirectly. The reagents may also include ancillary agents such as buffering agents and stabilizing agents, e.g., polysaccharides and the like. The kit may further include, where necessary, other members of the signal-producing system of which system the detectable group is a member (e.g., enzyme substrates), agents for reducing background interference in a test, control reagents, apparatus for conducting a test, and the like. The kit may be packaged in any suitable manner, typically with all elements in a single container along with a sheet of printed instructions for carrying out the test.

Such kits enable the detection of activatable elements by sensitive cellular assay methods, such as IHC and flow cytometry, which are suitable for the clinical detection, prognosis, and screening of cells and tissue from patients, such as leukemia patients, having a disease involving altered pathway signaling.

Such kits may additionally comprise one or more therapeutic agents. The kit may further comprise a software package for data analysis of the physiological status, which may include reference profiles for comparison with the test profile.

Such kits may also include information, such as scientific literature references, package insert materials, clinical trial results, and/or summaries of these and the like, which indicate or establish the activities and/or advantages of the composition, and/or which describe dosing, administration, side effects, drug interactions, or other information useful to the health care provider. Such information may be based on the results of various studies, for example, studies using experimental animals involving in vivo models and studies based on human clinical trials. Kits described herein can be provided, marketed and/or promoted to health providers, including physicians, nurses, pharmacists, formulary officials, and the like. Kits may also, in some embodiments be marketed to research companies, organization, and institutions for drug screening applications. Kits may also, in some embodiments, be marketed directly to the consumer.

### Generation of Node State Data

One or more cells or cell types, or samples containing one or more cells or cell types, can be isolated from body samples. The cells can be separated from body samples by centrifugation, elutriation, density gradient separation, apheresis, affinity selection, panning, FACS, centrifugation with Hypaque, solid supports (magnetic beads, beads in columns, or other surfaces) with attached antibodies, etc. By using antibodies specific for markers identified with particular cell types, a relatively homogeneous population of cells may be obtained. Cells can also be separated by using filters. For example, whole blood can also be applied to filters that are engineered to contain pore sizes that select for the desired cell type or class. Rare pathogenic cells can be filtered out of diluted, whole blood following the lysis of red blood cells by using filters with pore sizes between 5 to 10 μm, as disclosed in U.S. patent application Ser. No. 09/790,673. Alternatively, a heterogeneous cell population may be analyzed. Alternatively, a whole sample, without any cell separation may be used, e.g. whole blood (See U.S. Ser. No. 61/226,878, example 4). Once a sample is obtained, it can be used directly, frozen, or maintained in appropriate culture medium for short periods of time. Methods to isolate one or more cells for use according to the methods of this invention are performed according to standard techniques and protocols well-established in the art. See also U.S. Ser. Nos. 61/048,886; 61/048,920; and 61/048,657. See also, the commercial products from companies such as BD and BCI as identified above.

See also U.S. Pat. Nos. 7,381,535 and 7,393,656. All of the above patents and applications are incorporated by reference as stated above.

In some embodiments, the cells are cultured post collection in a media suitable for revealing the activation level of an activatable element (e.g. RPMI, DMEM) in the presence, or absence, of serum such as fetal bovine serum, bovine serum, human serum, porcine serum, horse serum, or goat serum. When serum is present in the media it could be present at a level ranging from 0.0001% to 30%.

Examples of hematopoietic cells include but are not limited to pluripotent hematopoietic stem cells, B-lymphocyte lineage progenitor or derived cells, T-lymphocyte lineage progenitor or derived cells, NK cell lineage progenitor or derived cells, granulocyte lineage progenitor or derived cells, monocyte lineage progenitor or derived cells, megakaryocyte lineage progenitor or derived cells and erythroid lineage progenitor or derived cells.

In practicing the methods of this invention, the detection of the status of the one or more activatable elements can be carried out by a person, such as a technician in the central laboratory. Alternatively, the detection of the status of the one or more activatable elements can be carried out using automated systems. In either case, the detection of the status of the one or more activatable elements for use according to the methods of this invention is performed according to standard techniques and protocols well-established in the art.

One or more activatable elements can be detected and/or quantified by any method that detect and/or quantitates the presence of the activatable element of interest. Such methods may include radioimmunoassay (RIA) or enzyme linked immunoabsorbance assay (ELISA), immunohistochemistry, immunofluorescent histochemistry with or without confocal microscopy, reversed phase assays, homogeneous enzyme immunoassays, and related non-enzymatic techniques, Western blots, whole cell staining, immunoelectronmicroscopy, nucleic acid amplification, gene array, protein array, mass spectrometry, patch clamp, 2-dimensional gel electrophoresis, differential display gel electrophoresis, microsphere-based multiplex protein assays, label-free cellular assays and flow cytometry, etc. U.S. Pat. No. 4,568,649 describes ligand detection systems, which employ scintillation counting. These techniques are particularly useful for modified protein parameters. Cell readouts for proteins and other cell determinants can be obtained using fluorescent or otherwise tagged reporter molecules. Flow cytometry methods are useful for measuring intracellular parameters.

In some embodiments, the present invention provides methods for determining an activatable element's activation profile for a single cell. The methods may comprise analyzing cells by flow cytometry on the basis of the activation level of at least two activatable elements. Binding elements (e.g. activation state-specific antibodies) are used to analyze cells on the basis of activatable element activation level, and can be detected as described below. Alternatively, non-binding elements systems as described above can be used in any system described herein. One embodiment uses single cell network profiling (SCNP).

Detection of cell signaling states may be accomplished using binding elements and labels. Cell signaling states may be detected by a variety of methods known in the art. They generally involve a binding element, such as an antibody, and a label, such as a fluorochrome to form a detection element. Detection elements do not need to have both of the above agents, but can be one unit that possesses both qualities. These and other methods are well described in U.S. Pat. Nos. 7,381,535 and 7,393,656 and U.S. Ser. Nos. 10/193,462; 11/655,785; 11/655,789; 11/655,821; 11/338,957, 61/048,886; 61/048,920; and 61/048,657 which are all incorporated by reference in their entireties.

In one embodiment of the invention, it is advantageous to increase the signal to noise ratio by contacting the cells with the antibody and label for a time greater than 5, 6, 7, 8, 9, 10, 11, 12, 13, 14, 15, 16, 17, 18, 19, 20, 24 or up to 48 or more hours.

When using fluorescent labeled components in the methods and compositions of the present invention, it will recognized that different types of fluorescent monitoring systems, e.g., Cytometric measurement device systems, can be used to practice the invention. In some embodiments, flow cytometric systems are used or systems dedicated to high throughput screening, e.g. 96 well or greater microtiter plates. Methods of performing assays on fluorescent materials are well known in the art and are described in, e.g., Lakowicz, J. R., Principles of Fluorescence Spectroscopy, New York: Plenum Press (1983); Herman, B., Resonance energy transfer microscopy, in: Fluorescence Microscopy of Living Cells in Culture, Part B, Methods in Cell Biology, vol. 30, ed. Taylor, D. L. & Wang, Y.-L., Diego Academic Press (1989), pp. 219-243; Turro, N.J., Modern Molecular Photochemistry, Menlo Park Benjamin/Cummings Publishing Col, Inc. (1978), pp. 296-361.

Fluorescence in a sample can be measured using a fluorimeter. In general, excitation radiation, from an excitation source having a first wavelength, passes through excitation optics. The excitation optics cause the excitation radiation to excite the sample. In response, fluorescent proteins in the sample emit radiation that has a wavelength that is different from the excitation wavelength. Collection optics then collect the emission from the sample. The device can include a temperature controller to maintain the sample at a specific temperature while it is being scanned. According to one embodiment, a multi-axis translation stage moves a microtiter plate holding a plurality of samples in order to position different wells to be exposed. The multi-axis translation stage, temperature controller, auto-focusing feature, and electronics associated with imaging and data collection can be managed by an appropriately programmed digital computer. The computer also can transform the data collected during the assay into another format for presentation. In general, known robotic systems and components can be used.

Other methods of detecting fluorescence may also be used, e.g., Quantum dot methods (see, e.g., Goldman et al., J. Am. Chem. Soc. (2002) 124:6378-82; Pathak et al. J. Am. Chem. Soc. (2001) 123:4103-4; and Remade et al., Proc. Natl. Sci. USA (2000) 18:553-8, each expressly incorporated herein by reference) as well as confocal microscopy. In general, flow cytometry involves the passage of individual cells through the path of a laser beam. The scattering the beam and excitation of any fluorescent molecules attached to, or found within, the cell is detected by photomultiplier tubes to create a readable output, e.g. size, granularity, or fluorescent intensity.

The detecting, sorting, or isolating step of the methods of the present invention can entail fluorescence-activated cell sorting (FACS) techniques, where FACS is used to select cells from the population containing a particular surface marker, or the selection step can entail the use of magnetically responsive particles as retrievable supports for target cell capture and/or background removal. A variety of FACS systems are known in the art and can be used in the methods of the invention (see e.g., WO99/54494, filed Apr. 16, 1999; U.S. Ser. No. 20010006787, filed Jul. 5, 2001, each expressly incorporated herein by reference).

In some embodiments, a FACS cell sorter (e.g. a FACSVantage™ Cell Sorter, Becton Dickinson Immunocytometry Systems, San Jose, Calif.) is used to sort and collect cells based on their activation profile (positive cells) in the presence or absence of an increase in activation level in an activatable element in response to a modulator. Other flow cytometers that are commercially available include the LSR II and the Canto II both available from Becton Dickinson. See Shapiro, Howard M., Practical Flow Cytometry, 4th Ed., John Wiley & Sons, Inc., 2003 for additional information on flow cytometers.

In some embodiments, the cells are first contacted with fluorescent-labeled activation state-specific binding elements (e.g. antibodies) directed against specific activation state of specific activatable elements. In such an embodiment, the amount of bound binding element on each cell can be measured by passing droplets containing the cells through the cell sorter. By imparting an electromagnetic charge to droplets containing the positive cells, the cells can be separated from other cells. The positively selected cells can then be harvested in sterile collection vessels. These cell-sorting procedures are described in detail, for example, in the FACSVantage™. Training Manual, with particular reference to sections 3-11 to 3-28 and 10-1 to 10-17, which is hereby incorporated by reference in its entirety. See the patents, applications and articles referred to, and incorporated above for detection systems.

Fluorescent compounds such as Daunorubicin and Enzastaurin are problematic for flow cytometry based biological assays due to their broad fluorescence emission spectra. These compounds get trapped inside cells after fixation with agents like paraformaldehyde, and are excited by one or more of the lasers found on flow cytometers. The fluorescence emission of these compounds is often detected in multiple PMT detectors which complicates their use in multiparametric flow cytometry. A way to get around this problem is to compensate out the fluorescence emission of the compound from the PMT detectors used to measure the relevant biological markers. This is achieved using a PMT detector with a bandpass filter near the emission maximum of the fluorescent compound, and cells incubated with the compound as the compensation control when calculating a compensation matrix. The cells incubated with the fluorescent compound are fixed with paraformaldehyde, then washed and permeabilized (“permed”) with 100% methanol. The methanol is washed out and the cells are mixed with unlabeled fixed/permed cells to yield a compensation control consisting of a mixture of fluorescent and negative cell populations.

In another embodiment, positive cells can be sorted using magnetic separation of cells based on the presence of an isoform of an activatable element. In such separation techniques, cells to be positively selected are first contacted with specific binding element (e.g., an antibody or reagent that binds an isoform of an activatable element). The cells are then contacted with retrievable particles (e.g., magnetically responsive particles) that are coupled with a reagent that binds the specific element. The cell-binding element-particle complex can then be physically separated from non-positive or non-labeled cells, for example, using a magnetic field. When using magnetically responsive particles, the positive or labeled cells can be retained in a container using a magnetic field while the negative cells are removed. These and similar separation procedures are described, for example, in the Baxter Immunotherapy Isolex training manual which is hereby incorporated in its entirety.

In some embodiments, methods for the determination of a receptor element activation state profile for a single cell are provided. The methods comprise providing a population of cells and analyze the population of cells by flow cytometry. Preferably, cells are analyzed on the basis of the activation level of at least two activatable elements. In some embodiments, a multiplicity of activatable element activation-state antibodies is used to simultaneously determine the activation level of a multiplicity of elements.

Flow cytometry is useful in a clinical setting, since relatively small sample sizes, as few as 10,000 cells, can produce a considerable amount of statistically tractable multidimensional signaling data and reveal key cell subsets that are responsible for a phenotype. See U.S. Pat. Nos. 7,381,535 and 7,393,656. See also Krutzik et al, 2004. Other methods for analyzing single cells include mass spec and laser cytometry.

In some embodiment, cell analysis by flow cytometry on the basis of the activation level of at least two elements is combined with a determination of other flow cytometry readable outputs, such as the presence of surface markers, granularity and cell size to provide a correlation between the activation level of a multiplicity of elements and other cell qualities measurable by flow cytometry for single cells.

When necessary cells are dispersed into a single cell suspension, e.g. by enzymatic digestion with a suitable protease, e.g. collagenase, dispase, etc; and the like. An appropriate solution is used for dispersion or suspension. Such solution will generally be a balanced salt solution, e.g. normal saline, PBS, Hanks balanced salt solution, etc., conveniently supplemented with fetal calf serum or other naturally occurring factors, in conjunction with an acceptable buffer at low concentration, generally from 5-25 mM. Convenient buffers include HEPES1 phosphate buffers, lactate buffers, etc. The cells may be fixed, e.g. with 3% paraformaldehyde, and are usually permeabilized, e.g. with ice cold methanol; HEPES-buffered PBS containing 0.1% saponin, 3% BSA; covering for 2 min in acetone at −200 C; and the like as known in the art and according to the methods described herein.

In some embodiments, one or more cells are contained in a well of a 96 well plate or other commercially available multiwell plate. In an alternate embodiment, the reaction mixture or cells are in a cytometric measurement device. Other multiwell plates useful in the present invention include, but are not limited to 384 well plates and 1536 well plates. Still other vessels for containing the reaction mixture or cells and useful in the present invention will be apparent to the skilled artisan.

The addition of the components of the assay for detecting the activation level or activity of an activatable element, or modulation of such activation level or activity, may be sequential or in a predetermined order or grouping under conditions appropriate for the activity that is assayed for. Such conditions are described here and known in the art. Moreover, further guidance is provided below (see, e.g., in the Examples).

In some embodiments, the activation level of an activatable element is measured using Inductively Coupled Plasma Mass Spectrometer (ICP-MS). A binding element that has been labeled with a specific element binds to the activatable element. When the cell is introduced into the ICP, it is atomized and ionized. The elemental composition of the cell, including the labeled binding element that is bound to the activatable element, is measured. The presence and intensity of the signals corresponding to the labels on the binding element indicates the level of the activatable element on that cell (Tanner et al. Spectrochimica Acta Part B: Atomic Spectroscopy, 2007 March; 62(3):188-195).

As will be appreciated by one of skill in the art, the instant methods and compositions find use in a variety of other assay formats in addition to flow cytometry analysis. For example, DNA microarrays are commercially available through a variety of sources (Affymetrix, Santa Clara, Calif.) or they can be custom made in the lab using arrayers which are also known (Perkin Elmer). In addition, protein chips and methods for synthesis are known. These methods and materials may be adapted for the purpose of affixing activation state binding elements to a chip in a prefigured array. In some embodiments, such a chip comprises a multiplicity of element activation state binding elements, and is used to determine an element activation state profile for elements present on the surface of a cell.

In some embodiments, a chip comprises a multiplicity of the “second set binding elements,” in this case generally unlabeled. Such a chip is contacted with sample, preferably cell extract, and a second multiplicity of binding elements comprising element activation state specific binding elements is used in the sandwich assay to simultaneously determine the presence of a multiplicity of activated elements in sample. Preferably, each of the multiplicity of activation state-specific binding elements is uniquely labeled to facilitate detection.

In some embodiments confocal microscopy can be used to detect activation profiles for individual cells. Confocal microscopy relies on the serial collection of light from spatially filtered individual specimen points, which is then electronically processed to render a magnified image of the specimen. The signal processing involved confocal microscopy has the additional capability of detecting labeled binding elements within single cells, accordingly in this embodiment the cells can be labeled with one or more binding elements. In some embodiments the binding elements used in connection with confocal microscopy are antibodies conjugated to fluorescent labels, however other binding elements, such as other proteins or nucleic acids are also possible.

In some embodiments, the methods and compositions of the instant invention can be used in conjunction with an “In-Cell Western Assay.” In such an assay, cells are initially grown in standard tissue culture flasks using standard tissue culture techniques. Once grown to optimum confluency, the growth media is removed and cells are washed and trypsinized. The cells can then be counted and volumes sufficient to transfer the appropriate number of cells are aliquoted into microwell plates (e.g., Nunc™ 96 Microwell™ plates). The individual wells are then grown to optimum confluency in complete media whereupon the media is replaced with serum-free media. At this point controls are untouched, but experimental wells are incubated with a modulator, e.g. EGF. After incubation with the modulator cells are fixed and stained with labeled antibodies to the activation elements being investigated. Once the cells are labeled, the plates can be scanned using an imager such as the Odyssey Imager (LiCor, Lincoln Nebr.) using techniques described in the Odyssey Operator's Manual v1.2., which is hereby incorporated in its entirety. Data obtained by scanning of the multiwell plate can be analyzed and activation profiles determined as described below.

In some embodiments, the detecting is by high pressure liquid chromatography (HPLC), for example, reverse phase HPLC, and in a further aspect, the detecting is by mass spectrometry.

These instruments can fit in a sterile laminar flow or fume hood, or are enclosed, self-contained systems, for cell culture growth and transformation in multi-well plates or tubes and for hazardous operations. The living cells may be grown under controlled growth conditions, with controls for temperature, humidity, and gas for time series of the live cell assays. Automated transformation of cells and automated colony pickers may facilitate rapid screening of desired cells.

Flow cytometry or capillary electrophoresis formats can be used for individual capture of magnetic and other beads, particles, cells, and organisms.

Flexible hardware and software allow instrument adaptability for multiple applications. The software program modules allow creation, modification, and running of methods. The system diagnostic modules allow instrument alignment, correct connections, and motor operations. Customized tools, labware, and liquid, particle, cell and organism transfer patterns allow different applications to be performed. Databases allow method and parameter storage. Robotic and computer interfaces allow communication between instruments.

In some embodiment, the methods of the invention include the use of liquid handling components. The liquid handling systems can include robotic systems comprising any number of components. In addition, any or all of the steps outlined herein may be automated; thus, for example, the systems may be completely or partially automated. See U.S. Ser. No. 61/048,657.

As will be appreciated by those in the art, there are a wide variety of components which can be used, including, but not limited to, one or more robotic arms; plate handlers for the positioning of microplates; automated lid or cap handlers to remove and replace lids for wells on non-cross contamination plates; tip assemblies for sample distribution with disposable tips; washable tip assemblies for sample distribution; 96 well loading blocks; cooled reagent racks; microtiter plate pipette positions (optionally cooled); stacking towers for plates and tips; and computer systems.

Fully robotic or microfluidic systems include automated liquid-, particle-, cell- and organism-handling including high throughput pipetting to perform all steps of screening applications. This includes liquid, particle, cell, and organism manipulations such as aspiration, dispensing, mixing, diluting, washing, accurate volumetric transfers; retrieving, and discarding of pipet tips; and repetitive pipetting of identical volumes for multiple deliveries from a single sample aspiration. These manipulations are cross-contamination-free liquid, particle, cell, and organism transfers. This instrument performs automated replication of microplate samples to filters, membranes, and/or daughter plates, high-density transfers, full-plate serial dilutions, and high capacity operation.

In some embodiments, chemically derivatized particles, plates, cartridges, tubes, magnetic particles, or other solid phase matrix with specificity to the assay components are used. The binding surfaces of microplates, tubes or any solid phase matrices include non-polar surfaces, highly polar surfaces, modified dextran coating to promote covalent binding, antibody coating, affinity media to bind fusion proteins or peptides, surface-fixed proteins such as recombinant protein A or G, nucleotide resins or coatings, and other affinity matrix are useful in this invention.

In some embodiments, platforms for multi-well plates, multi-tubes, holders, cartridges, minitubes, deep-well plates, microfuge tubes, cryovials, square well plates, filters, chips, optic fibers, beads, and other solid-phase matrices or platform with various volumes are accommodated on an upgradable modular platform for additional capacity. This modular platform includes a variable speed orbital shaker, and multi-position work decks for source samples, sample and reagent dilution, assay plates, sample and reagent reservoirs, pipette tips, and an active wash station. In some embodiments, the methods of the invention include the use of a plate reader.

In some embodiments, thermocycler and thermoregulating systems are used for stabilizing the temperature of heat exchangers such as controlled blocks or platforms to provide accurate temperature control of incubating samples from 0° C. to 100° C.

In some embodiments, interchangeable pipet heads (single or multi-channel) with single or multiple magnetic probes, affinity probes, or pipetters robotically manipulate the liquid, particles, cells, and organisms. Multi-well or multi-tube magnetic separators or platforms manipulate liquid, particles, cells, and organisms in single or multiple sample formats.

In some embodiments, the instrumentation will include a detector, which can be a wide variety of different detectors, depending on the labels and assay. In some embodiments, useful detectors include a microscope(s) with multiple channels of fluorescence; plate readers to provide fluorescent, ultraviolet and visible spectrophotometric detection with single and dual wavelength endpoint and kinetics capability, fluorescence resonance energy transfer (FRET), luminescence, quenching, two-photon excitation, and intensity redistribution; CCD cameras to capture and transform data and images into quantifiable formats; and a computer workstation.

In some embodiments, the robotic apparatus includes a central processing unit which communicates with a memory and a set of input/output devices (e.g., keyboard, mouse, monitor, printer, etc.) through a bus. Again, as outlined below, this may be in addition to or in place of the CPU for the multiplexing devices of the invention. The general interaction between a central processing unit, a memory, input/output devices, and a bus is known in the art. Thus, a variety of different procedures, depending on the experiments to be run, are stored in the CPU memory.

These robotic fluid handling systems can utilize any number of different reagents, including buffers, reagents, samples, washes, assay components such as label probes, etc.

### Modeling Node State Data

Phospho-protein members of signaling cascades and the kinases and phosphatases that interact with them are required to initiate and regulate proliferative signals in cells. Apart from the basal level of protein phosphorylation alone, the effect of potential drug molecules on these network pathways was studied to discern unique cancer network profiles, which correlate with the genetics and disease outcome. Single cell measurements of phospho-protein responses reveal shifts in the signaling potential of a phospho-protein network, enabling categorization of cell network phenotypes by multidimensional molecular profiles of signaling. See U.S. Pat. No. 7,393,656. See also Irish et. al., Single cell profiling of potentiated phospho-protein networks in cancer cells. Cell. 118: 1-20, 2004.

Cytokine response panels have been studied to survey altered signal transduction of cancer cells by using a multidimensional flow cytometry file which contained at least 30,000 cell events. In one embodiment, this panel is expanded and the effect of growth factors and cytokines on primary AML samples studied. See U.S. Pat. Nos. 7,381,535 and 7,393,656. See also Irish et. al., Cell 118: 1-20, 2004. The growth factor and the cytokine response panel included detection of phosphorylated Stat1, Stat3, Stat5, Stat6, PLCγ2, S6, Akt, Erk1/2, CREB, p38, and NF-KBp-65.

In some embodiments, the process of apoptosis, drug transport, drug metabolism, and the use of peroxide are employed to evaluate phosphatase activity. Analysis can assess the ability of the cell to undergo the process of apoptosis after exposure to the experimental drug in an in vitro assay as well as how quickly the drug is exported out of the cell or metabolized. The drug response panel can include but is not limited to detection of phosphorylated Chk2, Cleaved Caspase 3, Caspase 8, PARP and mitochondria-released Cytochrome C. Modulators may include Stauro, Etoposide, AraC, daunorubicin. Analysis can assess phosphatase activity after exposure of cells to phosphatase inhibitors including but not limited to 3 mM hydrogen peroxide (H₂O₂), 3 mM H₂O₂+SCF and 3 mM H₂O₂+IFNα. The response panel to evaluate phosphatase activity can include but is not limited to the detection of phosphorylated Slp76, PLCg2, Lck, S6, Akt, Erk, Stat1, Sta3, Stat5. Later, the samples may be analyzed for the expression of drug transporters such as MDR1/PGP, MRP1 and BCRP/ABCG2. Samples may also be examined for XIAP, Survivin, Bcl-2, MCL-1, Bim, Ki-67, Cyclin D1, ID1 and Myc.

Each of these techniques capitalizes on the ability of flow cytometry to deliver large amounts of multiparameter data at the single cell level. For cells associated with a condition (e.g. neoplastic or hematopoetic condition), a third “meta-level” of data exists because cells associated with a condition (e.g. cancer cells) are generally treated as a single entity and classified according to historical techniques. These techniques have included organ or tissue of origin, degree of differentiation, proliferation index, metastatic spread, and genetic or metabolic data regarding the patient.

In some embodiments, the present invention uses variance mapping techniques for mapping condition signalling space. These methods represent a significant advance in the study of condition biology because it enables comparison of conditions independent of a putative normal control. Traditional differential state analysis methods (e.g., DNA microarrays, subtractive Northern blotting) generally rely on the comparison of cells associated with a condition from each patient sample with a normal control, generally adjacent and theoretically untransformed tissue. Alternatively, they rely on multiple clusterings and reclusterings to group and then further stratify patient samples according to phenotype. In contrast, variance mapping of condition states compares condition samples first with themselves and then against the parent condition population. As a result, activation states with the most diversity among conditions provide the core parameters in the differential state analysis. Given a pool of diverse conditions, this technique allows a researcher to identify the molecular events that underlie differential condition pathology (e.g., cancer responses to chemotherapy), as opposed to differences between conditions and a proposed normal control.

In some embodiments, when variance mapping is used to profile the signaling space of patient samples, conditions whose signaling response to modulators is similar are grouped together, regardless of tissue or cell type of origin. Similarly, two conditions (e.g. two tumors) that are thought to be relatively alike based on lineage markers or tissue of origin could have vastly different abilities to interpret environmental stimuli and would be profiled in two different groups.

When groups of signaling profiles have been identified it is frequently useful to determine whether other factors, such as clinical responses, presence of gene mutations, and protein expression levels, are non-randomly distributed within the groups. If experiments or literature suggest such a hypothesis in an arrayed flow cytometry experiment, it can be judged with simple statistical tests, such as the Student's t-test and the X² test. Similarly, if two variable factors within the experiment are thought to be related, the r² correlation coefficient from a linear regression is used to represent the degree of this relationship.

Examples of analysis for activatable elements are described in US publication number 20060073474 entitled “Methods and compositions for detecting the activation state of multiple proteins in single cells” and US publication number 20050112700 entitled “Methods and compositions for risk stratification” the content of which are incorporate here by reference. See also U.S. Ser. No. 12/501,295.

Advances in flow cytometry have enabled the individual cell enumeration of up to thirteen simultaneous parameters (De Rosa et al., 2001) and are moving towards the study of genomic and proteomic data subsets (Krutzik and Nolan, 2003; Perez and Nolan, 2002). Likewise, advances in other techniques (e.g. microarrays) allow for the identification of multiple activatable elements. As the number of parameters, epitopes, and samples have increased, the complexity of experiments and the challenges of data analysis have grown rapidly. An additional layer of data complexity has been added by the development of stimulation panels which enable the study of activatable elements under a growing set of experimental conditions. See Krutzik et al, Nature Chemical Biology February 2008. Methods for the analysis of multiple parameters are well known in the art. See U.S. Ser. No. 61/079,579 for gating analysis.

In some embodiments where flow cytometry is used, flow cytometry experiments are performed and the results are expressed as fold changes using graphical tools and analyses, including, but not limited to a heat map or a histogram to facilitate evaluation. One common way of comparing changes in a set of flow cytometry samples is to overlay histograms of one parameter on the same plot. Flow cytometry experiments ideally include a reference sample against which experimental samples are compared. Reference samples can include normal and/or cells associated with a condition (e.g. tumor cells). See also U.S. Ser. No. 61/079,537 for visualization tools

As will be appreciated, the present invention also provides for the ordering of element clustering events in signal transduction. Particularly, the present invention allows the artisan to construct an element clustering and activation hierarchy based on the correlation of levels of clustering and activation of a multiplicity of elements within single cells. Ordering can be accomplished by comparing the activation level of a cell or cell population with a control at a single time point, or by comparing cells at multiple time points to observe subpopulations arising out of the others.

The present invention provides a valuable method of determining the presence of cellular subsets within cellular populations. Ideally, signal transduction pathways are evaluated in homogeneous cell populations to ensure that variances in signaling between cells do not qualitatively nor quantitatively mask signal transduction events and alterations therein. As the ultimate homogeneous system is the single cell, the present invention allows the individual evaluation of cells to allow true differences to be identified in a significant way.

Thus, the invention provides methods of distinguishing cellular subsets within a larger cellular population. As outlined herein, these cellular subsets often exhibit altered biological characteristics (e.g. activation levels, altered response to modulators) as compared to other subsets within the population. For example, as outlined herein, the methods of the invention allow the identification of subsets of cells from a population such as primary cell populations, e.g. peripheral blood mononuclear cells that exhibit altered responses (e.g. response associated with presence of a condition) as compared to other subsets. In addition, this type of evaluation distinguishes between different activation states, altered responses to modulators, cell lineages, cell differentiation states, etc.

As will be appreciated, these methods provide for the identification of distinct signaling cascades for both artificial and stimulatory conditions in complex cell populations, such a peripheral blood mononuclear cells, or naive and memory lymphocytes.

A user may also analyze multimodal distributions to separate cell populations.

A user can create other metrics for measuring the negative signal. For example, a user may analyze a “gated unstained” or ungated unstained autofluorescence population as the negative signal for calculations such as “basal” and “total”. This is a population that has been stained with surface markers such as CD33 and CD45 to gate the desired population, but is unstained for the fluorescent parameters to be quantitatively evaluated for node determination. However, every antibody has some degree of nonspecific association or “stickyness” which is not taken into account by just comparing fluorescent antibody binding to the autofluorescence. To obtain a more accurate “negative signal”, the user may stain cells with isotype-matched control antibodies. In addition to the normal fluorescent antibodies, in one embodiment, (phospho) or non phosphopeptides which the antibodies should recognize will take away the antibody's epitope specific signal by blocking its antigen binding site allowing this “bound” antibody to be used for ebaluation of non-specific binding. In another embodiment, a user may block with unlabeled antibodies. This method uses the same antibody clones of interest, but uses a version that lacks the conjugated fluorophore. The goal is to use an excess of unlabeled antibody with the labeled version. In another embodiment, a user may block other high protein concentration solutions including, but not limited to fetal bovine serum, and normal serum of the species in which the antibodies were made, i.e. using normal mouse serum in a stain with mouse antibodies. (It is preferred to work with primary conjugated antibodies and not with stains requiring secondary antibodies because the secondary antibody will recognize the blocking serum). In another embodiment, a user may treat fixed cells with phosphatases to enzymatically remove phosphates, then stain.

In alternative embodiments, there are other ways of analyzing data, such as third color analysis (3D plots), which can be similar to Cytobank 2D, plus third D in color.

One embodiment of the present invention is software to examine the correlations among phosphorylation or expression levels of pairs of proteins in response to stimulus or modulation. The software examines all pairs of proteins for which phosphorylation and/or expression was measured in an experiment. The Total phosho metric (sometimes called “FoldAF”) is used to represent the phosphorylation or expression data for each protein; this data is used either on linear scale or log 2 scale.

For each protein pair under each experimental condition (unstimulated, stimulated, or treated with drug/modulator), the Pearson correlation coefficient and linear regression line fit are computed. The Pearson correlation coefficients for samples representing responding and non-responding patients are calculated separately for each group and compared to the unperturbed (unstimulated) data. The following additional metrics are derived:

1. Delta CRNR unstim: the difference between Pearson correlation coefficients for each protein pair for the responding patients and for the non-responding patients in the basal or unstimulated state.
2. Delta CRNR stim: the difference between Pearson correlation coefficients for each protein pair for the responding patients and for the non-responding patients in the stimulated or treated state.
3. DeltaDelta CRNR: the difference between Delta CRNRstim and Delta CRNRunstim.

The correlation coefficients, line fit parameters (R, p-value, and slope), and the three derived parameters described above are computed for each protein-protein pair. Protein-protein pairs are identified for closer analysis by the following criteria:

1. Large shifts in correlations within patient classes as denoted by large positive or negative values (top and bottom quartile or 10^{th} and 90^{th} percentile) of the DeltaDelta CRNR parameter.
2. Large positive or negative (top and bottom quartile or 10^{th} and 90^{th} percentile) Pearson correlation for at least one patient group in either unstimulated or stimulated/treated condition.
3. Significant line fit (p-value<=0.05 for linear regression) for at least one patient group in either unstimulated or stimulated/treated condition.

All pair data is plotted as a scatter plot with axes representing phosphorylation or expression level of a protein. Data for each sample (or patient) is plotted with color indicating whether the sample represents a responder (generally blue) or non-responder (generally red). Further line fits for responders, non-responders and all data are also represented on this graph, with significant line fits (p-value<=0.05 in linear regression) represented by solid lines and other fits represented by dashed line, enabling rapid visual identification of significant fits. Each graph is annotated with the Pearson correlation coefficient and linear regression parameters for the individual classes and for the data as a whole. The resulting plots are saved in PNG format to a single directory for browsing using Picasa. Other visualization software can also be used.

Each protein pair can be further annotated by whether the proteins comprising the pair are connected in a “canonical” pathway. In the current implementation canonical pathways are defined as the pathways curated by the NCI and Nature Publishing Group. This distinction is important; however, it is likely not an exclusive way to delineate which protein pairs to examine. High correlation among proteins in a canonical pathway in a sample may indicate the pathway in that sample is “intact” or consistent with the known literature. One embodiment of the present invention identifies protein pairs that are not part of a canonical pathway with high correlation in a sample as these may indicate the non-normal or pathological signaling. This method will be used to identify stimulator/modulator-stain-stain combinations that distinguish classes of patients.

Another method of the present invention relates to display of information using scatter plots. Scatter plots are known in the art and are used to visually convey data for visual analysis of correlations. See U.S. Pat. No. 6,520,108. The scatter plots illustrating protein pair correlations can be annotated to convey additional information, such as one, two, or more additional parameters of data visually on a scatter plot.

Previously, scatter plots used equal size plots to denote all events.

Second, additional shapes may be used to indicate subclasses of patients. For example they could be used to denote patients who responded to a second drug regimen or where CRp status. Another example is to show how samples or patients are stratified by another parameter (such as a different stim-stain-stain combination). Many other shapes, sizes, colors, outlines, or other distinguishing glyphs may be used to convey visual information in the scatter plot.

In this example the size of the dots is relative to the measured expression and the box around a dot indicates a NRCR patient that is a patient that became CR (Responsive) after more aggressive treatment but was initially NR (Non-Responsive). Patients without the box indicates a NR patient that stayed NR.

Applying the methods of the present invention, the Total Phospho metric metric for p-Akt and p-Stat1 are correlated in response to peroxide (“HOOH”) treatment. (Total phoshpho is calculated as shown in FIG. 2, metric #3). On log 2 scale the Pearson correlation coefficient for p-Akt and p-Stat1 in response to HOOH for samples from patients who responded to first treatment is 0.89 and the p-value for linear regression line fit is 0.0075. In contrast there appeared to be no correlation observed for p-Akt and p-Stat1 in HOOH treated samples from patients annotated as “NR” (non-responder) or “NRCR” (initial non-responder, who responded to later more intensive treatment). Further there are no significant correlations observed for these proteins in any patient class for untreated samples.

The Total phospho metric for p-Erk and p-CREB also appeared to be correlated in response to IL-3, IL-6, and IL-27 treatment in samples from non-responding patients (NR and NR-CR). When considering all data in log 2 scale the Pearson correlation coefficients for p-Erk and p-CREB in response to IL-3, IL-6, and IL-27 for samples from patients who did not respond to first treatment are 0.74, 0.76, 0.81, respectively, and the respective p-values for linear regression line fits are <0.0001, <0.0001, and <0.0001. In contrast there appeared to be no correlation observed for p-Erk and p-Creb in IL-3, IL-6, and IL-27 experiments for patients annotated as “CR”.

### Gating

In another embodiment, a user may analyze the signaling in subpopulations based on surface markers. For example, the user could look at: “stem cell populations” by CD34+ CD38− or CD34+ CD33− expressing cells; drug transporter positive cells; i.e. FLT3 LIGAND+ cells; or multiple leukemic subclones based on CD33, CD45, HLA-DR, CD11b and analyzing signaling in each subpopulation. In another alternative embodiment, a user may analyze the data based on intracellular markers, such as transcription factors or other intracellular proteins; based on a functional assay (i.e. dye negative “side population” aka drug transporter+cells, or fluorescent glucose uptake, or based on other fluorescent markers.

In some embodiments where flow cytometry is used, prior to analyzing of data the populations of interest and the method for characterizing these populations are determined. For instance, there are at least two general ways of identifying populations for data analysis: (i) “Outside-in” comparison of Parameter sets for individual samples or subset (e.g., patients in a trial). In this more common case, cell populations are homogenous or lineage gated in such a way as to create distinct sets considered to be homogenous for targets of interest. An example of sample-level comparison would be the identification of signaling profiles in tumor cells of a patient and correlation of these profiles with non-random distribution of clinical responses. This is considered an outside-in approach because the population of interest is pre-defined prior to the mapping and comparison of its profile to other populations. (ii) “Inside-out” comparison of Parameters at the level of individual cells in a heterogeneous population. An example of this would be the signal transduction state mapping of mixed hematopoietic cells under certain conditions and subsequent comparison of computationally identified cell clusters with lineage specific markers. This could be considered an inside-out approach to single cell studies as it does not presume the existence of specific populations prior to classification. A major drawback of this approach is that it creates populations which, at least initially, require multiple transient markers to enumerate and may never be accessible with a single cell surface epitope. As a result, the biological significance of such populations can be difficult to determine. The main advantage of this unconventional approach is the unbiased tracking of cell populations without drawing potentially arbitrary distinctions between lineages or cell types.

### Specific Applications to Characterize Biological States

Patterns and profiles of one or more activatable elements are detected using the methods known in the art including those described herein. In some embodiments, patterns and profiles of activatable elements that are components of a cellular pathway or a signaling pathway are detected using the methods described herein. For example, expression and activity patterns and profiles of one or more phosphorylated polypeptides are detected using methods known in art including those described herein.

As described above, a statistical model is generated based on node state data for a set of samples with a known biological state and used to generate an association metric for a sample (“test sample”), where the association metric classifies the test sample as being associated with a biological state. A biological state, as used herein, refers to any discrete, charcterizable state of a cell such as a phenotype, a response to an modulator, a activation of an activatable element, an increase in expression, a morphological state, a response/non-response to drug treatment, a disease or pre-disease state. Biological states may correspond to categorical variables such as disease or numerical variables such as activation of an activation element or a metric of a surrogate marker for a clinical outcome.

The classification of a test sample of one or more rare cells can comprise classifying the cell as being associated with a biological state of minimal residual disease or emerging resistance based on an association metric. See U.S. No. 61/048,886 which is incorporated by reference. The classification of a sample can comprise generating association metrics based on statistical models of patient response to a treatment, where the association metrics specify whether the patient the sample is derived from is likely to respond to treatment. In some embodiments, the models of patient response are generated from sets of samples from the group consisting of: complete response, partial response, nodular partial response, no response, progressive disease, stable disease and adverse reaction. The classification of a sample can comprise generating association metrics based on models generated from samples that have been treated according to different methods of treatment, which may include dosing and scheduling. Example of methods of treatments include, but are not limited to, chemotherapy, biological therapy, radiation therapy, bone marrow transplantation, peripheral stem cell transplantation, umbilical cord blood transplantation, autologous stem cell transplantation, allogeneic stem cell transplantation, syngeneic stem cell transplantation, surgery, induction therapy, maintenance therapy, watchful waiting, and other therapy.

In some embodiments, statistical models are generated for samples (e.g. normal cells) other than samples associated with an aberrant or abnormal biological state (e.g. cancer samples) and a combination of these and other statistical models are to generate association metrics for a test sample and classify/diagnose the test sample based on the association metrics, e.g., in assigning a risk group to the test sample, predicting an increased risk of relapse associated with the test sample, predicting an increased risk of developing secondary complications associated with the test sample, choosing a therapy for an individual associated with the test sample, predicting response to a therapy for an individual associated with the test sample, determining the efficacy of a therapy in an individual associated with the test sample, and/or determining the prognosis for an individual associated with the test sample. That is, the test sample may comprise both normal cells other than cells associated with a condition (e.g. cancer cells) and the composition of the sample is reflective of the condition process. For instance, in the case of cancer, infiltrating immune cells might determine the outcome of the disease. Alternatively, a combination of information from the cancer cell plus the immune cells in the test sample that are responding to the disease, or reacting to the disease can be used for diagnosis or prognosis of the cancer.

In some embodiments, the invention is directed to methods for classifying a cell by contacting the cell with an inhibitor, generating node state data specifying the presence or absence of an increase or decrease in activation level of an activatable element in the cell, and classifying the cell based on association metrics generated from using the node state data. For example, treating cells with a modulator might cause an increase in levels of activated elements, and co-treatment with an inhibitor compound and the modulator might result in the absence of that increase. In another example, if signaling is constitutive due to a mutation, contacting cells with an inhibitor compound might cause a decrease in activated elements compared to the baseline or modulator-treated state of these cells (i.e. in the absence of inhibitor compound). In some embodiments, the invention is directed to methods of determining whether a sample associated with a patient is associated with a biological state by subjecting a sample from the individual to a modulator and an inhibitor, determining the activation level of an activatable element in the sample, and determining the presence or absence of the biological state based on the activation level upon treatment with a modulator and an inhibitor.

In some embodiments, the invention is directed to methods of determining a phenotypic profile of a sample comprising one or more cells by exposing the cells to a plurality of modulators in separate cultures, wherein at least one of the modulators is an inhibitor, generating node state data specifying the presence or absence of an increase in activation level of an activatable element in the cells from each of the separate cultures and classifying the cells based on the presence or absence of the increase in the activation of the activatable element from each of the separate culture.

In some embodiments, expression markers or drug transporters, such as CD34, CD33, CD45, HLADR, CD11B FLT3 Ligand, c-KIT receptor, ABCG2, MDR1, BCRP, MRP1, LRP, and others noted below, can also be used for stratifying responders and non-responders. Under this hypothesis, the quantity of drug transporters correlates with the response of the patient and non-responders may have higher levels of drug transporters (to move a drug out of a cell) as compared to responders. The expression markers may be detected using many different techniques, for example using nodes from flow cytometry data (see the articles and patent applications referred to above). Other common techniques employ expression arrays (commercially available from Affymetrix, Santa Clara Calif.), taqman (commercially available from ABI, Foster City Calif.), SAGE (commercially available from Genzyme, Cambridge Mass.), sequencing techniques (see the commercial products from Helicos, 454, US Genomics, and ABI) and other commonly know assays. See Golub et al., Science 286: 531-537 (1999). Expression markers are measured in unstimulated cells to know whether they have an impact on cell cycle progression or functional apoptosis.

In some embodiments, the invention is directed to methods of classifying a sample of one or more cells by contacting the sample with at least one modulator that affects signaling mediated by receptors selected from the group comprising SDF-1α, IFN-α, IFN-γ, IL-10, IL-6, IL-27, G-CSF, FLT-3L, IGF-1, M-CSF, and SCF; also subjecting the hematopoietic cell to at least one modulator selected from the group comprising PMA, Thapsigargin, H₂O₂, etoposide, AraC, daunorubicin, staurosporine, benzyloxycarbonyl-Val-Ala-Asp (OMe) fluoromethylketone (ZVAD), lenalidomide, EPO, azacitadine, decitabine; determining the expression level in the sample of at least one protein selected from the group comprising ABCG2, C-KIT receptor, and FLT3 LIGAND receptor, generating node state data specifying the activation states of a plurality of activatable elements in the cell comprising; and classifying the cell based on said activation states and expression levels. Another embodiment of the invention further includes using the modulators IL-3, IL-4, GM-CSF, EPO, LPS, TNF-α, and CD40L.

The methods of the invention are applicable to any biological stte in an individual involving, indicated by, and/or arising from, in whole or in part, altered physiological status in a cell. The term “physiological status” includes mechanical, physical, and biochemical functions in a cell. In some embodiments, the physiological status of a cell is determined by measuring characteristics of cellular components of a cellular pathway. Cellular pathways are well known in the art. In some embodiments the cellular pathway is a signaling pathway. Signaling pathways are also well known in the art (see, e.g., Hunter T., Cell 100: 113-27, 2000; Cell Signaling Technology, Inc., 2002 Catalogue, Pathway Diagrams pgs. 232-53). See also the conditions listed in U.S. Pat. Nos. 7,381,535, 7,393,656, and 7,563,584. A condition involving or characterized by altered physiological status may be readily identified, for example, by determining the state in a cell of one or more activatable elements, as taught herein.

In some embodiments, the invention allows for identification of biological states comprising prognostically and therapeutically relevant subgroups of different biological states corresponding to disease and prediction of the clinical course of a patient. In some embodiments, the invention provides methods of classifying a sample of one or more cells according to node state data specifying activation levels of one or more activatable elements in a cell from a patient having or suspected of having a condition. In some embodiments, the classification includes generating an association metric that specifies that the sample is associated with a clinical outcome. The clinical outcome can be the prognosis and/or diagnosis of a condition, and/or staging or grading of a condition. In some embodiments, an association metric is generated based on a model of patient response to treatment and specifies a response to a treatment associated with the sample. In some embodiments, the classifying of the cell includes classification as a cell that is correlated with minimal residual disease or emerging resistance. Example biological states include malignancies and autoimmune diseases, for example.

In some embodiments, the invention provides methods, including methods to identify a biological state corresponding to the physiological status of a sample of one or more cells, e.g., by determining the activation level of an activatable element upon contact with one or more modulators. In some embodiments, the modulator is an activator. In some embodiments, the modulator is an inhibitor. In some embodiments, the invention provides methods, including methods to classify a cell according to node state data indicating the status of an activatable element in a cellular pathway. The classification may be based node state data specifying the presence or absence of an increase or decrease in the activation of the activatable element. In some embodiments, the activation level of the activatable element is determined by contacting the cell with one or more modulators to induce signaling, and then contacting the cell with binding reagents, for example monoclonal antibodies or vital dyes, each of which is specific for an activation state of an activatable element. In some embodiments, the activation levels of a plurality of activatable elements are determined by contacting a cell with a plurality of binding elements, where each binding element is specific for an activation state of an activatable element. In some embodiments, the methods of the invention provide methods for identifying a biological state corresponding phenotypic profile of a sample comprised of one or more cells by exposing the cells to a plurality of modulators (recited herein) in separate cultures, wherein at least one of the modulators is an inhibitor, generating node state data specifying the presence or absence of an increase or decrease in the in activation level of an activatable element in the cells from each of the separate cultures and generating association metrics and/or statistical models based on the node state data from each of the separate culture. In some embodiments, at least one modulator is an inhibitor. In some embodiments, the cells are classified by analyzing the response to particular modulators or combinations of modulators, and by comparison of different cell states, with or without modulators or combinations of modulators. The information can be used in prognosis and diagnosis, including susceptibility to disease(s), classification of a condition, status of a diseased state and response to changes in the environment, such as the passage of time, treatment with drugs or other modalities. The physiological status of the cells provided in a sample (e.g. clinical sample) may be classified by generating association metrics based on node state data specifying the activation of cellular pathways of interest. The sample and its cells can also be classified as to their ability to respond to therapeutic agents and treatments.

Acute Myeloid Leukemia (AML) is one example of a biological state corresponding to disease. Other disease states are shown in the patent applications incorporated above, such as U.S. Ser. Nos. 12/460,029, 12/229,476. AML constitutes a biologically and clinically heterogeneous group of hematologic malignancies affecting mostly the elderly population (about ⅔ of patients are above 60 years of age). Approximately 13,000 people in US are diagnosed each year with AML and about 60% of them will die of the disease (NCI, SEER). Unfortunately, these numbers have not substantially changed in the last three decades.

Historically, cellular morphology and cytochemistry have been used for the classification of AML (e.g. FAB AML classification) (Bennett J M, et al: Proposals for the classification of the acute leukemias. French-American-British (FAB) co-operative group. Br J Haematol 1976); however, these morphology-based classifications have provided only limited value, if any, in informing either prognosis or therapeutic decisions for the majority of the AML patients. In the last decade, thanks to the emergence of new molecular technologies our understanding of the pathophysiology of the disease has grown dramatically. This new biologic information has been recently incorporated into the current World Health Organization (WHO) classification of acute leukemias (Vardiman J W, et al: Introduction and overview of the classification of the myeloid neoplasms. In: WHO classification of tumors of haematopoietic and lymphoid tissues; Swerdlow S H, et al, WHO, Geneva, Switzerland 2008:18-30) in an attempt to better characterize individual patients and their outcomes in response to therapy.

Currently age, patient performance status, the diagnosis of “secondary” AML, cytogenetic analysis and mutational status of specific genes performed on AML samples at diagnosis are generally recognized as prognostic factors in AML (Döhner H: Implication of the molecular characterization of acute myeloid leukemia. Hematology Am Soc Hematol Educ Prog (2007):412-419). Patients who are older than 60 years at diagnosis and/or with clinical co-morbidities have a worse outcome than those diagnosed at a younger age and/or with a good performance status. Those patients with AML evolving from an antecedent hematologic disorder such as myelodysplastic syndrome (MDS) and myeloproliferative neoplasms (MPNs) and those patients who developed AML after receiving certain cytotoxic therapies (such as alkylating agents and topoisomerases II inhibitors) as treatment of a prior malignancy, (collectively referred as “secondary”-AML) have a worse outcome than those patients diagnosed with “de-novo” AML

In some embodiments, the sample of one or more cells is classified according to clinical outcome based on association metrics generated from node state data specifying the activation level of an activatable element, e.g., in a cellular pathway and a statistical model generated from node state data from a set of patients with a specific clinical outcome. In some embodiments, the clinical outcome is the prognosis and/or diagnosis of a condition. In some embodiments, the clinical outcome is the presence or absence of a neoplastic or a hematopoietic condition. In some embodiments, the clinical outcome is the staging or grading of a neoplastic or hematopoietic condition. Examples of staging include, but are not limited to, aggressive, indolent, benign, refractory, Roman Numeral staging, TNM Staging, Rai staging, Binet staging, WHO classification, FAB classification, IPSS score, WPSS score, limited stage, extensive stage, staging according to cellular markers such as ZAP70 and CD38, occult, including information that may inform on time to progression, progression free survival, overall survival, or event-free survival.

In some embodiments, methods and compositions are provided for the classification of a sample according to a biological state corresponding to the activation level of an activatable element, e.g., in a cellular pathway wherein the classification comprises classifying a cell as a cell that is correlated to a patient response to a treatment, in a cellular pathway wherein the classification comprises classifying the cell as a cell that is correlated with minimal residual disease or emerging resistance. In some embodiments, the patient response is selected from the group consisting of complete response, partial response, nodular partial response, no response, progressive disease, stable disease and adverse reaction.

In some embodiments, methods and compositions are provided for the classification of a cell according to a biological state corresponding to the activation level of an activatable element, e.g., in a cellular pathway wherein the classification comprises selecting a method of treatment. Example of methods of treatments include, but are not limited to, chemotherapy, biological therapy, radiation therapy, bone marrow transplantation, Peripheral stem cell transplantation, umbilical cord blood transplantation, autologous stem cell transplantation, allogeneic stem cell transplantation, syngeneic stem cell transplantation, surgery, induction therapy, maintenance therapy, and watchful waiting.

Generally, the methods of the invention involve generating node state data specifying the activation levels of an activatable element in a plurality of single cells in a sample.

In some embodiments, the methods of the invention are employed to generate node state data specifying the status of an activatable element in a signaling pathway. Signaling pathways and their members have been described. See (Hunter T. Cell Jan. 7, 2000; 100(1): 13-27). Exemplary signaling pathways include the following pathways and their members: The MAP kinase pathway including Ras, Raf, MEK, ERK and elk; the PI3K/Akt pathway including PI-3-kinase, PDK1, Akt and Bad; the NF-KB pathway including IKKs, IkB and the Wnt pathway including frizzled receptors, beta-catenin, APC and other co-factors and TCF (see Cell Signaling Technology, Inc. 2002 Catolog pages 231-279 and Hunter T., supra.). In some embodiments of the invention, the correlated activatable elements being assayed (or the signaling proteins being examined) are members of the MAP kinase, Akt, NFkB, WNT, RAS/RAF/MEK/ERK, JNK/SAPK, p38 MAPK, Src Family Kinases, JAK/STAT and/or PKC signaling pathways.

In some embodiments, the methods of the invention are employed to generate node state data specifying the status of a signaling protein in a signaling pathway known in the art including those described herein. Exemplary types of signaling proteins within the scope of the present invention include, but are not limited to kinases, kinase substrates (i.e. phosphorylated substrates), phosphatases, phosphatase substrates, binding proteins (such as 14-3-3), receptor ligands and receptors (cell surface receptor tyrosine kinases and nuclear receptors)). Kinases and protein binding domains, for example, have been well described (see, e.g., Cell Signaling Technology, Inc., 2002 Catalogue “The Human Protein Kinases” and “Protein Interaction Domains” pgs. 254-279).

Nuclear Factor-kappaB (NE-κB) Pathway:

Nuclear factor-kappaB (NF-kappaB) transcription factors and the signaling pathways that activate them are central coordinators of innate and adaptive immune responses. More recently, it has become clear that NF-kappaB signaling also has a critical role in cancer development and progression. NF-kappaB provides a mechanistic link between inflammation and cancer, and is a major factor controlling the ability of both pre-neoplastic and malignant cells to resist apoptosis-based tumor-surveillance mechanisms. In mammalian cells, there are five NF-KB family members, RelA (p65), RelB, c-Rel, p50/p105 (NF-κB1) and p52/p100 (NF-κB2) and different NF-KB complexes are formed from their homo and heterodimers. In most cell types, NF-κB complexes are retained in the cytoplasm by a family of inhibitory proteins known as inhibitors of NF-κB (IκBs). Activation of NF-κB typically involves the phosphorylation of IκB by the IκB kinase (IKK) complex, which results in IκB ubiquitination with subsequent degradation. This releases NF-κB and allows it to translocate freely to the nucleus. The genes regulated by NF-κB include those controlling programmed cell death, cell adhesion, proliferation, the innate- and adaptive-immune responses, inflammation, the cellular-stress response and tissue remodeling. However, the expression of these genes is tightly coordinated with the activity of many other signaling and transcription-factor pathways. Therefore, the outcome of NF-κB activation depends on the nature and the cellular context of its induction. For example, it has become apparent that NF-KB activity can be regulated by both oncogenes and tumor suppressors, resulting in either stimulation or inhibition of apoptosis and proliferation. See Perkins, N. Integrating cell-signaling pathways with NF-κB and IKK function. Reviews: Molecular Cell Biology. January, 2007; 8(1): 49-62, hereby fully incorporated by reference in its entirety for all purposes. Hayden, M. Signaling to NF-κB. Genes & Development. 2004; 18: 2195-2224, hereby fully incorporated by reference in its entirety for all purposes. Perkins, N. Good Cop, Bad Cop: The Different Faces of NF-κB. Cell Death and Differentiation. 2006; 13: 759-772, hereby fully incorporated by reference in its entirety for all purposes.

Phosphatidvlinositol 3-kinase (PI3-K)/AKT Pathway:

PI3-Ks are activated by a wide range of cell surface receptors to generate the lipid second messengers phosphatidylinositol 3,4-biphosphate (PIP₂) and phosphatidylinositol 3,4,5-trisphosphate (PIP₃). Examples of receptor tyrosine kinases include but are not limited to FLT3 LIGAND, EGFR, IGF-1R, HER2/neu, VEGFR, and PDGFR. The lipid second messengers generated by PI3Ks regulate a diverse array of cellular functions. The specific binding of PI3,4P₂ and PI3,4,5P₃ to target proteins is mediated through the pleckstrin homology (PH) domain present in these target proteins. One key downstream effector of PI3-K is Akt, a serine/threonine kinase, which is activated when its PH domain interacts with PI3, 4P₂ and PI3,4,5P₃ resulting in recruitment of Akt to the plasma membrane. Once there, in order to be fully activated, Akt is phosphorylated at threonine 308 by 3-phosphoinositide-dependent protein kinase-1 (PDK-1) and at serine 473 by several PDK2 kinases. Akt then acts downstream of PI3K to regulate the phosphorylation of a number of substrates, including but not limited to forkhead box O transcription factors, Bad, GSK-3P, I-κB, mTOR, MDM-2, and S6 ribosomal subunit. These phosphorylation events in turn mediate cell survival, cell proliferation, membrane trafficking, glucose homeostasis, metabolism and cell motility. Deregulation of the PI3K pathway occurs by activating mutations in growth factor receptors, activating mutations in a PI3-K gene (e.g. PIK3CA), loss of function mutations in a lipid phosphatase (e.g. PTEN), up-regulation of Akt, or the impairment of the tuberous sclerosis complex (TSC1/2). All these events are linked to increased survival and proliferation. See Vivanco, I. The Phosphatidylinositol 3-Kinase-AKT Pathway in Human Cancer. Nature Reviews: Cancer. July, 2002; 2: 489-501 and Shaw, R. Ras, PI(3)K and mTOR signaling controls tumor cell growth. Nature. May, 2006; 441: 424-430, Marone et al., Biochimica et Biophysica Acta, 2008; 1784, p159-185 hereby fully incorporated by reference in their entirety for all purposes.

Wnt Pathway:

The Wnt signaling pathway describes a complex network of proteins well known for their roles in embryogenesis, normal physiological processes in adult animals, such as tissue homeostasis, and cancer. Further, a role for the Wnt pathway has been shown in self-renewal of hematopoietic stem cells (Reya T et al., Nature. 2003 May 22; 423(6938):409-14). Cytoplasmic levels of β-catenin are normally kept low through the continuous proteosomal degradation of β-catenin controlled by a complex of glycogen synthase kinase 3β (GSK-3 β), axin, and adenomatous polyposis coli (APC). When Wnt proteins bind to a receptor complex composed of the Frizzled receptors (Fz) and low density lipoprotein receptor-related protein (LRP) at the cell surface, the GSK-3/axin/APC complex is inhibited. Key intermediates in this process include disheveled (Dsh) and axin binding the cytoplasmic tail of LRP. Upon Wnt signaling and inhibition of the β-catenin degradation pathway, β-catenin accumulates in the cytoplasm and nucleus. Nuclear β-catenin interacts with transcription factors such as lymphoid enhanced-binding factor 1 (LEF) and T cell-specific transcription factor (TCF) to affect transcription of target genes. See Gordon, M. Wnt Signaling: Multiple Pathways, Multiple Receptors, and Multiple Transcription Factors. J of Biological Chemistry. June, 2006; 281(32): 22429-22433, Logan C Y, Nusse R: The Wnt signaling pathway in development and disease. Annu Rev Cell Dev Biol 2004, 20:781-810, Clevers H: Wnt/beta-catenin signaling in development and disease. Cell 2006, 127:469-480. hereby fully incorporated by reference in its entirety for all purposes.

Protein Kinase C (PKC) Signaling:

The PKC family of serine/threonine kinases mediate signaling pathways following activation of receptor tyrosine kinases, G-protein coupled receptors and cytoplasmic tyrosine kinases. Activation of PKC family members is associated with cell proliferation, differentiation, survival, immune function, invasion, migration and angiogenesis. Disruption of PKC signaling has been implicated in tumorigenesis and drug resistance. PKC isoforms have distinct and overlapping roles in cellular functions. PKC was originally identified as a phospholipid and calcium-dependent protein kinase. The mammalian PKC superfamily consists of 13 different isoforms that are divided into four subgroups on the basis of their structural differences and related cofactor requirements cPKC (classical PKC) isoforms (α, βI, βII and γ), which respond both to Ca2+ and DAG (diacylglycerol), nPKC (novel PKC) isoforms (δ, ε, θ and η), which are insensitive to Ca2+, but dependent on DAG, atypical PKCs (aPKCs, τ/λ, ξ), which are responsive to neither co-factor, but may be activated by other lipids and through protein-protein interactions, and the related PKN (protein kinase N) family (e.g. PKN1, PKN2 and PKN3), members of which are subject to regulation by small GTPases. Consistent with their different biological functions, PKC isoforms differ in their structure, tissue distribution, subcellular localization, mode of activation and substrate specificity. Before maximal activation of its kinase, PKC requires a priming phosphorylation which is provided constitutively by phosphoinositide-dependent kinase 1 (PDK-1). The phospholipid DAG has a central role in the activation of PKC by causing an increase in the affinity of classical PKCs for cell membranes accompanied by PKC activation and the release of an inhibitory substrate (a pseudo-substrate) to which the inactive enzyme binds. Activated PKC then phosphorylates and activates a range of kinases. The downstream events following PKC activation are poorly understood, although the MEK-ERK (mitogen activated protein kinase kinase-extracellular signal-regulated kinase) pathway is thought to have an important role. There is also evidence to support the involvement of PKC in the PI3K-Akt pathway. PKC isoforms probably form part of the multi-protein complexes that facilitate cellular signal transduction. Many reports describe dysregulation of several family members. For example alterations in PKCε have been detected in thyroid cancer, and have been correlated with aggressive, metastatic breast cancer and PKCτ was shown to be associated with poor outcome in ovarian cancer. (Knauf J A, et al. Isozyme-Specific Abnormalities of PKC in Thyroid Cancer: Evidence for Post-Transcriptional Changes in PKC Epsilon. The Journal of Clinical Endocrinology & Metabolism. Vol. 87, No. 5, pp 2150-2159; Zhang L et al. Integrative Genomic Analysis of Protein Kinase C (PKC) Family Identifies PKC{iota} as a Activatable element and Potential Oncogene in Ovarian Carcinoma. Cancer Res. 2006, Vol 66, No. 9, pp 4627-4635)

Mitogen Activated Protein (MAP) Kinase Pathways:

MAP kinases transduce signals that are involved in a multitude of cellular pathways and functions in response to a variety of ligands and cell stimuli. (Lawrence et al., Cell Research (2008) 18: 436-442). Signaling by MAPKs affects specific events such as the activity or localization of individual proteins, transcription of genes, and increased cell cycle entry, and promotes changes that orchestrate complex processes such as embryogenesis and differentiation. Aberrant or inappropriate functions of MAPKs have now been identified in diseases ranging from cancer to inflammatory disease to obesity and diabetes. MAPKs are activated by protein kinase cascades consisting of three or more protein kinases in series: MAPK kinase kinases (MAP3Ks) activate MAPK kinases (MAP2Ks) by dual phosphorylation on S/T residues; MAP2Ks then activate MAPKs by dual phosphorylation on Y and T residues MAPKs then phosphorylate target substrates on select S/T residues typically followed by a proline residue. In the ERK1/2 cascade the MAP3K is usually a member of the Raf family. Many diverse MAP3Ks reside upstream of the p38 and the c-Jun N-terminal kinase/stress-activated protein kinase (JNK/SAPK) MAPK groups, which have generally been associated with responses to cellular stress. Downstream of the activating stimuli, the kinase cascades may themselves be stimulated by combinations of small G proteins, MAP4Ks, scaffolds, or oligomerization of the MAP3K in a pathway. In the ERK1/2 pathway, Ras family members usually bind to Raf proteins leading to their activation as well as to the subsequent activation of other downstream members of the pathway.

Ras/RAF/MEK/ERK Pathway:

Classic activation of the RAS/Raf/MAPK cascade occurs following ligand binding to a receptor tyrosine kinase at the cell surface, but a vast array of other receptors have the ability to activate the cascade as well, such as integrins, serpentine receptors, heterotrimeric G-proteins, and cytokine receptors. Although conceptually linear, considerable cross talk occurs between the Ras/Raf/MAPK/Erk kinase (MEK)/Erk MAPK pathway and other MAPK pathways as well as many other signaling cascades. The pivotal role of the Ras/Raf/MEK/Erk MAPK pathway in multiple cellular functions underlies the importance of the cascade in oncogenesis and growth of transformed cells. As such, the MAPK pathway has been a focus of intense investigation for therapeutic targeting. Many receptor tyrosine kinases are capable of initiating MAPK signaling. They do so after activating phosphorylation events within their cytoplasmic domains provide docking sites for src-homology 2 (SH2) domain-containing signaling molecules. Of these, adaptor proteins such as Grb2 recruit guanine nucleotide exchange factors such as SOS-1 or CDC25 to the cell membrane. The guanine nucleotide exchange factor is now capable of interacting with Ras proteins at the cell membrane to promote a conformational change and the exchange of GDP for GTP bound to Ras. Multiple Ras isoforms have been described, including K-Ras, N-Ras, and H-Ras. Termination of Ras activation occurs upon hydrolysis of RasGTP to RasGDP. Ras proteins have intrinsically low GTPase activity. Thus, the GTPase activity is stimulated by GTPase-activating proteins such as NF-1 GTPase-activating protein/neurofibromin and p120 GTPase activating protein thereby preventing prolonged Ras stimulated signaling. Ras activation is the first step in activation of the MAPK cascade. Following Ras activation, Raf (A-Raf, B-Raf, or Raf-1) is recruited to the cell membrane through binding to Ras and activated in a complex process involving phosphorylation and multiple cofactors that is not completely understood. Raf proteins directly activate MEK1 and MEK2 via phosphorylation of multiple serine residues. MEK1 and MEK2 are themselves tyrosine and threonine/serine dual-specificity kinases that subsequently phosphorylate threonine and tyrosine residues in Erk1 and Erk2 resulting in activation. Although MEK1/2 have no known targets besides Erk proteins, Erk has multiple targets including Elk-1, c-Ets1, c-Ets2, p90RSK1, MNK1, MNK2, and TOB. The cellular functions of Erk are diverse and include regulation of cell proliferation, survival, mitosis, and migration. McCubrey, J. Roles of the Raf/MEK/ERK pathway in cell growth, malignant transformation and drug resistance. Biochimica et Biophysica Acta. 2007; 1773: 1263-1284, hereby fully incorporated by reference in its entirety for all purposes, Friday and Adjei, Clinical Cancer Research (2008) 14, p342-346.

c-Jun N-Terminal Kinase (JNK)/Stress-Activated Protein Kinase (SAPK) Pathway:

The c-Jun N-terminal kinases (JNKs) were initially described as a family of serine/threonine protein kinases, activated by a range of stress stimuli and able to phosphorylate the N-terminal transactivation domain of the c-Jun transcription factor. This phosphorylation enhances c-Jun dependent transcriptional events in mammalian cells. Further research has revealed three JNK genes (JNK1, JNK2 and JNK3) and their splice-forms as well as the range of external stimuli that lead to JNK activation. JNK1 and JNK2 are ubiquitous, whereas JNK3 is relatively restricted to brain. The predominant MAP2Ks upstream of JNK are MEK4 (MKK4) and MEK7 (MKK7). MAP3Ks with the capacity to activate JNK/SAPKs include MEKKs (MEKK1, -2, -3 and -4), mixed lineage kinases (MLKs, including MLK1-3 and DLK), Tp12, ASKs, TAOs and TAK1. Knockout studies in several organisms indicate that different MAP3Ks predominate in JNK/SAPK activation in response to different upstream stimuli. The wiring may be comparable to, but perhaps even more complex than, MAP3K selection and control of the ERK1/2 pathway. JNK/SAPKs are activated in response to inflammatory cytokines; environmental stresses, such as heat shock, ionizing radiation, oxidant stress and DNA damage; DNA and protein synthesis inhibition; and growth factors. JNKs phosphorylate transcription factors c-Jun, ATF-2, p53, Elk-1, and nuclear factor of activated T cells (NFAT), which in turn regulate the expression of specific sets of genes to mediate cell proliferation, differentiation or apoptosis. JNK proteins are involved in cytokine production, the inflammatory response, stress-induced and developmentally programmed apoptosis, actin reorganization, cell transformation and metabolism. Raman, M. Differential regulation and properties of MAPKs. Oncogene. 2007; 26: 3100-3112, hereby fully incorporated by reference in its entirety for all purposes.

p38 MAPK Pathway:

Several independent groups identified the p38 Map kinases, and four p38 family members have been described (α, β, γ, δ). Although the p38 isoforms share about 40% sequence identity with other MAPKs, they share only about 60% identity among themselves, suggesting highly diverse functions. p38 MAPKs respond to a wide range of extracellular cues particularly cellular stressors such as UV radiation, osmotic shock, hypoxia, pro-inflammatory cytokines and less often growth factors. Responding to osmotic shock might be viewed as one of the oldest functions of this pathway, because yeast p38 activates both short and long-term homeostatic mechanisms to osmotic stress. p38 is activated via dual phosphorylation on the TGY motif within its activation loop by its upstream protein kinases MEK3 and MEK6. MEK3/6 are activated by numerous MAP3Ks including MEKK1-4, TAOs, TAK and ASK. p38 MAPK is generally considered to be the most promising MAPK therapeutic target for rheumatoid arthritis as p38 MAPK isoforms have been implicated in the regulation of many of the processes, such as migration and accumulation of leucocytes, production of cytokines and pro-inflammatory mediators and angiogenesis, that promote disease pathogenesis. Further, the p38 MAPK pathway plays a role in cancer, heart and neurodegenerative diseases and may serve as promising therapeutic target. Cuenda, A. p38 MAP-Kinases pathway regulation, function, and role in human diseases. Biochimica et Biophysica Acta. 2007; 1773: 1358-1375; Thalhamer et al., Rheumatology 2008; 47:409-414; Roux, P. ERK and p38 MAPK-Activated Protein Kinases: a Family of Protein Kinases with Diverse Biological Functions. Microbiology and Molecular Biology Reviews. June, 2004; 320-344 hereby fully incorporated by reference in its entirety for all purposes.

Src Family Kinases:

Src is the most widely studied member of the largest family of nonreceptor protein tyrosine kinases, known as the Src family kinases (SFKs). Other SFK members include Lyn, Fyn, Lck, Hck, Fgr, Blk, Yrk, and Yes. The Src kinases can be grouped into two sub-categories, those that are ubiquitously expressed (Src, Fyn, and Yes), and those which are found primarily in hematopoietic cells (Lyn, Lck, Hck, Blk, Fgr). (Benati, D. Src Family Kinases as Potential Therapeutic Targets for Malignancies and Immunological Disorders. Current Medicinal Chemistry. 2008; 15: 1154-1165) SFKs are key messengers in many cellular pathways, including those involved in regulating proliferation, differentiation, survival, motility, and angiogenesis. The activity of SFKs is highly regulated intramolecularly by interactions between the SH2 and SH3 domains and intermolecularly by association with cytoplasmic molecules. This latter activation may be mediated by focal adhesion kinase (FAK) or its molecular partner Crk-associated substrate (CAS), which play a prominent role in integrin signaling, and by ligand activation of cell surface receptors, e.g. epidermal growth factor receptor (EGFR). These interactions disrupt intramolecular interactions within Src, leading to an open conformation that enables the protein to interact with potential substrates and downstream signaling molecules. Src can also be activated by dephosphorylation of tyrosine residue Y530. Maximal Src activation requires the autophosphorylation of tyrosine residue Y419 (in the human protein) present within the catalytic domain. Elevated Src activity may be caused by increased transcription or by deregulation due to overexpression of upstream growth factor receptors such as EGFR, HER2, platelet-derived growth factor receptor (PDGFR), fibroblast growth factor receptor (FGFR), vascular endothelial growth factor receptor, ephrins, integrin, or FAK. Alternatively, some human tumors show reduced expression of the negative Src regulator, Csk. Increased levels, increased activity, and genetic abnormalities of Src kinases have been implicated in both solid tumor development and leukemias. Ingley, E. Src family kinases: Regulation of their activities, levels and identification of new pathways. Biochimica et Biophysica Acta. 2008; 1784 56-65, hereby fully incorporated by reference in its entirety for all purposes. Benati and Baldari., Curr Med Chem. 2008; 15(12):1154-65, Finn (2008) Ann Oncol. May 16, hereby fully incorporated by reference in its entirety for all purposes.

Janus Kinase (JAK)/Signal Transducers and Activators of Transcription (STAT) Pathway:

The JAK/STAT pathway plays a crucial role in mediating the signals from a diverse spectrum of cytokine receptors, growth factor receptors, and G-protein-coupled receptors. Signal transducers and activators of transcription (STAT) proteins play a crucial role in mediating the signals from a diverse spectrum of cytokine receptors growth factor receptors, and G-protein-coupled receptors. STAT directly links cytokine receptor stimulation to gene transcription by acting as both a cytosolic messenger and nuclear transcription factor. In the Janus Kinase (JAK)-STAT pathway, receptor dimerization by ligand binding results in JAK family kinase (JFK) activation and subsequent tyrosine phosphorylation of the receptor, which leads to the recruitment of STAT through the SH2 domain, and the phosphorylation of conserved tyrosine residue. Tyrosine phosphorylated STAT forms a dimer, translocates to the nucleus, and binds to specific DNA elements to activate target gene transcription, which leads to the regulation of cellular proliferation, differentiation, and apoptosis. The entire process is tightly regulated at multiple levels by protein tyrosine phosphatases, suppressors of cytokine signaling and protein inhibitors of activated STAT. In mammals seven members of the STAT family (STAT1, STAT2, STAT3, STAT4, STAT5a, STAT5b and STAT6) have been identified. JAKs contain two symmetrical kinase-like domains; the C-terminal JAK homology 1 (JH1) domain possesses tyrosine kinase function while the immediately adjacent JH2 domain is enzymatically inert but is believed to regulate the activity of JH1. There are four JAK family members: JAK1, JAK2, JAK3 and tyrosine kinase 2 (Tyk2). Expression is ubiquitous for JAK1, JAK2 and TYK2 but restricted to hematopoietic cells for JAK3. Mutations in JAK proteins have been described for several myeloid malignancies. Specific examples include but are not limited to: Somatic JAK3 (e.g. JAK3A572V, JAK3V722I, JAK3P132T) and fusion JAK2 (e.g. ETV6-JAK2, PCM1-JAK2, BCR-JAK2) mutations have respectively been described in acute megakaryocytic leukemia and acute leukemia/chronic myeloid malignancies, JAK2 (V617F, JAK2 exon 12 mutations) and MPL MPLW515L/K/S, MPLS505N) mutations associated with myeloproliferative neoplasms and myeloproliferative neoplasms. JAK2 mutations, primarily JAK2V617F, are invariably associated with polycythemia vera (PV). This mutation also occurs in the majority of patients with essential thrombocythemia (ET) or primary myelofibrosis (PMF) (Tefferi n., Leukemia & Lymphoma, March 2008; 49(3): 388-397). STATs can be activated in a JAK-independent manner by src family kinase members and by oncogenic FLt3 ligand-ITD (Hayakawa and Naoe, Ann NY Acad Sci. 2006 November; 1086:213-22; Choudhary et al. Activation mechanisms of STAT5 by oncogenic FLt3 ligand-ITD. Blood (2007) vol. 110 (1) pp. 370-4). Although mutations of STATs have not been described in human tumors, the activity of several members of the family, such as STAT1, STAT3 and STAT5, is dysregulated in a variety of human tumors and leukemias. STAT3 and STAT5 acquire oncogenic potential through constitutive phosphorylation on tyrosine, and their activity has been shown to be required to sustain a transformed phenotype. This was shown in lung cancer where tyrosine phosphorylation of STAT3 was JAK-independent and mediated by EGF receptor activated through mutation and Src. (Alvarez et al., Cancer Research, Cancer Res 2006; 66) STAT5 phosphorylation was also shown to be required for the long-term maintenance of leukemic stem cells. (Schepers et al. STAT5 is required for long-term maintenance of normal and leukemic human stem/progenitor cells. Blood (2007) vol. 110 (8) pp. 2880-2888) In contrast to STAT3 and STAT5, STAT1 negatively regulates cell proliferation and angiogenesis and thereby inhibits tumor formation. Consistent with its tumor suppressive properties, STAT1 and its downstream targets have been shown to be reduced in a variety of human tumors (Rawlings, J. The JAK/STAT signaling pathway. J of Cell Science. 2004; 117 (8):1281-1283, hereby fully incorporated by reference in its entirety for all purposes).

A key issue in the treatment of many cancers is the development of resistance to chemotherapeutic drugs. Of the many resistance mechanisms, two classes of transporters play a major role. The human ATP-binding cassette (ABC) superfamily of proteins consists of 49 membrane proteins that transport a diverse array of substrates, including sugars, amino acids, bile salts lipids, sterols, nucleotides, endogenous metabolites, ions, antibiotics drugs and toxins out of cells using the energy of hydrolysis of ATP. ATP-binding-cassette (ABC) transporters are evolutionary extremely well-conserved transmembrane proteins that are highly expressed in hematopoietic stem cells (HSCs). The physiological function in human stem cells is believed to be protection against genetic damage caused by both environmental and naturally occurring xenobiotics. Additionally, ABC transporters have been implicated in the maintenance of quiescence and cell fate decisions of stem cells. These physiological roles suggest a potential role in the pathogenesis and biology of stem cell-derived hematological malignancies such as acute and chronic myeloid leukemia (Raaijmakers, Leukemia (2007) 21, 2094-2102, Zhou et al., Nature Medicine (2001), 7, p 1028-1034

Several ABC proteins are multidrug efflux pumps that not only protect the body from exogenous toxins, but also play a role in uptake and distribution of therapeutic drugs. Expression of these proteins in target tissues causes resistance to treatment with multiple drugs. (Gillet et al., Biochimica et Biophysica Acta (2007) 1775, p 237, Sharom (2008) Pharmacogenomics 9 p 105). A more detailed discussion of the ABC family members with critical roles in resistance and poor outcome to treatment is discussed below

The second class of plasma membrane transporter proteins that play a role in the uptake of nucleoside-derived drugs are the Concentrative and Equilibrative Nucleoside Transporters (CNT and ENT, respectively), encoded by gene families SLC28 and SLC29 (Pastor-Anglada (2007) J. Physiol. Biochem 63, p 97). They mediate the uptake of natural nucleosides and a variety of nucleoside-derived drugs, mostly used in anti-cancer therapy. In vitro studies, have shown that one mechanism of nucleoside resistance can be mediated through mutations in the gene for ENT1/SLC29A1 resulting in lack of detectable protein (Cai et al., Cancer Research (2008) 68, p2349). Studies have also described in vivo mechanisms of resistance to nucleoside analogues involving low or non-detectable levels of ENT1 in Acute Myeloid Leukemia (AML), Mantle Cell lymphoma and other leukemias (Marce et al., Malignant Lymphomas (2006), 91, p 895).

Of the ABC transporter family, three family members account for most of the multiple drug resistance (MDR) in humans; P-gycoprotein (Pgp/MDR1/ABCB1), MDR-associated protein (MRP1, ABCC1) and breast cancer resistance protein (BCRP, ABCG2 or MXR). Pgp/MDR1 and ABCG2 can export both unmodified drugs and drug conjugates, whereas MRP1 exports glutathione and other drug conjugates as well as unconjugated drugs together with free glutathione. All three ABC transporters demonstrate export activity for a broad range of structurally unrelated drugs and display both distinct and overlapping specificities. For example, MRP1 promotes efflux of drug-glutathione conjugates, vinca alkaloids, camptothecin, but not taxol. Examples of drugs exported by ABCG2 include mitoxantrone, etoposide, daunorubicin as well as the tyrosine kinase inhibitors Gleevec and Iressa. In treatment regimens for leukemias, one of the main obstacles to achieving remission is intrinsic and acquired resistance to chemotherapy mediated by the ABC drug transporters. Several reports have described correlations between transporter expression levels as well as their function, evaluated through the use of fluorescent dyes, with resistance of patients to chemotherapy regimens.

Experimentally, it is possible to correlate expression of transporter proteins with their function by the use of inhibitors including but not limited to cyclosporine (measures Pgp function), probenecid (measures MRP1 function), fumitremorgin C, and a derivative Ko143, reserpine (measures ABCG2 function). Although these molecules inhibit a variety of transporters, they do permit some correlations to be made between protein expression and function (Legrand et al., (Blood (1998) 91, p 4480), Legrand et al., (Blood (1999) 94, p 1046, Zhou et al., Nature Medicine, 2001, 7, p 1028-1034, Sarkardi et al., Physiol Rev 2006 86: 1179-1236).

Extending the use of these inhibitors, they can be used to makes statistical associations within subpopulations of cells gated both for phenotypic markers denoting stages of development along hematopoietic and lymphoid lineages, as well as reagents that recognize the transporter proteins themselves. Thus it will be possible to simultaneously measure protein expression and function

The response to DNA damage is a protective measure taken by cells to prevent or delay genetic instability and tumorigenesis. It allows cells to undergo cell cycle arrest and gives them an opportunity to either: repair the broken DNA and resume passage through the cell cycle or, if the breakage is irreparable, trigger senescence or an apoptotic program leading to cell death (Wade Harper et al., Molecular Cell, (2007) 28 p 739-745, Bartek J et al., Oncogene (2007) 26 p 7773-9).

Several protein complexes are positioned at strategic points within the DNA damage response pathway and act as sensors, transducers or effectors of DNA damage. Depending on the nature of DNA damage for example; double stranded breaks, single strand breaks, single base alterations due to alkylation, oxidation etc, there is an assembly of specific DNA damage sensor protein complexes in which activated ataxia telangiectasia mutated (ATM) and ATM- and Rad3 related (ATR) kinases phosphorylate and subsequently activate the checkpoint kinases Chk1 and Chk2. Both of these DNA-signal transducer kinases amplify the damage response by phosphorylating a multitude of substrates. Both checkpoint kinases have overlapping and distinct roles in orchestrating the cell's response to DNA damage.

Maximal kinase activation of Chk2 involves phosphorylation and homo-dimerization with ATM-mediated phosphorylation of T68 on Chk2 as a preliminary event. This in turn activates the DNA repair. As mentioned above, in order for DNA repair to proceed, there must be a delay in the cell cycle Chk2 seems to have a role at the G1/S and G2/M junctures and may have overlapping functions with Chk1. There are multiple ways in which Chk1 and Chk2 mediate cell cycle suspension. In one mechanism Chk2 phosphorylates the CDC25A and CDC25C phosphatases resulting in their removal from the nucleus either by proteosomal degradation or by sequestration in the cytoplasm by 14-3-3. These phosphatases are no longer able to act on their nuclear CDK substrates. If DNA repair is successful cell cycle progression is resumed (Antoni et al., Nature reviews cancer (2007) 7, p 925-936).

When DNA repair is no longer possible the cell undergoes apoptosis with participation from Chk2 in p53 independent and dependent pathways. Chk2 substrates that operate in a p53-independent manner include the E2F1 transcription factor, the tumor suppressor promyelocytic leukemia (PML) and the polo-like kinases 1 and 3 (PLK1 and PLK3). E2F1 drives the expression of a number of apoptotic genes including caspases 3, 7, 8 and 9 as well as the pro-apoptotic Bcl-2 related proteins (Bim, Noxa, PUMA).

In its response to DNA damage, the p53 activates the transcription of a program of genes that regulate DNA repair, cell cycle arrest, senescence and apoptosis. The overall functions of p53 are to preserve fidelity in DNA replication such that when cell division occurs tumorigenic potential can be avoided. In such a role, p53 is described as “The Guardian of the Genome (Riley et al., Nature Reviews Molecular Cell Biology (2008) 9 p 402-412). The diverse alarm signals that impinge on p53 result in a rapid increase in its levels through a variety of post translational modifications. Worthy of mention is the phosphorylation of amino acid residues within the amino terminal portion of p53 such that p53 is no longer under the regulation of Mdm2. The responsible kinases are ATM, Chk1 and Chk2. The subsequent stabilization of p53 permits it to transcriptionally regulate multiple pro-apoptotic members of the Bcl-2 family, including Bax, Bid, Puma, and Noxa (Discussion below).

The series of events that are mediated by p53 to promote apoptosis including DNA damage, anoxia and imbalances in growth-promoting signals are sometimes termed the ‘intrinsic apoptotic” program since the signals triggering it originate within the cell. An alternate route of activating the apoptotic pathway can occur from the outside of the cell mediated by the binding of ligands to transmembrane death receptors. This extrinsic or receptor mediated apoptotic program acting through their receptor death domains eventually converges on the intrinsic, mitochondrial apoptotic pathway as discussed below (Sprick et al., Biochim Biophys Acta. (2004) 1644 p 125-32).

Key regulators of apoptosis are proteins of the Bcl-2 family. The founding member, the Bcl-2 proto-oncogene was first identified at the chromosomal breakpoint of t(14:18) bearing human follicular B cell lymphoma. Unexpectedly, expression of Bcl-2 was proved to block rather than promote cell death following multiple pathological and physiological stimuli (Danial and Korsemeyer, Cell (2204) 116, p 205-219). The Bcl-2 family has at least 20 members which are key regulators of apoptosis, functioning to control mitochondrial permeability as well as the release of proteins important in the apoptotic program. The ratio of anti- to pro-apoptotic molecules such as Bcl-2/Bax constitutes a rheostat that sets the threshold of susceptibility to apoptosis for the intrinsic pathway, which utilizes organelles such as the mitochondrion to amplify death signals. The family can be divided into 3 subclasses based on structure and impact on apoptosis. Family members of subclass 1 including Bcl-2, Bcl-X_{L} and Mcl-1 are characterized by the presence of 4 Bcl-2 homology domains (BH1, BH2, BH3 and BH4) and are anti-apoptotic. The structure of the second subclass members is marked for containing 3 BH domains and family members such as Bax and Bak possess pro-apoptotic activities. The third subclass, termed the BH3-only proteins include Noxa, Puma, Bid, Bad and Bim. They function to promote apoptosis either by activating the pro-apoptotic members of group 2 or by inhibiting the anti-apoptotic members of subclass 1 (Er et al., Biochimica et Biophysica Act (2006) 1757, p 1301-1311, Fernandez-Luna Cellular Signaling (2008) Advance Publication Online).

The role of mitochondria in the apoptotic process was clarified as involving an apoptotic stimulus resulting in depolarization of the outer mitochondrial membrane leading to a leak of cytochrome C into the cytoplasm. Association of cytochrome C molecules with adaptor apoptotic protease activating factor (APAF) forms a structure called the apoptosome which can activate enzymatically latent procaspase 9 into a cleaved activated form. Caspase 9 is one member of a family of cysteine aspartyl-specific proteases; genes encoding 11 of these proteases have been mapped in the human genome. Activated caspase 9, classified as an intiator caspase, then cleaves procaspase 3 which cleaves more downstream procaspases, classified as executioner caspases, resulting in an amplification cascade that promotes cleavage of death substrates including poly(ADP-ribose) polymerase 1 (PARP). The cleavage of PARP produces 2 fragments both of which have a role in apoptosis (Soldani and Scovassi Apoptosis (2002) 7, p 321). A further level of apoptotic regulation is provided by smac/Diablo, a mitochondrial protein that inactivates a group of anti-apoptotic proteins termed inhibitors of apoptosis (IAPs) (Huang et al., Cancer Cell (2004) 5 p 1-2). IAPB operate to block caspase activity in 2 ways; they bind directly to and inhibit caspase activity and in certain cases they can mark caspases for ubiquitination and degradation.

The balance of pro- and anti-apoptotic proteins is tightly regulated under normal physiological conditions. Tipping of this balance either way results in disease. An oncogenic outcome results from the inability of tumor cells to undergo apoptosis and this can be caused by over-expression of anti-apoptotic proteins or reduced expression or activity of pro-apoptotic protein

Interrogation of the apoptotic machinery will also be performed with a combination of Cytarabine and Daunorubicin at clinically relevant concentrations based on peak plasma drug levels. The standard dose of Cytarabine, 100 mg/m2, yields a peak plasma concentration of approximately 40 nM, whereas high dose Cytarabine, 3 g/m2, yields a peak plasma concentration of 2 uM. Daunorubicin at 25 mg/m2 yields a peak plasma concentration of 50 ng/ml and at 50 mg/m2 yields a peak plasma concentration of 200 ng/ml. Our in vitro apoptosis assay will use concentrations of Cytarabine up to 2 uM, and concentrations of Daunorubicin up to 200 ng/ml.

### Specific Embodiments

Payers use the terminology “payback” or “return on investment (ROI)” as criteria for assessing the economic impact of adopting a new technology. ROI means not only the point at which breakeven occurs, if at all, but also the short-, intermediate- and long-term financial consequences on operational budgets and overall disease treatment costs and revenues. Medical specialists desire both improvement in clinical outcomes but also minimal difficulties in securing reimbursement from private and public third-parties. Patients want to live longer, but also face substantial copayments and coinsurance rates (20% on Medicare “Part B” for outpatient drugs that are, by definition, unsafe for patient self-administration) and wish to know the value for money in addition to clinical risks and benefits. In some embodiments, the methods of the invention can be used at the individual patient level to provide more detailed and valid information than can be derived from gross categorizations of patients into treatable and untreatable subgroups. In some embodiments, the methods of the invention may select targeted therapies for individual patients, such as chemotherapeutic combinations, resulting in improved patient outcomes.

In some embodiments, the third party may be a medical center, a patient or a physician and the invention is used to generate reports that accurately predict patient response to a treatment regimen at the appropriate dose for that patient, and could prevent administration of toxic and ineffective, but costly therapy to patients, with AML patients as an example. Accurate predictive tests may provide significant cost savings. Of 8,500 AML patients receiving treatment, nearly 3,700 may not respond the treatment. The methods of the invention may be used to predict these 3,700 non-responders, potentially producing a cost savings of part or all of the $280,000,000 that would otherwise have been spent applying an ineffective and potentially toxic treatment to these non-responders.

In one embodiment of the present invention, reports comprising predictive tests such as AML diagnostics are used to guide and inform key clinical decisions. In some embodiments, the methods of the invention can be used to generate reports that identify whether patients will respond to costly and toxic therapies, with AML therapies as an example (there are many others). Thus, cost savings may be realized through spending selectively on treatment regimens to which patients respond. The methods of the invention generate reports that predict whether an AML patient responds to induction therapy, which along with hospital costs, may total $75,000. If the patient is unlikely to respond to induction therapy, this patient may be a good candidate for an experimental drug or therapy. The methods of the invention may be used to generate reports that identify candidate experimental therapies or drugs to which the patient is likely to respond. If the patient responds to a therapy, the methods of the invention may be used to predict the likelihood of relapse. If relapse is considered likely, the methods of the invention may be used to monitor the patient for relapse, or to identify consolidation therapies to which the patient is likely to respond. If the patient relapses, the methods of the invention can identify alternative or experimental therapies for treatment. If the patient is unlikely to respond to traditional consolidation therapy, the methods of the invention may be used to identify novel or experimental therapies for preventing relapse.

Relevent to the cost-savings potential of the invention is the development of reimbursement strategies which motivate, reward, and protect the innovative test developer. Given reimbursement strategies which recognize the value of these tests to improve the quality and efficiency of patient management, industry will be stimulated to translate the emerging discoveries of cancer biology into important new tests to aid in the biologically-informed management of human malignancy, the promise of “personalized medicine”. Improved reimbursement potential will also lead to increased expectations of the diagnostics industry to develop these complex tests to higher levels of evidence, with rigor in the establishment of clinical validation and clinical utility equivalent to that expected of therapeutics developers. However, absent improved reimbursement for these new higher clinical value tests, industry will not be motivated to use its technology and resources to develop such improved clinical management tools, and the potential of the new biology will not be fully realized. Tests that inform meaningful clinical decisions with high predictive results will improve quality of care and access to care with appropriate reimbursement.

Another embodiment of the present invention is a method for screening therapeutics that are in development and indicated for patients. Alternatively, in some embodiments, the invention is a method for screening combinations of therapeutics that can increase the potency or reduce harmful side effects of an older therapeutic that is of limited use due to a lack of potency or harmful side effects. See U.S. Ser. No. 61/186,619.

Pharmaceutical and biotechnology companies are required to conduct clinical trials to be able to secure labeling indications for the drugs they are developing. Often, such clinical trials are expensive and time-consuming. In oncology the regulatory standard for clinical efficacy of a new chemotherapy, either as monotherapy or in combination, is long-term (e.g., 5-year and median) survival for a specific tumor and its staging. The safety and efficacy assessment is also frequently linked to whether the patient is naïve to therapy or refractory to first-line or secondary chemotherapies. Given the long-term nature of some clinical trials, it is highly likely that the diagnostic's ongoing clinical development will result in an intrinsically different agent than the one that is ongoing formal clinical trials with the drug or drug combinations. In this case, technology assessments may become dated and, possibly, conclude that the agent is not as cost-effective as standard empiric decision-making. Accordingly, the cost of conducting clinical trials is sufficiently high such that it may not be economically feasible to conduct new trials. Although secondary measures such as disease-free progression, and tumor-specific quality of life outcomes and patient preferences are commonly used as secondary endpoints, survival gains are a high hurdle to exceed and remain the regulatory and clinical practice gold standard for efficacy. Since survival rates for many cancer drugs are relatively low, often measured in weeks or months, when prescribed for all tumor-specific patients, the question of treatment costs and benefits is increasingly posed. The unfettered access to novel oncolytics has a limited window of opportunity before more rigid requirements are required before coverage and reimbursement are granted.

In some embodiments, use of the invention may involve a partnership between a pharmaceutical/biotechnology company developing a drug or therapeutic and a central laboratory utilizing this invention to provide advantages in the drug development process. For several practical reasons, the technologies described herein will be more widely-implemented if these technologies also offer cost savings. First, the results of molecular diagnostic-drug trials may result in a smaller market and coverage limits, and the pharmaceutical company may be reluctant, at best, to engage in these trials. Second, even with diagnostic-guided decision-making, the drug may not achieve 100% efficacy and net patient gains may be unimpressive from a cost-effectiveness perspective of a third-party payer. Finally, both new drugs and diagnostics have a “trial and error” phase, which means the results of technology assessments conducted later in a Dx-Rx life cycle may produce different, perhaps, superior outcomes than those conducted at or near launch. Hence, the technology assessment process is complex, requiring evaluations on both the drug as well as the diagnostic agent and their interface. For an example of a proposed partnership between a drug company and a company that utilizes the methods the invention described herein, see Example 5.

In some embodiments, the methods of the invention can be used to generate node state data used to pre-screen drug candidates for pharmacokinetic and pharmacodynamic properties, target coverage, and efficacy and generate reports including these analyses. The node state data produced may be used to indentify candidate drugs with high efficacy and minimal undesirable off-target effects in patient samples that are likely to predict effects when the drug is administered to a patient, for example whole blood (See U.S. Ser. No. 61/226,878), thus avoiding the costs of pursuing preclinical or clinical research on ineffective or toxic candidates. See Example 3 (below) for an example of an embodiment in which the methods of the invention are used in the development of kinase inhibitors. In some embodiments, the methods of the invention enable dose-dependent titrations for multiple pathways and cell types simultaneously (See FIG. 8 in U.S. Ser. No. 61/226,878). In some embodiments, the methods of the invention may be used to simultaneously measure drug potency on one or more targets in one or more cell subsets (See FIG. 3 in U.S. Ser. No. 61/226,878). Off-target effects of the drug may also be measured (See FIGS. 16-17 in See U.S. Ser. No. 61/226,878). The ability to perform simultaneous measurements of multiple targets in single cells allows inferences to be made about interactions between these targets that could not be made if the experiments were performed separately (See Irish, et al, Cell, 2004). Furthermore, the ability to obtain multiple measurements from the same sample can realize cost savings for a client. Reagents may be expensive, quantities of available cell samples may be limited, and the labor and time required to perform experiments may be rate-limiting. The use of the methods of the invention to perform these measurements simultaneously can conserve reagents and cell samples, and can reduced the amount of time to screen the effects of a given number of compounds on a given number of targets (See also U.S. Ser. No. 12/031,499). For another example of simultaneous measurements of multiple pathways in different cell types, see FIG. 4 in U.S. Ser. No. 61/226,878. In this example, simultaneous measurements of IL-27 mediated signaling are made within multiple cell types from the same AML bone marrow sample (For a review of IL-27-mediated signaling, see Colgan J, and Rothman, P., All in the family: IL-27 suppression of T(H)-17 cells. Nature Immunology 7: 899-901, 2006).

In some embodiments, the methods of the invention can be used to determine target dosing of a candidate therapeutic, to avoid ineffective preclinical experiments and clinical trials using a dose that is too low, and to avoid toxic side effects that result from a dose that is too high (see Example 4 in U.S. Ser. No. 61/226,878). Especially in the case of biologics, manufacturing a drug for clinical trials or for market may be expensive and time consuming. The use of the invention to determine a dose before clinical trials commence can avoid the use of excessive doses of drug during these trials, resulting in cost savings for a manufacturer during clinical trials. Furthermore, manufacturing a drug for market can be expensive and limited by manufacturing capacity. The use of the invention to determine a dose can avoid the use of excessive doses of drug in the market, thereaby reducing the cost of goods sold, and increasing the number of units that can be sold when manufacturing capacity is limiting.

The methods of the invention may also be used during clinical trials to monitor target impact and harmful side effects during toxicology studies. Despite the cost of clinical trials, drug developers must select the indication, dose, target patient population, and treatment regimen (e.g single or combination therapeutic) before the trial commences, potentially resulting in a lengthy and costly failed clinical trial. In some embodiments, the methods of the invention can be used to identify clinical indications targeted by the drug, and thus can guide the design of clinical trials. For example, researchers may treat samples with a modulator, compare effects of the compound and vehicle on the activation or deactivation of target pathways, and well off-target effects, and identify a set of activatable elements or other criteria to identify target patient populations, dosing, and treatment regimens. Each of these applications decreases the likelihood of performing costly but ineffective, preclinical experiments and clinical trials, and therefore may provide cost savings. Furthermore, each of these applications increases the likelihood of designing preclinical experiments and clinical trails in a manner that allows observation of on-target drug effects, and decreases the likelihood of toxic effects that might harm patients and delay drug development.

In some embodiments, the methods of the invention may be use to characterize pathways that are being targeted by therapeutics, and evaluate the effects of proposed combination therapeutics on the pathways. In this manner, the most appropriate combinations of therapeutics can be identified, simplifying, accelerating, and decreasing the cost of pre-clinical animal studies, and focusing and improving clinical development. For example, Pro-Apoptotic Receptor Agonists (PARAs) are being developed as potential cancer therapeutics (Ashkenazi, A., and Herbst, R. S. To kill a tumor cell: the potential of proapoptotic receptor agonists. J. Clin. Invest. 118: 1979-90, 2008). One class of PARAs, Apo2L/TRAIL ligands bind to pro-apoptotic receptors, DR4 and DR5, actiating extrinsic apoptosis independently of p53. PARAs may promote apotosis through the extrinsic pathway, and may also promote apopotosis through crosstalk with the intrinsic pathway. PARAs may synergize with chemotherapy, as a potential pro-apoptotic combination therapy. In cell lines or patient cell samples, the effects of PARAs on the extrinsic apoptosis pathway may be monitored in single cells by cleaved Casapse 8 levels, for example. The effects of chemotherapy on the intrinsic apotosis pathway (i.e. DNA damage) may be simultaneously monitored using levels of pChk2 and p-H2AX, for example. The synergistic effect on apoptotic cell death may be monitored based on the levels of cleaved effector caspases such as caspases 3, 6, and 7, and of cleaved PARP.

Using the signaling nodes and methodology described herein, multiparametric flow cytometry of another single cell analysis method (such as mass spec) could be used in vitro to predict both on and off-target cell signaling effects.

Using the signaling nodes and methodology described herein, one embodiment of the present invention, such as multiparametric flow cytometry, could be used after in vivo exposure to a therapeutic in development for patients. Using an embodiment of the present invention, the bone marrow or peripheral blood (fresh, frozen, ficoll purified, etc.) obtained from a patient at time points before and after exposure to a given therapeutic may be subjected to a modulator as above. Activatable elements (e.g. JAKs/STATs/AKT), including the proposed target of the therapeutic, or those that may be affected by the therapeutic (off-target) can then be assessed for an activation state. This activation state can then be used to determine the on and off target signaling effects on the bone marrow or blast cells. In some embodiments, the methods of the invention can be used to measure signaling in a subpopulation of less than 100 cells within a larger heterogeneuous population (See FIG. 2 and Table 9 in U.S. Ser. No. 61/226,878).

The apoptosis and peroxide panel study may reveal new biological classes of stratifying nodes for drug screening. Some of the important nodes could include changes on levels of p-Lck, pSlp-76, p PLCγ2, in response to peroxide alone or in combination with growth factors or cytokines. These important nodes are induced Cleaved Caspase 3 and Cleaved Caspase 8, and etoposide induced p-Chk2, peroxide (H₂O₂) induced p-SLP-76, peroxide (H₂O₂) induced p-PLCγ2 and peroxide (H₂O₂) induced P-Lck. The apoptosis panel may include but is not limited to, detection of changes in phosphorylation of Chk2, changes in amounts of cleaved caspase 3, cleaved caspase 8, cleaved poly (ACP ribose) polymerase PARD, cytochrome C released from the mitochondria these apoptotic nodes are measured in response to agents that included but are not limited to DNA damaging agents such as etoposide, AraC and daunorubicin either alone or in combination as well as to the global kinase inhibitor staurosporine.

In one embodiment, customers who are developing candidate drug compounds or testing therapies involving combinations of drug compounds will send the compound to a central location which will perform drug screening experiments and also perform data analysis. The customer may also send cell samples, such as a cell line or primary patient samples to the central location for use in these screening experiments. In another embodiment, customers will purchase a kit to perform the drug screening protocols themselves and send the data to a central location for analysis. In another embodiment, customers will purchase a kit to perform the drug screening experiment and data analysis themselves.

### Example 1

### Diagnosis, Prognosis and Therapeutic Response Typing in AML

A third party physician or medical center purchases, from the central laboratory, kits containing reagents standardized by the central laboratory to minimize sample damage and produce reproducible results. The third party physician or medical center collects a blood sample from a patient suspected of having AML and treats the blood sample with a reagent. The third party transmits the physical sample to the central laboratory. The third party further transmits requisition data specifying that the third party is to be tested for AML, sub-typed for AML if positive for AML and typed according to therapeutic response. The third party further transmits anonymized clinical data associated with the patient to the central laboratory server 110 via the client 150 operated by the third party using kit software 200.

The central laboratory processes the physical sample by stimulating the sample with one or more modulators, fixes and permeabilizes the cells in the sample and contacts the cells in the sample with antibodies. The central laboratory then quantitates the signal of the antibodies using a flow cytometer or comparable technology to generate signal data representing the activation level of different activatable elements in the sample. The data representing the signal of the antibodies is further processed by the central laboratory server 110.

The central laboratory server 110 generates node state metrics based on the signal data. The central laboratory server 110 then sequentially applies a series of statistical models associated with different AML and therapeutic biological states to the node state metrics in order to generate association metrics.

The central laboratory server 110 first applies a statistical model that characterizes node states associated with AML to the node state metrics associated with the sample in order to generate an association metric that specifies the probability that the sample is derived from a patient with AML. The statistical model may be generated based on node state data from samples from AML patient and alternatively with samples from Acute Lymphoid Leukemia (ALL) patients and/or samples from individuals with no known hematological malignancies. Based on this association metric, the central laboratory server 110 determines whether the patient has a diagnosis of AML.

If the patient has a diagnosis of AML, the central laboratory server 110 applies statistical models generated from samples derived from patients with different subtypes of AML (e.g. M3, M4) to the node state metrics from the sample to generate association metrics that specific the probability of the sample having each different subtype of AML. If the central laboratory server 110 determines that the patient has a diagnosis of a sub-type of AML (M4), the central laboratory server 110 further applies statistical models generated from samples derived from patients with different therapeutic responses (response and non-response) to the node state data associated with the sample to generated association metrics that specify whether the patient is likely to respond to standard induction-based therapeutics. If the central laboratory server 110 determines that the patient has a prognosis of response to standard induction-based therapeutics (e.g. a probability of 80% or greater), then the central laboratory server applies a statistical model generated from patients who relapse on the treatment and patients that don't relapse on the treatment to the node state data associated with the sample in order to generate an association metric that specifies the patient's likelihood of relapse. If the central laboratory server 110 determines that the patient has a prognosis of non-response to standard induction-based therapies or relapse from these therapies, the central laboratory server 110 applies a statistical model generated from samples derived from patients that have been responsive to alternative therapeutics (e.g. stem cell transplantation, FLT3 inhibitors, PI3 kinase inhibitors, Vidaza®, Dacogen®, Farnesyl transferase inhibitors, Etoposide®, Voreloxin®) to generate one or more association metrics that specify the likelihood of the patient's response to the alternative therapeutics.

The central laboratory server 110 generates a report that comprises the generated association metrics and explains their clinical significance. The report comprises graphical and textual summaries of the association metrics and node state data as illustrated in FIGS. 8-18. Then central laboratory server 110 further comprises the clinical data from the third party and biometric data ordered by the third party from a partner laboratory and transmit to the central laboratory server by the partner laboratory.

### Example 2

### Candidate Drug Testing for Pharmaceutical Companies

A third party pharmaceutical company purchases, from the central laboratory, kits containing reagents standardized by the central laboratory to minimize sample damage and produce reproducible results. The pharmaceutical company collects blood samples from individuals. The individuals may or may not be patients in a particular disease state that a test compound (e.g. candidate kinase inhibitor) is used to treat. The pharmaceutical company transmits the physical samples to the central laboratory with the test compound. The pharmaceutical company further transmits requisition data specifying that the physical samples are to be treated with the test compound and other modulators over a series of specified concentrations and a pre-defined set of antibodies are to be used to quantify activation levels of specified activatable elements (e.g. activatable elements in the JAK/STAT, PI3 kinase, mTor, Ras/Rap and/or Ehf receptor pathways) responsive to stimulator with the drug/modulators. The pharmaceutical company will collaborate with the central laboratory to determine a set of activable elements to quantify that characterize response to the test compound and “off target” response. The central laboratory processes the physical sample by stimulating the sample with the test compound and/or the one or more modulators over the series of specified concentrations, fixes and permeabilizes the cells in the sample and contacts the cells in the sample with antibodies. The central laboratory then quantitates the signal of the antibodies using a flow cytometer or comparable technology to generate signal data representing the activation level of different activatable elements in the samples. Alternately, the pharmaceutical company may buy kits containing the modulators and/or antibodies and perform any of the above steps themselves as described in FIG. 4.

The data representing the signal of the antibodies is further processed by the central laboratory server 110. For each concentration of the drug, the central laboratory server 110 identifies statistical models associated with different blood cell types (e.g. leukocytes, melanocytes, Natural Killer cells, B Lymphoctyes, C cells, T cells, Myeloid cells, dendritic cells>) and applies the statistical models to the node state data associated with each cell in the sample to generate association metrics that specify the cell type of each cell in the sample. For each concentration of drug at each different cell type, the central laboratory server 110 identifies statistical models generated from samples of the cell types have biological states of high/low IC-50 values and “off target” response to a drug to the node state data association with the cell type at a concentration of the drug to generate association metrics that specify whether the cells have high/low IC-50 values and/or “off target” response at the concentration of the drug.

The central laboratory server 110 then generates reports that summarize the association metrics and their significance. The central laboratory server 110 generates plots of the likelihood of IC-50 values and “off target” response for each cell type at each concentration of the drug. These plots may be bar and whisker plots that allow the drug company to view the node state data of their treated samples as compared to the node state data of cells with known IC-50 values and “off target” response used to generate the statistical models. Using these plots, the pharmaceutical company can determine the efficacy and safety of their test compound at different concentrations in different cell types.

The central laboratory server 110 further generates interactive graphical user interfaces that allow the user to select to view data associated with different modulators, activatable element and populations of cells as illustrated in FIGS. 18 and 19.

### Example 3

### Collaboration with Diagnostics Company to Develop Diagnostic

The central laboratory server 110 receives node state data from a third party client 150 operated by a biotechnology company that develops diagnostic tests. The biotechnology company generates node state data associated with a large set of samples with a known disease state (e.g. Lupus) using modulators, reagents and antibodies purchased from the central laboratory as kits and using kit software 200 purchased from the central laboratory. The biotechnology company transmits the node state data to the central laboratory server 110 via a client 150 operated by the biotechnology company.

The central laboratory server 110 applies a set of statistical models associated with different cell types to the received node state data associated with each sample to generated association metrics that specify the cell type of each cell in the sample. For each cell type represented in the set of samples, central laboratory server 110 then generates statistical models based on the node state data associated with cells of the same cell type in the received samples and node state data associated with cells of the same cell type that are known not to have the disease state (i.e. “normal” with respect to the disease state). The generated models characterize, for each cell type, node states (i.e. levels of activatable elements or “activation states”) that distinguish the disease state from normal samples. The central laboratory server 110 also generates statistical models, for each cell type, based on the node state data associated with the same cell type in the received samples and node state data associated with cells of the same cell type from samples that have disease state associated with a similar phenotype (e.g. in the case of Lupus other auto-immune diseases). The central laboratory server 110 generates metrics such as ROC curves and confidence values that summarize the accuracy of the statistical models.

The central laboratory server 110 generates reports that summarize the node state data that distinguishes the disease samples from the samples without the disease state using graphical and textual summarize of node state data associated with each state. The reports further comprise plots and visualizations of the metrics that summarize the accuracy of the statistical models. The central laboratory server 110 transmits these reports to the biotechnology company via a client 150 operated by the biotechnology company.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1.-28. (canceled)

29. A method comprising:
obtaining primary cells from an individual, the cells are associated with cancer or autoimmune disease;
determining activation state data for phosphorylated proteins within single cells from the individual by a process comprising:
contacting the cells with at least two modulators;
contacting the cells with a plurality of binding elements;
detecting the binding elements on a single cell basis using a flow cytometer;
identifying cell pathways and signaling pathway disruptions using the activation state data;
determining a clinical outcome for the individual by comparing the activation state data to a database containing activation state data linked to clinical information from other individuals and when therapeutic action was taken or not taken;
matching the clinical outcome of the individual to biological profiles that guide the selection of therapeutic regimens,
generating a report containing the activation state data, diagnosis or treatment information, cell characterization information, signaling responses to modulators, apoptosis inducing agents and drug response readouts, using a computer;
accessing or transmitting the report over the internet, a web portal or network by a third party or to a third party;
providing therapeutic treatment based on the activation state data of the single cells; and
adding the activation state data to the database containing activation state data linked to clinical information.

30. The method of claim 29 wherein the report further comprises biometric data associated with the sample.

31. The method of claim 29 wherein the third party pays to access the report by a subscription fee.

32. The method of claim 29 wherein the report contains interactive sections when accessed electronically.

33. The method of claim 29 wherein the report contains information on therapeutic dosing.

34. The method of claim 29 wherein the report indicates the likelihood of relapse.

35. The method of claim 29 wherein the step of identifying cell pathways includes correlating the pathways to a biological state selected from the group of: a disease state, a clinical outcome or marker thereof, a response to a modulator and an activation level of an activatable element.

36. The method of claim 29 wherein the report displays one or more graphical summaries of the activation state data.

37. The method of claim 30 wherein the biometric data contains information selected from the group consisting of nucleic acid or protein array based experiments, hematopathology services, such as diagnostic immunophenotyping, cytogenetics, immunohistochemistry, karyotyping, FISH, molecular genetics, analysis of cell morphology, blood smear interpretation and report, bone marrow smear interpretation and report, cytospin, cytopathology selective, DNA ploidy by flow, flow markers, skin or other solid tissue, tissue culture, solid tumor culture, cytogenetic chromosome analysis, surgical pathology, decalcification, and morphometric analysis.

38. The method of claim 29 wherein the report comprises interactive sections used by the third party to navigate and interpret activation state data, specify types of data, re-integrate patient data, and to allow reconfiguring of the data.

39. The method of claim 29 further comprising providing data in the report on the likelihood for response to therapy.

40. The method of claim 29 further comprising predicting the likelihood of relapse and identification of an alternative therapy.

41. The method of claim 29 wherein the activation state data relevant to guiding therapeutic treatment includes data to: measure signaling pathway activity in single cells, identify signaling pathway disruptions in diseased cells, identify response and resistant biological profiles that guide the selection of therapeutic regimens, monitor the effects of therapeutic treatments on signaling in diseased cells, or monitor the effects of treatment over time.

42. The method of claim 29, wherein the report is used by the third party to: select a sample for an experiment, guide treatment of a patient, diagnose a patient, or determine a prognosis for the patient.

43. The method of claim 29 wherein the report generation module characterizes rare cell and heterogeneous cell populations.

44. The method of claim 29 wherein the report identifies: which treatments would be effective and ineffective; the optimal dose of an agent or combination of agents; or the biological, pharmacological and clinical effect of the treatment.
